(19) United States
(12) Patent Application Publication
(10) Pub. No.: US 2016/0357462 A1
(43) Pub. Date: Dec. 8, 2016

(54) Nonvolatile Memory Modules and Data Management Methods Thereof

(71) Applicant: Samsung Electronics Co., Ltd., Suwon-si (KR)

(72) Inventors: Hee Hyun Nam, Seoul (KR); Jaegeun Park, Suwon-si (KR); Sungyong Seo, Seongnam-si (KR); Youngkwang Yoo, Yongin-si (KR); Han-Ju Lee, Hwaseong-si (KR); Youngjin Cho, Seoul (KR)

(21) Appl. No.: 15/096,877

(22) Filed: Apr. 12, 2016

(30) Foreign Application Priority Data
Jun. 8, 2015 (KR) 10-2015-0080732
Jun. 8, 2015 (KR) 10-2015-0080737
Jun. 8, 2015 (KR) 10-2015-0080745
Jun. 8, 2015 (KR) 10-2015-0080838

(51) Int. Cl. G06F 3/06

(52) U.S. Cl. CPC G06F 3/0619; G06F 3/0613; G06F 3/0659; G06F 3/0685

(57) ABSTRACT

Disclosed is a nonvolatile memory module. The nonvolatile memory module includes at least one nonvolatile memory, a random access memory (RAM) and a device controller. Responsive to receiving a write request comprising sub-data from a host, the device controller accumulates the sub-data in the RAM and programs the accumulated sub-data in the nonvolatile memory. A size of the sub-data is smaller than a size of a default transmission unit provided from the host.

### CROSS-REFERENCE TO RELATED APPLICATIONS

This non-provisional patent application claims benefit and priority under 35 U.S.C. §119 to Korean Patent Application Nos. 10-2015-0080838 filed Jun. 8, 2015, 10-2015-0080732 filed Jun. 8, 2015, 10-2015-0080737 filed Jun. 8, 2015, and 10-2015-0080745 filed Jun. 8, 2015, in the Korean Intellectual Property Office, the contents of all of which are incorporated herein in their entirety by reference.

### BACKGROUND

Embodiments of the inventive concept disclosed herein relate to a semiconductor memory devices, and more particularly, to nonvolatile memory modules and data management methods thereof.

Semiconductor memory device include volatile memory devices and nonvolatile memory devices. Read and write speeds of volatile memory devices are fast, but when a power supply is interrupted, data stored therein disappears. In contrast, nonvolatile memory devices retain data stored therein even when power is removed. Therefore, nonvolatile memory devices may be used to store information to be retained regardless of whether a power is supplied.

An example of nonvolatile semiconductor memory devices is a flash memory which is used in portable electronic devices. However, since a write unit and an erase unit of the flash memory may be different from each other, the flash memory may be driven according to an erase-after-write scheme. Accordingly, the flash memory may use firmware and/or an interface for hiding an erase operation to interface with a central processing unit (CPU) of a computer system.

Flash memory may be used as a data storage device or a working memory by mounting the flash memory on the same slot or channel as a main memory (or a working memory). In this case, compatibility with a conventionally used volatile random access memory (RAM) (e.g., a DRAM) should be considered.

### SUMMARY

Embodiments of the inventive concept provide a data management method capable of minimizing an increase in a write count of a nonvolatile memory even though sub-data is write requested from a nonvolatile memory module by a default transmission unit. Embodiments of the inventive concept also provide a method capable of providing high data integrity and managing a life efficiently by minimizing an increase in the number of write operations about a nonvolatile memory.

A nonvolatile memory module according to embodiments of the inventive concept may include at least one nonvolatile memory and a device controller. When a write request about sub-data is received from a host, the device controller may accumulate the sub-data in a RAM and may program the accumulated sub-data at the nonvolatile memory. The sub-data may be data of which a size is smaller than a size of a default transmission unit provided from the host.

A data writing method of a nonvolatile memory module according to embodiments of the inventive concept may include storing a write start command of sub-data, of which a size is smaller than a size of a default transmission unit from a host, in a command area of a RAM, receiving first sub-data corresponding to a write command from the host to store the first sub-data in a write area of the RAM, receiving second sub-data from the host to store the second sub-data in the write area, and combining the first sub-data and the second sub-data from the write area to program the combined result in a nonvolatile memory.

A nonvolatile memory module according to embodiments of the inventive concept may include a device controller communicatively coupled to a host and configured to receive a plurality of data transmissions having a default transmission unit size from the host, a nonvolatile memory coupled to the device controller and configured to be programmed with data from the plurality of data transmissions, and a volatile memory coupled to the device controller and configured to store sub-data having a size smaller than the default transmission unit size that are accumulated from respective ones of the plurality of data transmissions from the host. The device controller may program accumulated sub-data data from the volatile memory into the nonvolatile memory when a predetermined condition is met.

A nonvolatile memory module according to embodiments of the inventive concept may include a device controller communicatively coupled to a host via an interface and configured to receive a data transmission from the host having a default transmission unit size, a nonvolatile memory coupled to the device controller, and a volatile memory coupled to the device controller. The volatile memory may include a command area configured to transfer commands to the device controller responsive to write operations performed over the interface by the host to the command area, a write area configured to receive write data from the host responsive to write operations performed over the interface by the host to the write area, a read area configured to transfer read data to the host responsive to read operations performed over the interface by the host to the read area, and a status area configured to transfer status to the host about the data transmission responsive to read operations performed over the interface by the host to the status area. The device controller may be configured to identify sub-data of the write data having a size smaller than the default transmission unit size, accumulate the sub-data in the volatile memory until a predetermined condition is met, and program the sub-data into the non-volatile memory responsive to the predetermined condition being met.

A user device according to embodiments of the inventive concept may include a nonvolatile memory module and a processor. The nonvolatile memory module may include a nonvolatile memory and a device controller. The device controller may include a RAM connected with the outside through a physical layer interface and may control the nonvolatile memory with reference to a command or data stored in the RAM. The processor may store an access command to the nonvolatile memory and write data in the RAM through the physical layer interface. The processor may store in the RAM sub-data write command about sub-data, of which a size is smaller than a size of a default transmission unit of the physical layer interface. The device controller may accumulate pieces of sub-data stored in the RAM through pieces of write data of different default transmission units in response to the sub-data write command and may program the accumulated sub-data at the nonvolatile memory.

A nonvolatile memory module according to embodiments of the inventive concept may include at least one nonvolatile memory and a device controller. The device controller may receive data and an error correction code, may detect an error of the data using the error correction code, and may correct the error of the data. The device controller may execute an error correction module to correct an error of the data.

A nonvolatile memory module according to embodiments of the inventive concept may include at least one nonvolatile memory and a device controller. The device controller may receive data and an error correction code from a host, may detect an error of the data using the error correction code, and may execute an error correction module to correct an error of the data. The device controller may include a RAM controller, a physical layer, a dual inline memory module (DIMM) controller, and a processor. The RAM controller may receive a RAM address and a RAM address from the host. The physical layer may include a RAM controller to receive a RAM command and a RAM address from the host and a RAM to store the data based on the RAM command and the RAM address. The DIMM controller may control data exchange between the RAM and the nonvolatile memory. The processor may execute the error correction module.

The nonvolatile memory module may include one or more nonvolatile memories and a memory controller. In the case where a read request associated with read data stored in at least one of nonvolatile memories is received from a host, a device controller may transmit one, which is ready to transmit, from among a plurality of transmission unit data constituting read data in response to a preparation of each transmission unit data. Each transmission unit data may be transmitted to a host regardless of an order to constitute read data.

In a nonvolatile memory module according to embodiments of the inventive concept, a device controller may generate notification data indicating a preparation of each transmission unit data. Each transmission unit data may be transmitted to a host regardless based on notification data.

In a nonvolatile memory module according to embodiments of the inventive concept, whether a plurality of transmission unit data is all transmitted may be managed by a host.

In a nonvolatile memory module according to embodiments of the inventive concept, a device controller may operate according to an interface protocol defined in a DIMM specification. In addition, a command signal corresponding to a read request may be received through a data input/output pin defined in a DIMM specification, and a data signal corresponding to each of a plurality of transmission unit data may be transmitted to a host through a data input/output pin.

A storage device according to embodiments of the inventive concept may include one or more nonvolatile memories and a device controller. A device controller may transmit read data, stored in at least one of nonvolatile memories, to a host in response to a request from a host. A device controller may include a physical layer and a controller. A physical layer may include a RAM and a RAM controller configured to control the RAM based on a RAM command and a RAM address from a host. A controller may control a physical layer and nonvolatile memories such that read data is read from a position of nonvolatile memories corresponding to a storage address based on a storage command and a storage address, which are provided from a host and are stored in a RAM and such that each of a plurality of transmission unit data which is generated by dividing read data is temporarily stored in a RAM. A device controller may transmit read data by each of the plurality of transmission unit data to a host.

In a storage device according to embodiments of the inventive concept, a device controller may store notification data in a RAM. Notification data may indicate that each of a plurality of transmission unit data is stored in a RAM and may include information associated with a position at read data of each of a plurality of transmission unit data.

In a storage device according to embodiments of the inventive concept, at least one of a plurality of transmission unit data may include an invalid portion not included in read data. In some embodiments, notification data may further include information associated with an invalid portion. In addition, an invalid portion may be discarded by a host based on notification data, and remaining data other than an invalid portion of a plurality of transmission unit data may be combined to read data.

An electronic device according to embodiments of the inventive concept may include one or more storage device and at least one processor. A processor may provide a storage device associated with a read request associated with read data stored in a storage device. A storage device may prepare transmission of each of a plurality of transmission unit data, constituting read data, to a processor and may generate notification data associated with preparation of each of a plurality of transmission unit data. A processor may receive one, which is ready to transmit, from among a plurality of transmission unit data with reference to notification data.

A nonvolatile memory module according to embodiments of the inventive concept may include one or more nonvolatile memories and a device controller. A device controller may receive write data together with an error correction code from a host, may check an error of write data with reference to an error correction code, and may store write data in at least one of nonvolatile memories. In addition, a device controller may store error information in a RAM included therein such that error information about an error is accessed by a host.

In a nonvolatile memory module according to embodiments of the inventive concept, error information may include information about whether an error is detected from write data.

In a nonvolatile memory module according to embodiments of the inventive concept, when an error is detected from write data, error information may further include information about whether the detected error is correctable.

In a nonvolatile memory module according to embodiments of the inventive concept, in the case where error information indicates that the detected error is uncorrectable, a device controller may again receive write data from a host based on error information.

In a nonvolatile memory module according to embodiments of the inventive concept, when an error is detected from write data and the detected error is correctable, error information may further include information about whether write data is stored in at least one of nonvolatile memory module after the detected error is detected.

In a nonvolatile memory module according to embodiments of the inventive concept, when an error is not detected from write data and the detected error is correctable, a device controller may store write data in at least one of nonvolatile memory module.

In a nonvolatile memory module according to embodiments of the inventive concept, a device controller may operate according to an interface protocol defined in a DIMM specification.

A storage device according to embodiments of the inventive concept may include one or more nonvolatile memories and a device controller. A device controller may receive write data together with an error correction code from a host and may store write data in at least one of nonvolatile memories. A device controller may include a physical layer and a controller. A physical layer may include a RAM and a RAM controller configured to control the RAM based on a RAM command and a RAM address from a host. A controller may control a physical layer and nonvolatile memories based on a storage command and a storage address stored in a RAM and provided from a host, such that write data is stored at a position of nonvolatile memories corresponding to a storage address after being temporarily stored in a RAM. A controller may include an error correction block which checks an error of write data with reference to after write data is read from a RAM. A device controller may store error information about an error in a RAM.

In a storage device according to embodiments of the inventive concept, error information stored in a RAM may be accessed by a host.

In a storage device according to embodiments of the inventive concept, when an error is detected and the detected error is correctable, an error correction block may correct the detected error.

An electronic device according to embodiments of the inventive concept may include one or more storage device and at least one processor. A processor may provide a storage device with an error correction code and write data. A storage device may check an error of write data with reference to an error correction code, may store error information about an error in a RAM included in a physical layer of a storage device, and may store write data when no error exists or an error is correctable. A processor may access a RAM to obtain error information.

In a storage device according to embodiments of the inventive concept, a processor may determine whether error information is stored, every check point in time.

A nonvolatile memory module according to embodiments of the inventive concept may include at least one nonvolatile memory and a device controller. The device controller may receive data and an error correction code, may detect an error of the data using the error correction code, and may correct the error of the data. The device controller may execute an error correction module to correct an error of the data.

The host and the nonvolatile memory module may communicate with each other through a dual data rate (DDR) interface.

The nonvolatile memory module may be a dual in-line memory module (DIMM).

The device controller may include a RAM in which the data is stored and may include a physical layer for an interface with the host and a DIMM controller to control data exchange between the RAM and the nonvolatile memory.

The DIMM controller may include an error detector which is implemented with hardware for detecting an error of the data.

The DIMM controller may further include a stream packet generator and a status information generator. The stream packet generator may process the data in the form of a stream packet and may transmit the processed result to the nonvolatile memory. In the case where an error of the data is not corrected, the status information generator may update status information about the data not corrected.

The DIMM controller may transmit the status information to the RAM.

The status information may be accessed by the host and may be used for the host to retransmit the data.

The data may include a storage command, a storage address, and write data. The RAM may include a read area to store the storage command and the storage address, a write area to store the write data, and a status area to store status information associated with whether an execution of the storage command is completed.

The error correction module may be loaded from the nonvolatile memory or a ROM included in the device controller.

A nonvolatile memory module according to embodiments of the inventive concept may include at least one nonvolatile memory and a device controller. The device controller may receive data and an error correction code from a host, may detect an error of the data using the error correction code, and may execute an error correction module to correct an error of the data. The device controller may include a RAM controller, a physical layer, a DIMM controller, and a processor. The RAM controller may receive a RAM address and a RAM address from the host. The physical layer may include a RAM controller to receive a RAM command and a RAM address from the host and a RAM to store the data based on the RAM command and the RAM address. The DIMM controller may control data exchange between the RAM and the nonvolatile memory. The processor may execute the error correction module.

The DIMM controller may include an error detector and a status information generator. The error detector may detect an error of the data. In the case where an error of the data is not corrected, the status information generator may update status information about the data not corrected.

The status information may be stored in the RAM, may be accessed by the host, and may be used for the host to retransmit the data.

The host and the nonvolatile memory module may communicate with each other through a dual data rate (DDR) interface.

The nonvolatile memory module may be a dual in-line memory module (DIMM).

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram illustrating a computer system according to embodiments of the inventive concept;

FIG. 2 is a block diagram illustrating an embodiment of a software layer of the computing system of FIG. 1;

FIG. 3 is a diagram illustrating a physical or logical area of a RAM which may be used in the computer system of FIG. 1;

FIG. 4 is a block diagram illustrating a method for writing sub-data, according to embodiments of the inventive concept;

FIG. 5 is a diagram illustrating an embodiment of a method for writing sub-data of FIG. 4;

FIG. 6 is a block diagram illustrating a method for writing sub-data, according to embodiments of the inventive concept;

FIG. 7 is a diagram illustrating an embodiment of a method for writing sub-data, according to an embodiment of FIG. 6;

FIG. 8 is a flow chart illustrating an operation of a host for performing the write method of FIG. 6;

FIG. 9 is a flow chart illustrating an operation of a storage device according to a write request about sub-data of a host;

FIG. 10 is a block diagram illustrating an additional operation associated with the embodiment illustrated in FIG. 6;

FIG. 11 is a block diagram illustrating a method for writing sub-data, according to embodiments of the inventive concept;

FIG. 12 is a diagram illustrating a method for writing sub-data, according to the embodiment of FIG. 10;

FIG. 13 is a flow chart illustrating an operation of a host for performing the write method of FIG. 12;

FIG. 14 is a flow chart illustrating an operation of a storage device according to a write request about sub-data of a host;

FIG. 15 is a block diagram illustrating a method for writing sub-data, according to embodiments of the inventive concept;

FIG. 16 is a diagram illustrating an embodiment of a method for writing sub-data of FIG. 15;

FIG. 17 is a block diagram illustrating the case that a merge operation may be added to the embodiment of FIG. 15;

FIG. 18 is a diagram illustrating an embodiment of the method for writing sub-data of FIG. 17;

FIG. 19 is a block diagram schematically illustrating an embodiment of one of the nonvolatile memories of FIG. 1;

FIG. 20 is a circuit diagram illustrating an embodiment of one of the memory blocks included in a cell array of a memory cell array in FIG. 19;

FIG. 21 is a block diagram illustrating a storage system including a storage device according to embodiments of the inventive concept;

FIG. 22 is a diagram schematically illustrating a configuration of an embodiment of the RAM of FIG. 21 and communications among a processor, a RAM, and a controller;

FIG. 23 is a flow chart for describing an embodiment of a write operation of the storage device illustrated in FIG. 21;

FIG. 24 is a flow chart for describing an embodiment of a read operation of the storage device illustrated in FIG. 21;

FIG. 25 is a flow chart for describing an embodiment of a read operation of a storage device illustrated in FIG. 21;

FIG. 26 is a diagram illustrating transmission of transmission unit data and notification data during a read operation of FIGS. 24 and 25;

FIG. 27 is a diagram illustrating the procedure for transmitting transmission unit data from a storage device to a host side with reference to notification data of FIG. 26, based on an embodiment of the read operation of FIGS. 24 and 25;

FIG. 28 is a diagram illustrating a procedure for obtaining read data by combining a valid portions of transmission unit data transmitted according to a read operation of FIGS. 24 and 25;

FIG. 29 is a block diagram illustrating an embodiment of the nonvolatile memories of FIG. 21;

FIG. 30 is a circuit diagram illustrating an embodiment of a memory block of the memory cell array in FIG. 29;

FIG. 31 is a block diagram illustrating a storage system according to embodiments of the inventive concept;

FIG. 32 is a diagram schematically illustrating a configuration of a RAM of FIG. 31 and communications among a processor, a RAM, and a controller;

FIG. 33 is a flow chart for describing an embodiment of a read operation of the storage device illustrated in FIG. 31;

FIG. 34 is a flow chart for describing an embodiment of a write operation of the storage device illustrated in FIG. 31;

FIG. 35 is a diagram illustrating a procedure for communicating an error of write data during a write operation of FIG. 34;

FIG. 36 is a flow chart illustrating a procedure for checking an error and generating error information during a write operation of FIG. 34 at a storage device of FIG. 31;

FIG. 37 is a flow chart illustrating a procedure for checking error information during a write operation of FIG. 31 at a storage device of FIG. 31;

FIG. 38 is a diagram illustrating operations corresponding to the case that an error of write data does not occur during the write operation of FIG. 34;

FIG. 39 is a diagram illustrating operations corresponding to the case that a correctable error of write data occurs during the write operation of FIG. 34;

FIG. 40 is a diagram illustrating operations corresponding to the case that an uncorrectable error of write data occurs during the write operation of FIG. 34;

FIG. 41 is a block diagram illustrating an embodiment of the nonvolatile memories of FIG. 31;

FIG. 42 is a circuit diagram illustrating an embodiment of a memory block of the memory cell array in FIG. 31;

FIG. 43 is a block diagram illustrating a storage system according to embodiments of the inventive concept;

FIG. 44 is a block diagram illustrating a configuration of data storage illustrated in FIG. 43;

FIG. 45 is a diagram illustrating data storage and software layers according to embodiments of the inventive concept;

FIG. 46 is a block diagram illustrating a structure of the RAM illustrated in FIG. 44;

FIG. 47 is a flow chart illustrating an embodiment of a write operation of the data storage illustrated in FIG. 44;

FIG. 48 is a flow chart illustrating an embodiment of a read operation of the data storage illustrated in FIG. 44;

FIG. 49 is a block diagram illustrating communications between a host and data storage;

FIG. 50 is a block diagram illustrating the procedure for detecting and correcting an error, according to embodiments of the inventive concept;

FIG. 51 is a block diagram illustrating an embodiment of the DIMM controller illustrated in FIG. 50;

FIG. 52 is a block diagram illustrating an embodiment of the DIMM controller illustrated in FIG. 50, according to embodiments of the inventive concept;

FIG. 53 is a flow chart illustrating a method for detecting and correcting an error of data received from a host on a storage system according to embodiments of the inventive concept;

FIG. 54 is a flow chart illustrating an operating method of a device controller according to embodiments of the inventive concept;

FIG. 55 is a flow chart illustrating an operating method of a device controller according to embodiments of the inventive concept;

FIG. 56 is a block diagram illustrating an embodiment of the nonvolatile memories described in FIG. 44;

FIG. 57 is a circuit diagram illustrating an embodiment of the memory blocks included in the memory cell array of FIG. 56;

FIG. 58 is a block diagram illustrating a computing system to which a nonvolatile memory module according to the inventive concept may be applied;

FIG. 59 is a block diagram illustrating an embodiment of the nonvolatile memory modules of FIG. 58;

FIG. 60 is a block diagram illustrating an embodiment of the nonvolatile memory modules of FIG. 58;

FIG. 61 is a block diagram illustrating another example of a computing system to which a nonvolatile memory module according to the inventive concept may be applied;

FIG. 62 is a block diagram schematically illustrating an embodiment of the nonvolatile memory module illustrated in FIG. 61;

FIG. 63 is a block diagram illustrating an embodiment of the nonvolatile memory module illustrated in FIG. 61;

FIG. 64 is a block diagram schematically illustrating an embodiment of the nonvolatile memory module illustrated in FIG. 61; and

FIG. 65 is a diagram illustrating a server system to which a nonvolatile memory system according to embodiments of the inventive concept may be applied.

### DETAILED DESCRIPTION

It is to be understood that both the foregoing general description and the following detailed description are provided as examples, for illustration, and not for limiting the scope of the invention. Reference will now be made in detail to the present preferred embodiments of the invention, examples of which are illustrated in the accompanying drawings. Wherever possible, the same reference numbers are used in the drawings and the description to refer to the same or like parts.

Below, a flash memory device will be exemplified as an example of a nonvolatile memory device to describe features and functions of the inventive concept. However, other features and performs may be easily understood from information disclosed herein. The inventive concept may be implemented or applied through other embodiments. In addition, the detailed description may be changed or modified according to view points and applications without departing from the claims, the scope and spirit, and any other purposes of the inventive concept.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

As used herein, the term “and/or” includes any and all combinations of one or more of the associated listed items. Expressions such as “at least one of,” when preceding a list of elements, modify the entire list of elements and do not modify the individual elements of the list.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts.

Unless otherwise defined, all terms (including technical and scientific terms) used herein have the same meaning as commonly understood by one of ordinary skill in the art to which these inventive concepts belong. It will be further understood that terms, such as those defined in commonly used dictionaries, should be interpreted as having a meaning that is consistent with their meaning in the context of the relevant art and this specification and will not be interpreted in an idealized or overly formal sense unless explicitly so defined herein.

When some embodiments may be embodied otherwise, respective process steps described herein may be performed otherwise. For example, two process steps described in a sequential order may be performed substantially the same time or in reverse order.

I. Nonvolatile Memory Module Accumulating Data by Sub Data Unit

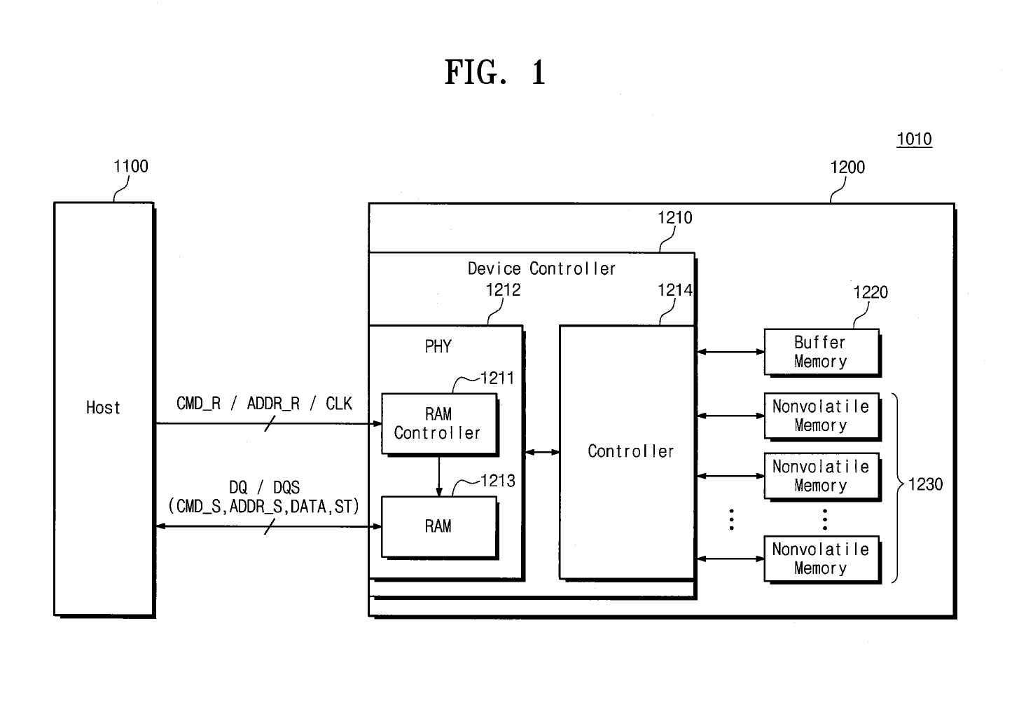

FIG. 1 is a block diagram illustrating a computer system according to embodiments of the inventive concept. Referring to FIG. 1, a computing system 1010 may include a host 1100 and a storage device 1200.

The host 1100 may perform an access operation to the storage device 1200 such as a write request and/or a read request. The host 1100 may access a physical layer 1212 of a device controller 1210 to write data at the storage device 1200.

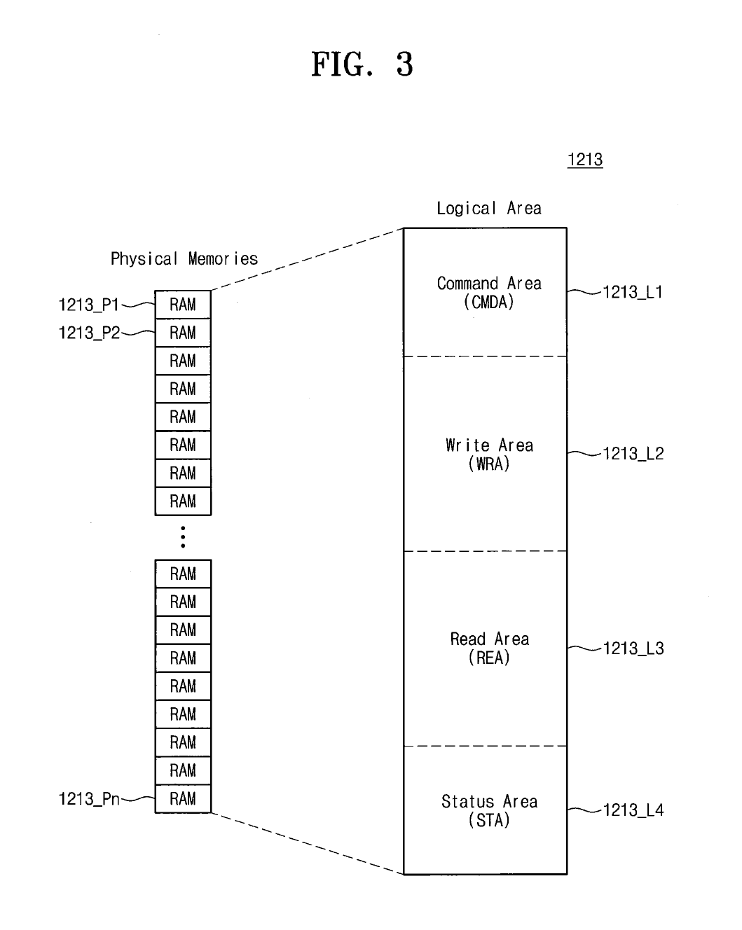

The storage device 1200 may include a device controller 1210, a buffer memory 1220, and/or a nonvolatile memory 1230. The device controller 1210 may include a physical layer 1212 for interfacing with the host 1100 and a controller 1214 to perform data communication with the physical layer 1212 and the buffer memory 1220 and/or with the nonvolatile memory 1230. The physical layer 1212 may include a random access memory (RAM) controller 1211 which may receive a RAM command CMD_R, a RAM address ADDR_R, and/or a clock CLK from the host 1100. The physical layer 1212 may include a RAM 1213 which exchanges data with the host 1100 using data DQ and a data strobe signal DQS. The host 1100 may write data CMD_S, ADDR_S, DATA, and/or ST at a specific area to access the nonvolatile memory 1230 or the buffer memory 1220. Areas of the RAM 1213 classified by the host 1100 for each function will be described with reference to FIG. 3.

According to an interfacing protocol defined at the host 1100 and the physical layer 1212 of the storage device 1200, the host 1100 may transfer data by a default transmission unit when writing data in the RAM 1213. That is, during a write operation, the host 1100 may write data of a default transmission unit (e.g., 512 bytes) at the RAM 1213 of the storage device 1200. In some embodiments, even though a small size of data (e.g., 16 bytes) is written, a larger amount of data (e.g., 512 bytes) including substantially meaningful 16-byte data and invalid 496-byte dummy data may be written at the RAM 1213.

The storage device 1200 of the inventive concept may identify a write request about data which is smaller in size than a default transmission unit of the physical layer 1212. Sub-data smaller in size than the default transmission unit may be accumulated inside the device controller 1210 based on the identification result. The accumulated sub-data may be programmed at the nonvolatile memory 1230 based on instructions from the host 1100 and/or an internal determination. The above-described function may allow the number of program operations about the nonvolatile memory 1230 to be reduced markedly. The above-described technique of the inventive concept may make it possible to markedly extend a life of the storage device 1200 which depends on a life of the nonvolatile memory 1230. As used herein, data smaller in size than the default transmission unit may be referred to as “sub-data”.

In some embodiments, the storage device 1200 may be of the form of a dual in-line memory module (DIMM) and may be mounted on a DIMM socket so as to communicate with the host 1100. That is, the physical layer 1212 may perform interfacing defined according to a dual data rate (DDR, DDR2, DDR3, and DDR4) protocol, though the present inventive concept is not limited thereto.

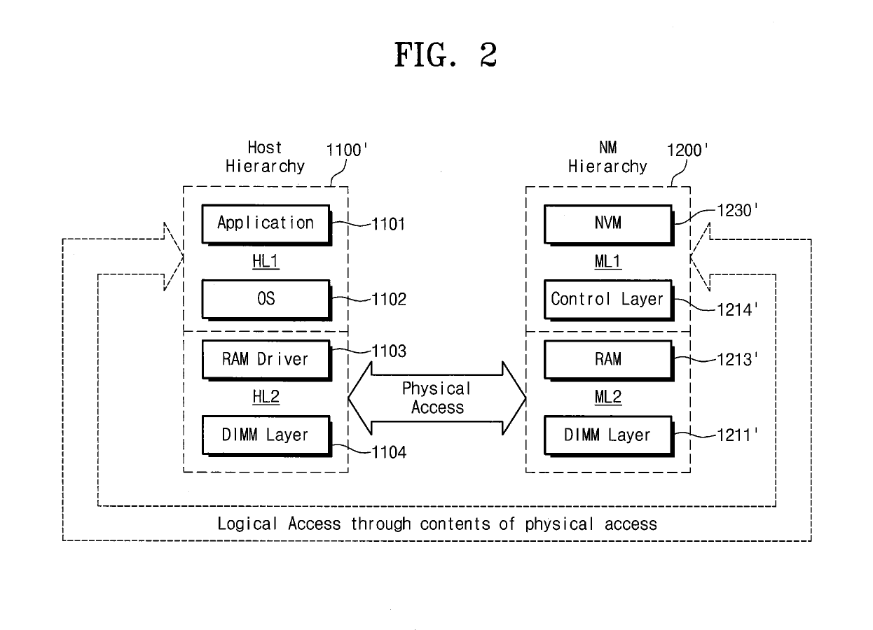

FIG. 2 is a block diagram illustrating an embodiment of a software layer of the computing system 1010 of FIG. 1. Referring to FIG. 2, a host layer 1100′ may be driven on the host 1100. Software or firmware of a nonvolatile memory layer 1200′ may be driven on the storage device 1200′.

The host layer 1100′ may include a variety of software layers. An application program 1101 and an operating system 1102 may be included in a host upper layer HL1. The application program 1101 may be driven as a basic service and may be software of an upper layer driven by a user. The operating system 1102 may perform an overall control operation of the computing system 1010 such as program execution, file access, driving of an application program, control of the storage device 1200, and the like.

A RAM driver 1103 and/or a DIMM layer driver 1104 may be included in a host lower layer HL2 for access to the storage device 1200. The RAM driver 1103 and/or the DIMM layer driver 1104 may be substantially included in a kernel of an operating system 1102. The RAM driver 1103 may perform a control operation for an access to a RAM 1213′ of the storage device 1200 with respect to an access request from the host upper layer HL1. For example, the RAM driver 1103 may be a control module for controlling the RAM 1213′ of the storage device 1200 at an operating system (1102) level. The RAM driver 1103 may be called if the application program 1101 or the operating system 1102 requests an access to the RAM 1213′. In addition, the DIMM layer driver 1104 may be called together with the RAM driver 1103 to support access to the RAM 1213′ at an actual physical layer level.

The nonvolatile memory layer 1200′ may include a memory upper layer ML1 and a memory lower layer ML2. The memory upper layer ML1 may control access to the nonvolatile memory 1230′ according to an upper command CMD_S or an upper address ADDR_S written at the RAM 1213′. The memory upper layer ML1 may perform an access to the nonvolatile memory 1230′ and a memory management operation by the controller layer 1214′. For example, a control about the nonvolatile memory 1230′ such as garbage collection, wear leveling, stream control, and the like may be performed by the controller layer 1214′. In contrast, interfacing between the RAM 1213′ and the host 1100 may be performed on the memory lower layer ML2. That is, the memory lower layer ML2 may perform an operation for writing or reading data at or from the RAM 1213′ using a RAM command CMD_R and/or a RAM address ADDR_R provided through the RAM controller 1211. It may be understood that the memory lower layer ML2 accesses the RAM 1213′ based on a request of the memory upper layer ML1.

Firmware or software with the above-described layer structure (hierarchy) may allow the computing system 1010 to access the nonvolatile memory 1230. An access to the nonvolatile memory 1230 included in the storage device 1200 of a DIMM form may be performed by decoding a command and an address CMD_S and ADDR_S provided through the RAM 1213.

The host lower layer HL2 according to an embodiment of the inventive concept may transmit a sub-write command to the storage device 1200 at a write request about sub-data SD smaller in sized than a minimum transmission unit of the physical layer. A transfer of write data according to a configuration of the physical layer should be made by a minimum write unit. However, if provided together with a sub-write command Sub_W_CMD, sub-data SD may be accumulated in the device controller 1210. The accumulated sub-data SD may be programmed at the nonvolatile memory based on instructions from the host lower layer HL2 or internal determination of the controller 1214.

FIG. 3 is a diagram illustrating a physical or logical area of a RAM which may be used in the computer system 1010 of FIG. 1. Referring to FIG. 3, the RAM 1213 may include a plurality of SRAMs 1213_P1, 1213_P2, . . . , 1213_Pn physically. The SRAMs 1213_P1, 1213_P2, . . . , 1213_Pn may be divided into at least four areas 1213_L1, 1213_L2, 1213_L3, and 1213_L4 logically.

The RAM 1213 may include at least one or more SRAMs physically. That is, the RAM 1213 may include the SRAMs 1213_P1, 1213_P2, . . . , 1213_Pn. Accesses to the storage device 1200 may be made first through the RAM 1213. The SRAMs 1213_P1, . . . , 1213_P2, . . . , 1213_Pn may be arranged in a physical structure where optimal access interfacing is possible in a host side. For example, the SRAMs 1213_P1, 1213_P2, . . . , 1213_Pn may be assigned by a unit of input/output pins DQS and DQ of the DIMM. That is, an SRAM 1213_P1 may be assigned with respect to data input/output pins DQ0 to DQ7 and DQS0, and an SRAM 1213_P2 may be assigned with respect to data input/output pins DQ8 to DQ15 and DQS1.

Under the physical structure of the RAM 1213, the RAM 1213 may be divided into four areas based on functions, logically. Logically, the RAM 1213 may be divided into a command area 1213_L1, a write area 1213_L2, a read area 1213_L3, and a status area 1213_L4. The host may physically write data at the RAM 1213 through the RAM command CMD_R and the RAM address ADDR_R in the DIMM interfacing manner. However, an access command CMD_S or an address ADDR_S about the nonvolatile memory 1230 may be transmitted using data input/output pins DQ and DQS and may be written at the command area 1213_L1 of the RAM 1213. Data to be programmed at the nonvolatile memory 1230 may be written at the write area 1213_L2 of the RAM 1213. Read data requested by the host may be read from the nonvolatile memory 1230, and the read data may be stored in the read area 1213_L3 of the RAM 1213. The host 1100 may fetch data stored in the read area 1213_L3 with reference to information of the status area 1213_L4 of the RAM 1213. Status information of the storage device 1200 may be stored in the status area 1213_L4. The host 1100 may confirm a status of the storage device 1200 through access to the status area 1213_L4 such as polling and may access the storage device 1200.

A sub write request Sub_W_CMD may be provided to the command area 1213_L1 of the RAM 1213 as a write request about sub-data of a size smaller than a minimum transfer unit. Valid data requested to be written, from among data of a write unit, may be stored in the write area 1213_L2. If an optimal write data unit about the nonvolatile memory 1230 is accumulated, the accumulated data may be programmed at a target area of the nonvolatile memory 1230.

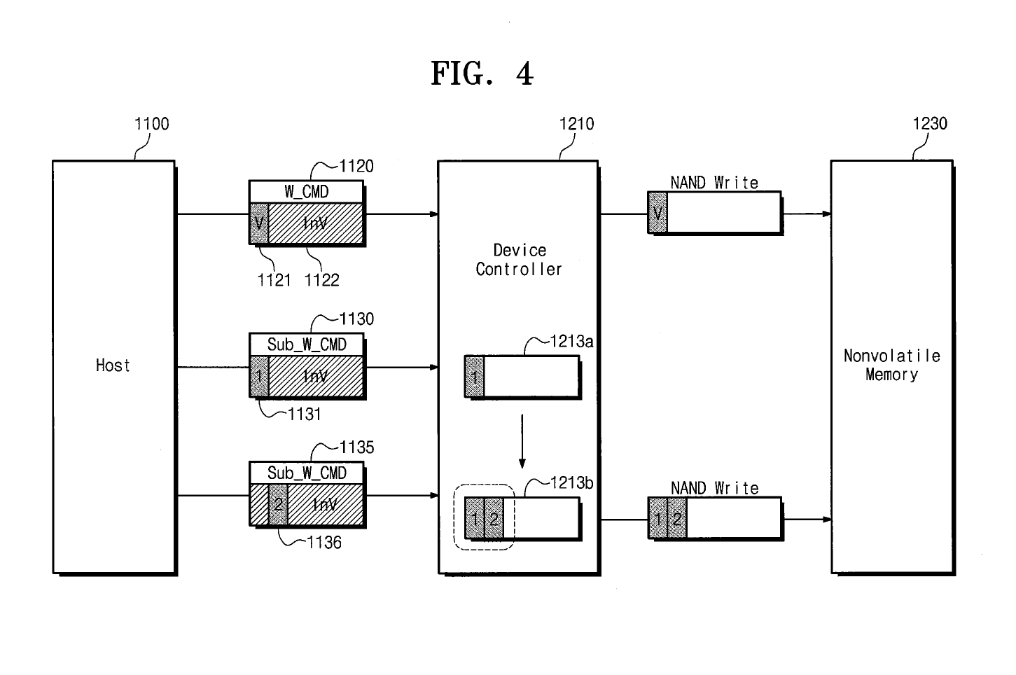

FIG. 4 is a block diagram illustrating a method for writing sub-data, according to embodiments of the inventive concept. Referring to FIG. 4, the host 1100 may transmit sub-data to the device controller 1210 using a sub-write command Sub_W_CMD. Sub-data requested to be written by the sub-write command Sub_W_CMD may be accumulated on the RAM 1213, and the accumulated sub-data may be programmed at the nonvolatile memory 1230.

When requesting the storage device 1200 to write data 1121, the host 1100 may write a normal write command 1120 at the command area 1213_L1. The write-requested sub-data 1121 may compose a write unit together with dummy data 1122 so as to be transmitted to the device controller 1210. At this time, the device controller 1210 may read the data 1121 write requested by the write command W_CMD from the write area 1213_L2 of the RAM 1213 and may program the read data 1121 at the nonvolatile memory 1230. The data 1121 write requested by the normal write command W_CMD may be transmitted to the device controller 1210 by a default transmission unit (1121, 1122) according to the limitations of a protocol of a physical layer of the storage device 1200.

In some embodiments, according to the sub-write command Sub_W_CMD of the inventive concept, the storage device 1200 may identify sub-data relatively and may accumulate the identified sub-data at the RAM 1213. If the size of accumulated sub-data reaches a given size, the accumulated sub-data may be programmed at the nonvolatile memory 1230. This will be in more detail described herein.

The host 1100 may transmit a write request, which is associated with sub-data 1131 smaller in size than the default transmission unit, to the device controller 1210 using the sub-write command Sub_W_CMD (refer to 1130). The host 1100 may write the sub-write command Sub_W_CMD at the command area 1213_L1 of the RAM 1213. Sub-data included in the default transmission unit may be transmitted to the storage device 1200. The sub-write command Sub_W_CMD written in the command area 1213_L1 of the RAM 1213 may include a data offset, indicating a position of the sub-data 1131 at the default transmission unit, and size information of the sub-data 1131. The device controller 1210 may store the sub-data 1131 at the write area 1213_L2 of the RAM 1213 with reference to information written in the command area 1213_L1. The device controller 1210 may postpone programming the sub-data 1131, stored in the write area 1213_L2, at the nonvolatile memory 1230.

Next, the host 1100 may transmit a write request about sub-data 1136 to the device controller 1210 using the sub-write command Sub_W_CMD (refer to 1135). First, the host 1100 may write the sub-write command Sub_W_CMD at the command area 1213_L1 of the RAM 1213. Sub-data 1136 of the default transmission unit may be transmitted to the storage device 1200. The sub-write command Sub_W_CMD written in the command area 1213_L1 of the RAM 1213 may include a data offset, indicating a position of the sub-data 1136 at the default transmission unit, and size information of the sub-data 1136. In some embodiments, the device controller 1210 may store the sub-data 1136 at the write area 1213_L2 of the RAM 1213 with reference to information written in the command area 1213_L1. The device controller 1210 may program the pieces of the sub-data 1131 and 1136, accumulated on the write area 1213_L2, at the nonvolatile memory 1230.

A point in time when the sub-data 1131 and 1136 accumulated by the device controller 1210 is programmed at the nonvolatile memory 1230 may be controlled in various ways. For example, a program point in time of the accumulated sub-data may be determined by providing information about points in time for starting and ending accumulation of the sub-data at the host 1100. Alternatively, the storage device 1200 may automatically program the accumulated sub-data at the nonvolatile memory 1230 with reference to the size of the accumulated sub-data. Below, an embodiment in which the host 1100 provides points in time for starting and ending accumulation of the sub-data will be described. However, such settings related to points in time for starting and ending accumulation of the sub-data according to embodiments of the inventive concept are not be limited to this disclosure.

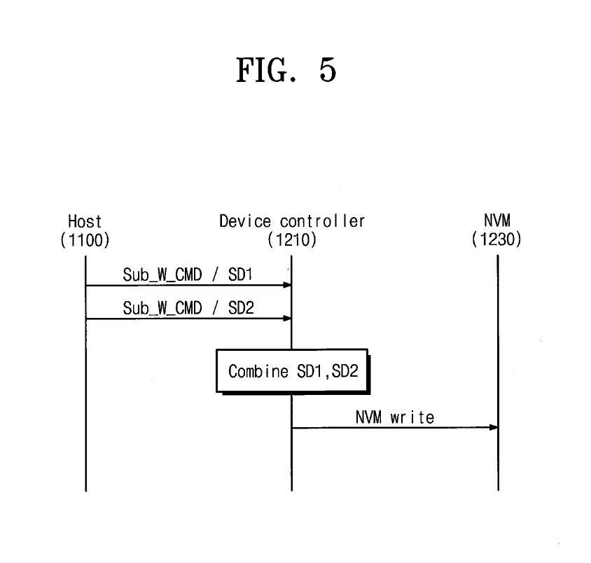

FIG. 5 is a diagram illustrating an embodiment of a method for writing sub-data of FIG. 4. Referring to FIG. 5, the host 1100 may transmit a sub-write command Sub_W_CMD and a write request about sub-data to the device controller 1210. In some embodiments, the device controller 1210 may accumulate the sub-data, may combine accumulated sub-data, and may program the combined sub-data at the nonvolatile memory 1230.

The host 1100 may monitor an occurrence of the write request about the sub-data. If there is issued a write request about data of which the size is greater than or equal to that of a default transmission unit and/or a write unit, the host 1100 may write a normal write command W_CMD at the command area 1213_L1 of the RAM 1213 and may write the write-requested data at the write area 1213_L2. In some embodiments, if there is issued a write request about first sub-data SD1 of which the size is smaller than that of the default transmission unit and/or write unit, the host 1100 may write a sub-write command Sub_W_CMD at the command area 1213_L1 of the RAM 1213 and may write the first sub-data SD1 at the write area 1213_L2. The write method of the host 1100 may be equally applied to the case that a write request of second sub-data SD2 is issued. The host 1100 may write the sub-write command Sub_W_CMD at the command area 1213_L1 of the RAM 1213 and may write the write-requested second sub-data SD2 at the write area 1213_L2. The sub-write command Sub_W_CMD may include a data offset, indicating a position of the sub-data at the default transmission unit, and size information of the sub-data.

The device controller 1210 may accumulate the pieces of the sub-data SD1 and SD2 at the write area 1213_L2 of the RAM 1213. If a specific condition is satisfied, the device controller 1210 may combine the accumulated sub-data SD1 and SD2. The combined sub-data (SD1, SD2) may be programmed at the nonvolatile memory 1230.

The host 1100 may transfer sub-data, of which the size is smaller than that of the default transmission unit, to the storage device 1200 using the sub-write command Sub_W_CMD. The storage device 1200 may accumulate write-requested data on the RAM 1213 until the size of accumulated data reaches a given size and may program the accumulated sub-data at the nonvolatile memory 1230 of the storage device 1200. The sub-data writing method according to embodiments of the inventive concept may make it possible to markedly reduce the number of write operations performed with respect to the nonvolatile memory 1230. Accordingly, it may be possible to extend a life of the storage device 1200 which depends on the number of write operations.

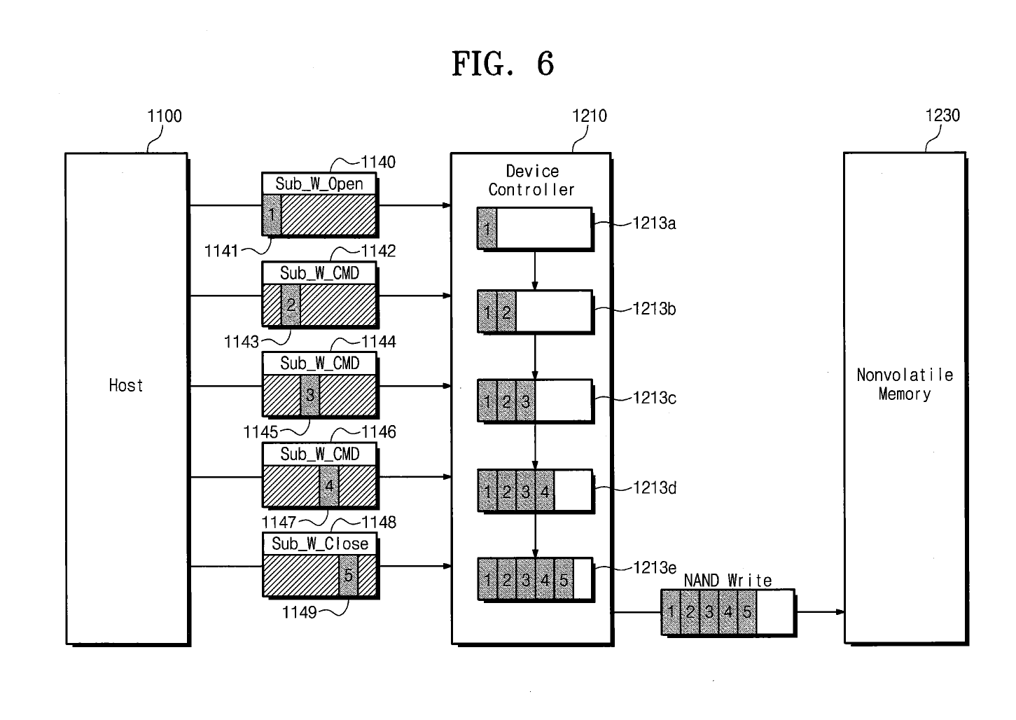

FIG. 6 is a block diagram illustrating a method for writing sub-data, according to embodiments of the inventive concept. Referring to FIG. 6, the host 1100 may control accumulation and program points in time about sub-data using a sub-write open command Sub_W_Open and a sub-write close command Sub_W_Close.

If a write request about sub-data is issued, the host 1100 may provide the device controller 1210 with first sub-data 1141 together with the sub-write open command Sub_W_Open (1140). The sub-write open command Sub_W_Open may include a data offset indicating a position at a write unit of the first sub-data 1141, size information of data, and the like. The host 1100 may write the sub-write open command Sub_W_Open at the command area 1213_L1 of the RAM 1213 through a RAM command CMD_R and a RAM address ADDR_R and may write the first sub-data 1141 at the write area 1213_L2. In this case, the device controller 1210 may postpone programming the first sub-data 1141, which is written in the write area 1213_L2, at the nonvolatile memory 1230 with reference to the sub-write open command written in the command area 1213_L1.

Next, the host 1100 may write the sub-write command Sub_W_CMD (1142) and second sub-data 1143 at the command area 1213_L1 and the write area 1213_L2 of the RAM 1213, respectively. The sub-write command Sub_W_CMD (1142) may include a data offset about the second sub-data 1143, size information of data, and the like. In this case, the device controller 1210 may postpone programming the second sub-data 1143, which is written in the write area 1213_L2 of the RAM 1213, at the nonvolatile memory 1230 with reference to the information written in the command area 1213_L1 of the RAM 1213.

Likewise, the host 1100 may write third sub-data 1145 at the RAM 1213 using a sub-write command Sub_W_CMD (1144). The host 1100 may write fourth sub-data 1147 at the RAM 1213 using a sub-write command Sub_W_CMD (1146). The device controller 1210 may postpone programming the third sub-data 1145 and the fourth sub-data 1147, which are write-requested by the sub-write commands 1144 and 1146, at the nonvolatile memory 1230.

Next, the host 1100 may transmit a write request about sub-data 1149 to the device controller 1210 using the sub-write close command Sub_W_Close (1148). At this time, the sub-write close command Sub_W_Close written in the command area 1213_L1 of the RAM 1213 may include a data offset and size information of the fifth sub-data 1149. In this case, the device controller 1210 may combine the accumulated first to fifth sub-data 1141, 1143, 1145, 1147, and 1149 with reference to the sub-write close command Sub_W_Close written in the command area 1213_L1 of the RAM 1213. The combined first to fifth sub-data 1141, 1143, 1145, 1147, and 1149 may be programmed at the nonvolatile memory 1230.

If receiving the sub-write close command Sub_W_Close (1148), the device controller 1210 may read data, which previously exists in the nonvolatile memory 1230, with reference to address information. The write-requested first to fifth sub-data 1141, 1143, 1145, 1147, and 1149 and the read data may be merged, and the merged data may be programmed at the nonvolatile memory 1230.

There is described an embodiment in which information about times when accumulation of sub-data starts and ends by the host 1100 is controlled by the sub-write open command Sub_W_Open and the sub-write close command Sub_W_Close, respectively.

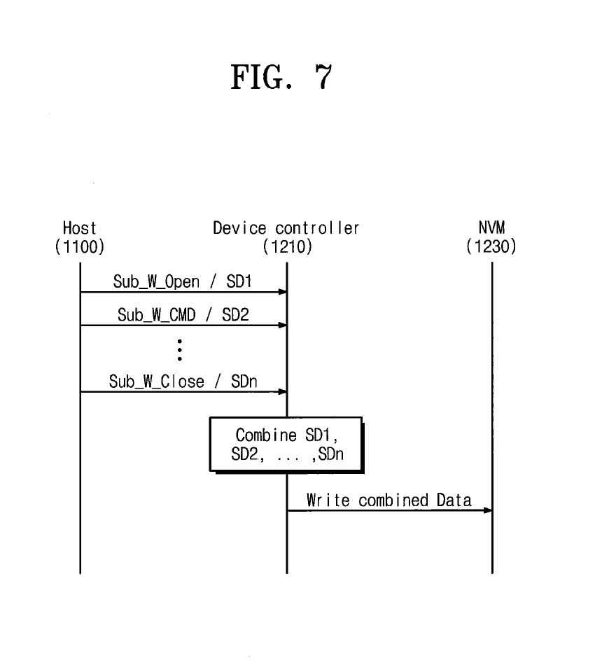

FIG. 7 is a diagram illustrating an embodiment of a method for writing sub-data, according to an embodiment of FIG. 6. Referring to FIG. 7, the host 1100 may control a point in time to accumulate sub-data at the RAM 1213 using the sub-write open command Sub_W_Open, the sub-write command Sub_W_CMD, and the sub-write close command Sub_W_Close.

The host 1100 may monitor an occurrence of a write request about sub-data prior to a write unit. If there is issued a write request about first sub-data SD1, the host 1100 may write the sub-write open command Sub_W_Open at the command area 1213_L1 of the RAM 1213 and may write the write-requested first sub-data SD1 at the write area 1213_L2 of the RAM 1213.

Next, there may be issued a write request about second sub-data SD2 of which the size is smaller than that of the write unit. In this case, the host 1100 may write the sub-write command Sub_W_CMD at the command area 1213_L1 of the RAM 1213 so as to accumulate the second sub-data SD2 at the write area 1213_L2 together with the first sub-data SD1 being accumulated. This write manner may continue until a sub-write close command Sub_W_Close is provided.

The host 1100 may monitor write requests about sub-data of which the size is smaller than that of the default transmission unit, to determine whether the size of pieces of write-requested data is a suitable to program the write-requested data at the nonvolatile memory 1230. If the determination result indicates that the size of pieces of write-requested data is a suitable to program the write-requested data at the nonvolatile memory 1230, the host 1100 may write the sub-write close command Sub_W_Close and the last sub-data SDn at the command area 1213_L1 and the write area 1213_L2 of the RAM 1213, respectively.

The device controller 1210 may start to accumulate data about the write area 1213_L2 of the RAM 1213 from the first sub-data SD1 in response to the sub-write open command Sub_W_Open. The device controller 1210 may postpone programming sub-data SD1 to SDn−1, which are provided together with the sub-write open command Sub_W_Open or the sub-write commands Sub_W_CMD, at the nonvolatile memory 1230.

If the sub-write close command Sub_W_Close is written at the command area 1213_L1 of the RAM 1213, the device controller 1210 may combine the accumulated sub-data SD1 to SDn−1 and the sub-data SDn. The device controller 1210 may program the combined sub-data SD1 to SDn at the nonvolatile memory 1230. The device controller 1210 may perform a read operation about data which is updated with the combined sub-data and may perform an operation to merge the read data with the combined data. In some embodiments, the device controller 1210 may program the merged data at the nonvolatile memory 1230.

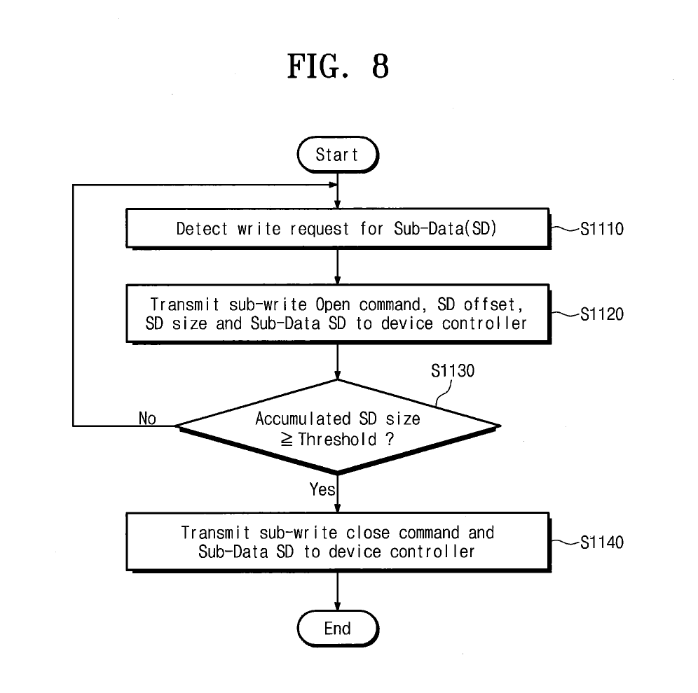

FIG. 8 is a flow chart illustrating an operation of a host for performing the write method of FIG. 6. Referring to FIG. 8, the host 1100 may detect a write request about sub-data and may issue a specialized write command about the sub-data.

In step S1110, the host 1100 may detect whether there is generated a write request to a physical layer about sub-data of which the size is smaller than that of the default transmission unit of a protocol of the physical layer. The write request about the sub-data may occur frequently at a situation such as updating of metadata, writing of juggling data, and the like.

If a first write request about the sub-data is generated, in step S1120, the host 1100 may issue the sub-write open command Sub_W_Open. The sub-write open command Sub_W_Open may include an offset of the write-requested sub-data, a size thereof, an address thereof at the nonvolatile memory 1230, and the like. In contrast, in the case where the write request about the sub-data is not a first or the last write request, the host 1100 may issue the sub-write command Sub_W_CMD. The sub-write open command Sub_W_Open and the sub-write command Sub_W_CMD may refer to a command for postponing programming corresponding data at the nonvolatile memory 1230.

In step S1130, the host 1100 may determine whether the size of accumulated sub-data reaches a threshold. The accumulated size of data write-requested by the sub-write open command Sub_W_Open to data write-requested through the most recent sub-write command Sub_W_CMD may be compared with the threshold. If the accumulated sub-data size is smaller than the threshold (No), the procedure may proceed to step S1110. If the accumulated sub-data size is greater than or equal to the threshold (Yes), the procedure may proceed to step S1140.

In step S1140, the host 1100 may transmit the sub-write close command Sub_W_Close. The host 1100 may provide the sub-write close command Sub_W_Close together with the last sub-data.

A method to transmit a write request about sub-data of a smaller than a default transmission size at the host 1100 is described with reference to FIG. 8.

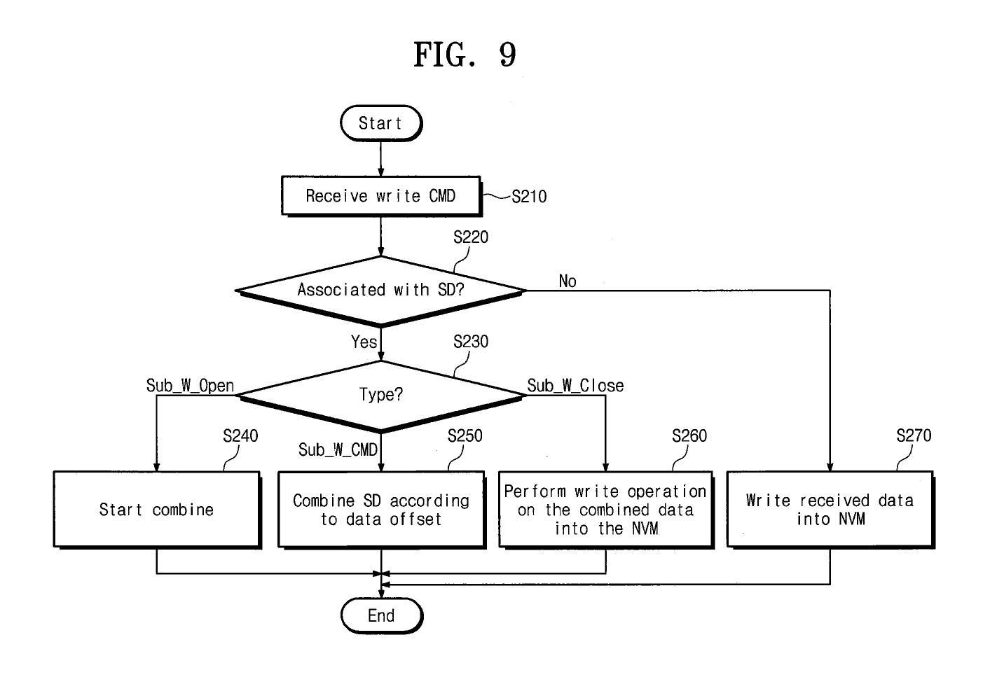

FIG. 9 is a flow chart illustrating an operation of a storage device according to a write request about sub-data of a host. Referring to FIG. 9, the storage device 1200 may manage write-requested sub-data SD based on a type of a command provided from the host 1100.

In step S210, the storage device 1200 may receive a write command from the host 1100. The write command provided from the host 1100 may be stored in the command area 1213_L1 of the RAM 1213.

In step S220, the storage device 1200 may decode or parse a write command stored in the command area 1213_L1 of the RAM 1213 and may determine whether the received write command is the sub-write command Sub_W_CMD. If the received write command is not the sub-write command Sub_W_CMD (No), the procedure may proceed to step S270. If the received write command is the sub-write command Sub_W_CMD (Yes), the procedure may proceed to step S230.

In step S230, the storage device 1200 may determine a type of the write command about sub-data. Commands may, for example, include the sub-write open command Sub_W_Open, the sub-write command Sub_W_Open, and/or the sub-write close command Sub_W_Open. Three operation branches may be possible based on a type of a write command about sub-data written in the command area 1213_L1 of the RAM 1213. If the received write command is the sub-write open command Sub_W_Open, the procedure may proceed to step S240. If the received write command is the sub-write command Sub_W_CMD, the procedure may proceed to step S250. If the received write command is the sub-write close command Sub_W_Close, the procedure may proceed to step S260.

In step S240, the storage device 1200 may start to accumulate sub-data written in the write area 1213_L2 of the RAM 1213 together with the sub-write open command Sub_W_Open. That is, the storage device 1200 may postpone programming sub-data SD1, provided together with the sub-write open command Sub_W_Open, at the nonvolatile memory 1230 and may start to accumulate sub-data in the RAM 1213.

In step S250, the storage device 1200 may manage sub-data, written in the write area 1213_L2 of the RAM 1213 together with the sub-write command Sub_W_CMD. That is, the storage device 1200 may identify valid data with reference to a data offset and may store the identified result at the RAM 1213. Programming data, stored in the RAM 1213, for the nonvolatile memory 1230 may be postponed until the sub-write close command Sub_W_Close is provided.

In step S260, the storage device 1200 may start to combine sub-data written in the write area 1213_L2 of the RAM 1213 together with the sub-write close command Sub_W_Close. The storage device 1200 may program the combined sub-data at a specified area of the nonvolatile memory 1230. In some embodiments, where pieces of sub-data accumulated in the RAM 1213 include data for updating a specific area of the nonvolatile memory 1230, the storage device 1200 may read corresponding data from the nonvolatile memory 1230. The read data and the accumulated data may be merged, and the merged data may be programmed at the nonvolatile memory 1230.

In step S270, since the write-requested data does not correspond to a write command about the sub-data, the storage device 1200 may store the write-requested data in the RAM 1213 and may immediately program the write-requested data at the nonvolatile memory 1230.

An operation of the storage device 1200 about a command may include hint information about management of sub-data is described with reference to FIG. 9. The host 1200 may process sub-data based on at least three distinguishable commands: the sub-write open command Sub_W_Open, the sub-write command Sub_W_CMD, and the sub-write close command Sub_W_Close. The storage device 1200 may markedly reduce the number of program operations, performed with respect to the nonvolatile memory 1230, using a command including hint information about a sub-data processing method.

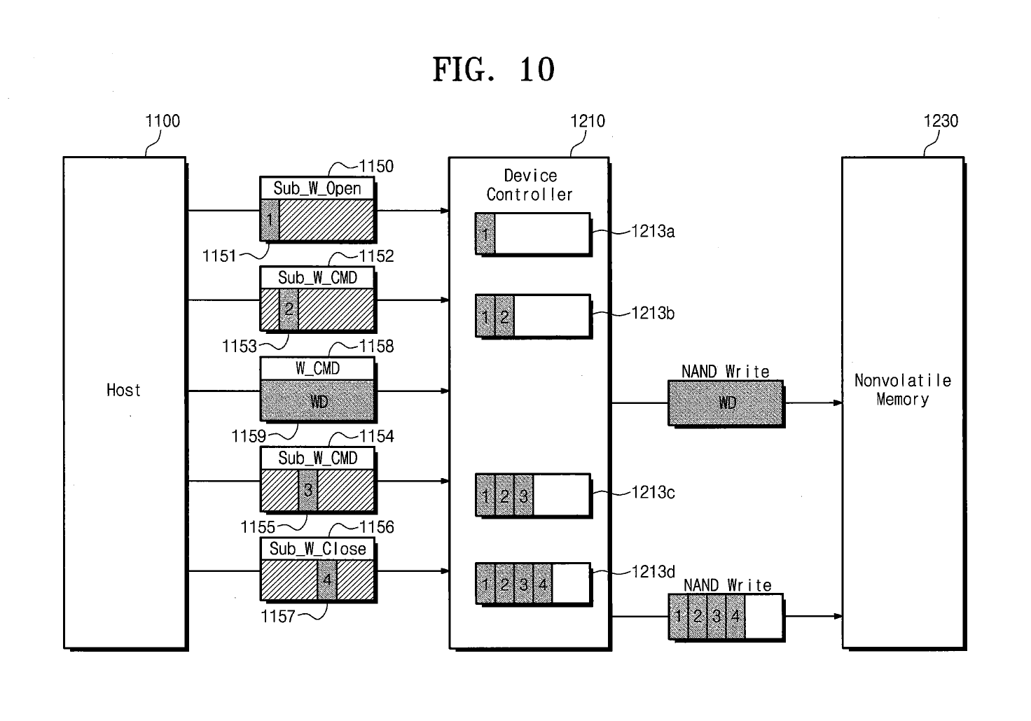

FIG. 10 is a block diagram illustrating an additional operation associated with the embodiment illustrated in FIG. 6. Referring to FIG. 10, there is illustrated an example in which write data of a default transmission unit and a write command are received during an accumulation operation about one sub-data.

The host 1100 may transmit write commands 1150, 1152, 1154, and 1156 for writing pieces of sub-data 1151, 1153, 1155, and 1157 of a small size to the device controller 1210. The host 1100 may transmit write command 1158 for writing pieces of data 1159 of a default transmission size to the device controller 120. In detail, the host 1100 may write a second sub-write command 1152 and sub-data 1153 at the command area 1213_L1 and the write area 1213_L2 of the RAM 1213 and may then write the write command 1158 for writing data 1159 of a write unit at the command area 1213_L1.

The storage device 1200 may write the data 1159 of the write unit at the nonvolatile memory 1230 in response to a write command W_CMD about the data 1159 of the write unit provided while cumulating the sub-data 1151, 1153, 1155, and 1157. Accumulation or combination of sub-data 1155 and 1157 after the data 1159 of the write unit is programmed at the nonvolatile memory 1230 may be performed in response to the sub-write command 1154 and a sub-write close command 1156. That is, based on the sub-write close command 1156, accumulation of data may be ended, and the sub-data 1151, 1153, 1155, and 1157 thus accumulated may be programmed at the nonvolatile memory 1230.

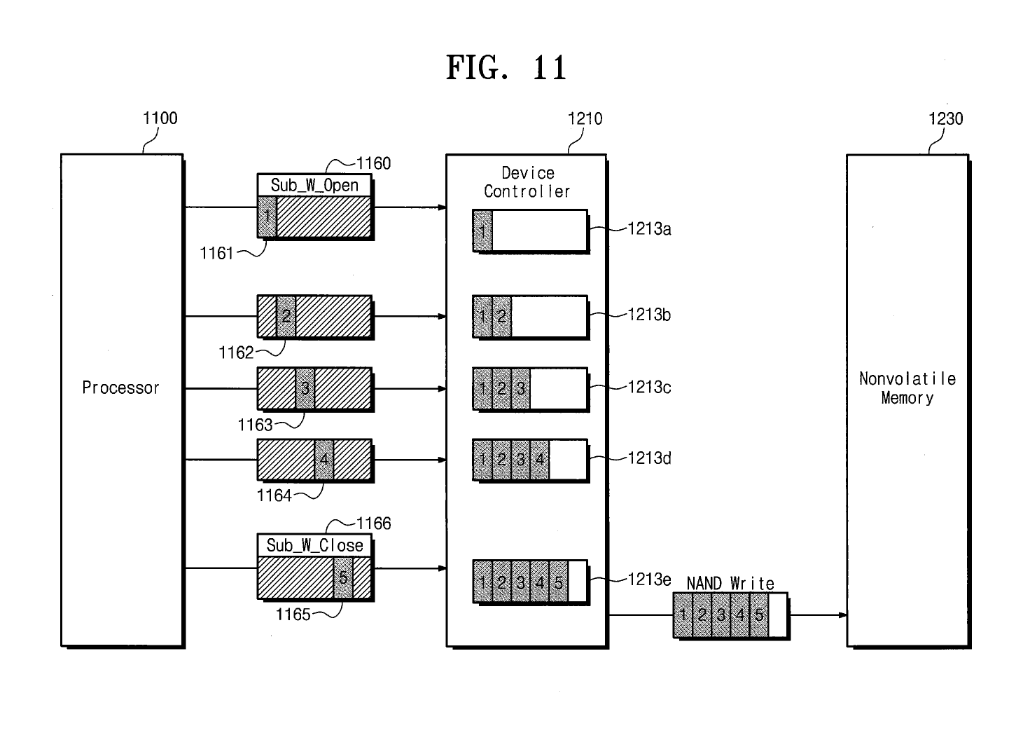

FIG. 11 is a block diagram illustrating a method for writing sub-data, according to embodiments of the inventive concept. Referring to FIG. 11, the host 1100 may use a sub-write open command Sub_W_Open (1160) and a sub-write close command Sub_W_Close (1165) as a write command about sub-data.

The host 1100 may inform the storage device 1200 of a write start about sub-data using the sub-write open command Sub_W_Open (1160). The host 1100 may provide the sub-write close command Sub_W_Close (1166) to the storage device 1200 so as to end accumulation of sub-data. The host 1100 may transmit only sub-data 1162, 1163, and 1164 between the sub-write open command Sub_W_Open and the sub-write close command Sub_W_Close without a separate command.

If a write request about sub-data is issued, the host 1100 may provide the device controller 1210 with first sub-data 1161 together with the sub-write open command Sub_W_Open (1160). The sub-write open command Sub_W_Open (1160) may include a data offset indicating a position at a write unit of the first sub-data 1161, size information of data transmitted, and the like. The host 1100 may write the sub-write open command Sub_W_Open (1160) at the command area 1213_L1 of the RAM 1213 through a RAM command CMD_R and a RAM address ADDR_R and may write the first sub-data 1161 at the write area 1213_L2. In this case, the device controller 1210 may postpone programming the first sub-data 1161, which is written in the write area 1213_L2, at the nonvolatile memory 1230 with reference to the sub-write open command written in the command area 1213_L1.

Next, if a write request about sub-data occurs, the host 1100 may write second sub-data 1162 at the write area 1213_L2 of the RAM 1213 without providing a separate command. A data offset or size information about the second sub-data 1162 may be previously defined by the sub-write open command Sub_W_Open (1160). Accordingly, the device controller 1210 may identify pieces of sub-data 1162, 1163, 1164 using the sub-write open command Sub_W_Open (1160) until a sub-write close command Sub_W_Close (1166) is written and may accumulate the identified sub-data in the RAM 1213.

If there is determined that pieces of sub-data of which the size is greater than or equal to a specific size are written in the RAM 1213, the host 1100 may transmit the sub-write close command Sub_W_Close (1166) and the last sub-data 1165. Upon receiving the sub-write close command Sub_W_Close (1166) and the last sub-data 1165, the device controller 1210 may stop accumulating the received sub-data 1161, 1162, 1163, 1164, and 1165 and may program the accumulated data at the nonvolatile memory 1230. That is, the device controller 1210 may combine the sub-data 1161, 1162, 1163, 1164, and 1165 stored in the RAM 1213 and may program the combined data at the nonvolatile memory 1230. Here, if the sub-data 1161, 1162, 1163, 1164, and 1165 are information indicating the update of specific data of the nonvolatile memory 123, there may be additionally performed an operation to read and merge data to be updated from the nonvolatile memory 1230.

States 1213a, 1213b, 1213c, 1213d, and 1213e of the write area 1213_L2 of the RAM 1213 illustrated in the device controller 1210 sequentially show states in which the sub-data 1161, 1162, 1163, 1164, 1165 are written. The device controller 1210 may identify sub-data with reference to a data offset or data size information defined in the sub-write open command Sub_W_Open (1160) and may store the sub-data at the RAM 1213 based on the identification result.

There is described an embodiment in which management information about the sub-data 1161, 1162, 1163, 1164, and 1165 is provided using the sub-write open command Sub_W_Open and the sub-write close command Sub_W_Close by the host 1100.

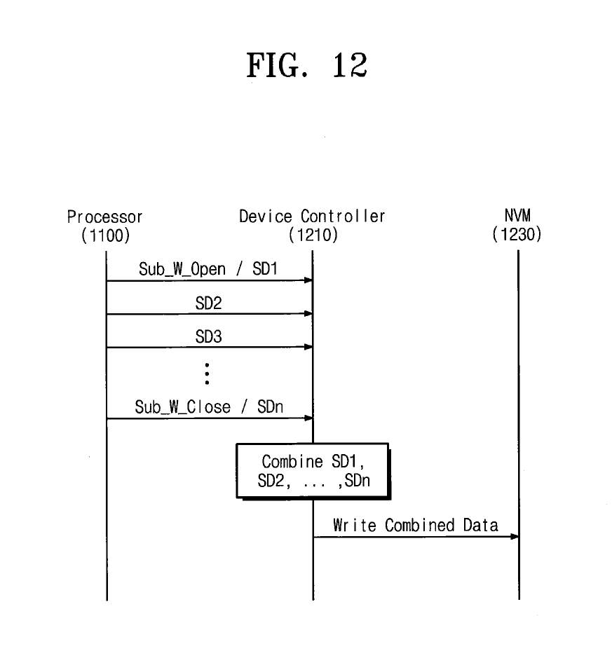

FIG. 12 is a diagram illustrating a method for writing sub-data, according to the embodiment of FIG. 10. Referring to FIG. 12, the host 1100 may control an accumulation point in time about sub-data using the sub-write open command Sub_W_Open and the sub-write close command Sub_W_Close.

The host 1100 may monitor an occurrence of a write request about sub-data of which the size is smaller than a write unit. If a write request about first sub-data SD1 occurs, the host 1100 may write the sub-write open command Sub_W_Open at the command area 1213_L1 of the RAM 1213 and may write the write-requested first sub-data SD1 at the write area 1213_L2. The sub-write open command Sub_W_Open may include offset information and size information of pieces of sub-data to be transmitted later.

Next, a write request about second sub-data SD2 may occur. In this case, the host 1100 may write the second sub-data SD2 at the write area 1213_L2 of the RAM 1213 without writing a separate command. At this time, the second sub-data SD2 may be identified by offset and size information defined in the sub-write open command Sub_W_Open, at one write unit. Likewise, the host 1100 may compose one write unit with respect to third sub-data SD3 and may write resultant data at the RAM 1213.

The host 1100 may monitor write requests about sub-data of which the size is smaller than that of the default transmission unit, to detect a size of accumulated sub-data. If the detected size of sub-data reaches a specific size, the host 1100 may provide the storage device 1200 with the sub-write close command Sub_W_Close and the last sub-data SDn.

The device controller 1210 may start to accumulate data at the write area 1213_L2 of the RAM 1213 from the first sub-data SD1 in response to the sub-write open command Sub_W_Open. The device controller 1210 may postpone programming sub-data SD2 to SDn−1, which are stored in the write area 1213_L2 of the RAM 1213, until the sub-write close command Sub_W_Close is provided. The device controller 1210 may combine the accumulated sub-data SD1 to SDn if the sub-write close command Sub_W_Close and the last sub-data SDn are respectively written at the command area 1213_L1 and the write area 1213_L2 of the RAM 1213. The device controller 1210 may program the combined sub-data SD1 to SDn at the nonvolatile memory 1230. Although not shown, in the case where the combined sub-data is data for updating specific data of the nonvolatile memory 1230, the device controller 1210 may perform a read operation about the nonvolatile memory 1230 and an operation to merge the read data with the combined data. In this case, the device controller 1210 may program the merged data at the nonvolatile memory 1230.

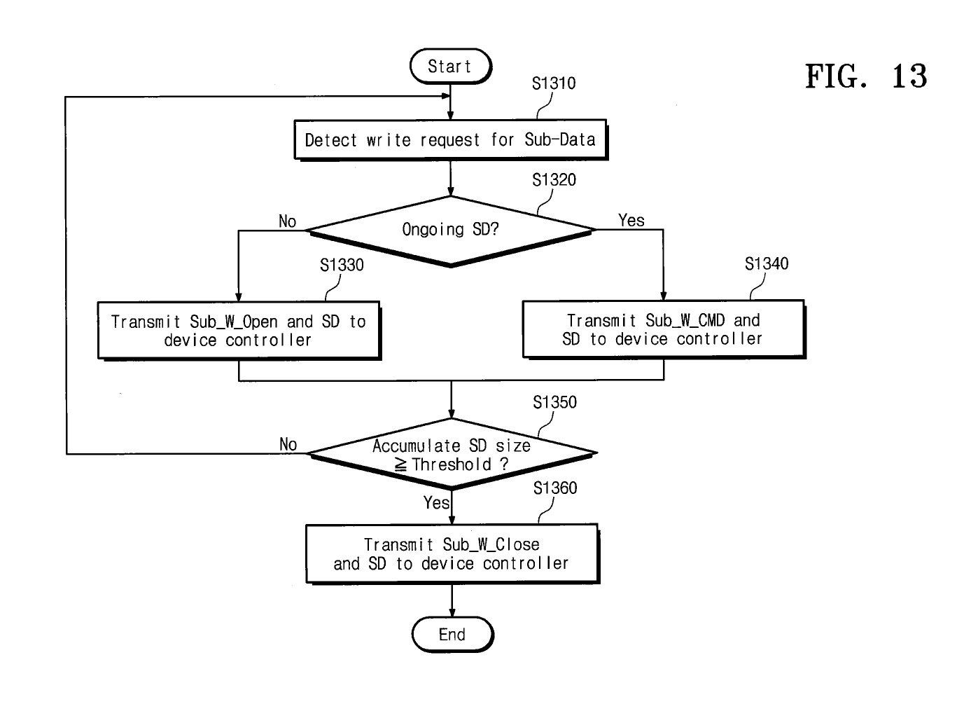

FIG. 13 is a flow chart illustrating an operation of a host for performing the write method of FIG. 12. Referring to FIG. 13, the host 1100 may detect a write request about sub-data of a size smaller than a default transmission unit and may issue a specialized write command about the sub-data.

In step S1310, the host 1100 may detect an occurrence of a write request to a physical layer about sub-data of which the size is smaller than that of the default transmission unit limited according to a protocol of the physical layer. The write request about the sub-data may occur frequently in some situations such as updating of metadata.

In step S1320, the host 1100 may determine whether the write request about the sub-data is a first write request or whether writing of sub-data is ongoing. In the case where the write request about the sub-data is a first write request (No), the procedure may proceed to step S1330. In contrast, in the case where writing of sub-data is ongoing, the procedure may proceed to step S1340.

In step S1330, the host 1100 may issue the sub-write open command Sub_W_Open. The sub-write open command Sub_W_Open may include an offset of the write-requested data, a size thereof, an address thereof at the nonvolatile memory 1230, and the like. Afterwards, the offset and size information of the data may indicate a position at a write unit of sub-data to be stored in the write area 1213_L2 of the RAM 1213 and size information thereof. In some embodiments, the data of a write unit including sub-data is may only be transmitted to the storage device 1200 until the sub-write close command Sub_W_Close is transmitted.

In step S1340, the host 1100 may transmit only sub-data to the storage device 1200 by a write unit because the write request about the sub-data is not the first write request or the last write request. The host 1100 may write the sub-data at the storage device 1200 based on the offset and size defined in the sub-write open command Sub_W_Open. In this case, sub-data may be sequentially accumulated in the write area 1213_L2 of the RAM 1213.

In step S1350, the host 1100 may determine whether the size of accumulated sub-data has reached a threshold. The accumulated size of data write-requested by the sub-write open command Sub_W_Open to sub-data written most recently may be compared with the threshold. If the accumulated sub-data size is smaller than the threshold (No), the procedure may proceed to step S1310. If the accumulated sub-data size is greater than or equal to the threshold (Yes), the procedure may proceed to step S1360.

In step S1360, the host 1100 may output the sub-write close command Sub_W_Close. The host 1100 may provide the sub-write close command Sub_W_Close and the last sub-data together.

There is described a method in which a write request about sub-data is written in the storage device 1200 using the sub-write open command Sub_W_Open and the sub-write close command Sub_W_Close at the host 1100.

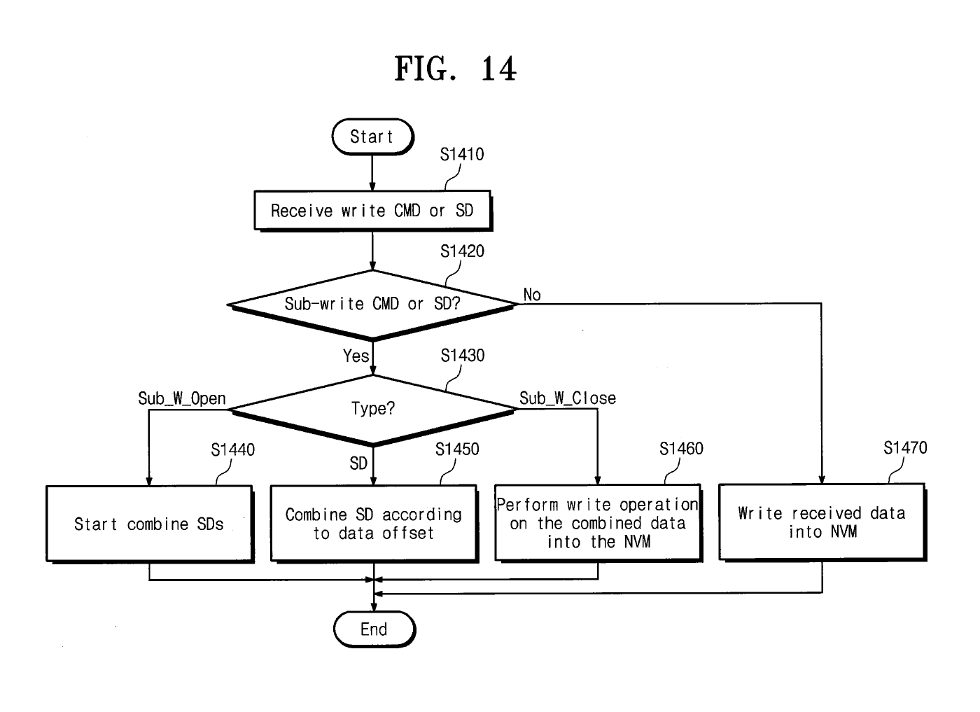

FIG. 14 is a flow chart illustrating an operation of a storage device according to a write request about sub-data of a host. Referring to FIG. 14, the storage device 1200 may manage write-requested sub-data based on a type of a command provided from the host 1100.

In step S1410, the storage device 1200 may receive a write command or sub-data from the host 1100. The write command provided from the host 1100 may be stored in the command area 1213_L1 of the RAM 1213. The sub-data may be stored in the write area 1213_L2 of the RAM 1213.

In step S1420, the storage device 1200 may decode or parse the write command stored in the command area 1213_L1 of the RAM 1213 and may determine whether the received write command is a write command about sub-data. The storage device 1200 may determine whether the received write command is sub-data transmitted without a command, a sub-write open command Sub_W_Open or a sub-write close command Sub_W_Close. If the received write command W_CMD is not a write command associated with sub-data (No), the procedure may proceed to step S1470. If the received write command W_CMD is a write command associated with sub-data (Yes), the procedure may proceed to step S1430.

In step S1430, the storage device 1200 may determine a type of the write command about sub-data. Commands of such a kind may include the sub-write open command Sub_W_Open and the sub-write close command Sub_W_Close. In addition, a case where sub-data are transmitted without a command may be possible. At least three operation branches may be possible based on a type of a write command about sub-data written in the command area 1213_L1 of the RAM 1213 and the case that sub-data is transmitted alone without a command. If the received write command is the sub-write open command Sub_W_Open, the procedure may proceed to step S1440. In the case where the sub-data are transmitted without a command, the procedure may proceed to step S1450. If the received write command is the sub-write close command Sub_W_Close, the procedure may proceed to step S1460.

In step S1440, the storage device 1200 may start to accumulate sub-data written in the write area 1213_L2 of the RAM 1213 together with the sub-write open command Sub_W_Open. That is, the storage device 1200 may postpone programming sub-data SD1, provided together with the sub-write open command Sub_W_Open, at the nonvolatile memory 1230 and may start to accumulate sub-data in the RAM 1213.

In step S1450, the storage device 1200 may accumulate the sub-data, which is transmitted alone without a command, together with previously stored sub-data. That is, the storage device 1200 may identify valid data with reference to a data offset transmitted through the sub-write open command Sub_W_Open and may store the identified result at the RAM 1213. Programming data, stored in the RAM 1213, at the nonvolatile memory 1230 may be postponed until the sub-write close command Sub_W_Close is provided.

In step S1460, the storage device 1200 may start to combine sub-data written in the write area 1213_L2 of the RAM 1213 together with the sub-write close command Sub_W_Close. The storage device 1200 may program the combined sub-data at a specified area of the nonvolatile memory 1230. In the case where pieces of sub-data accumulated in the RAM 1213 include data for updating a specific area of the nonvolatile memory 1230, the storage device 1200 may read corresponding data from the nonvolatile memory 1230. The read data and the accumulated data may be merged, and the merged data may be programmed at the nonvolatile memory 1230.

In step S1470, since the write-requested data does not correspond to a write command about the sub-data, the storage device 1200 may store the write-requested data in the RAM 1213 and may program the write-requested data at the nonvolatile memory 1230 without accumulating it in the RAM 1213.

A response of the storage device 1200 to a command including hint information about management of sub-data is described with reference to FIG. 14. The storage device 1200 may process sub-data using the sub-write open command Sub_W_Open and the sub-write close command Sub_W_Close. The storage device 1200 may markedly reduce the number of program operations, performed with respect to the nonvolatile memory 1230, using a command including hint information about a sub-data processing method.

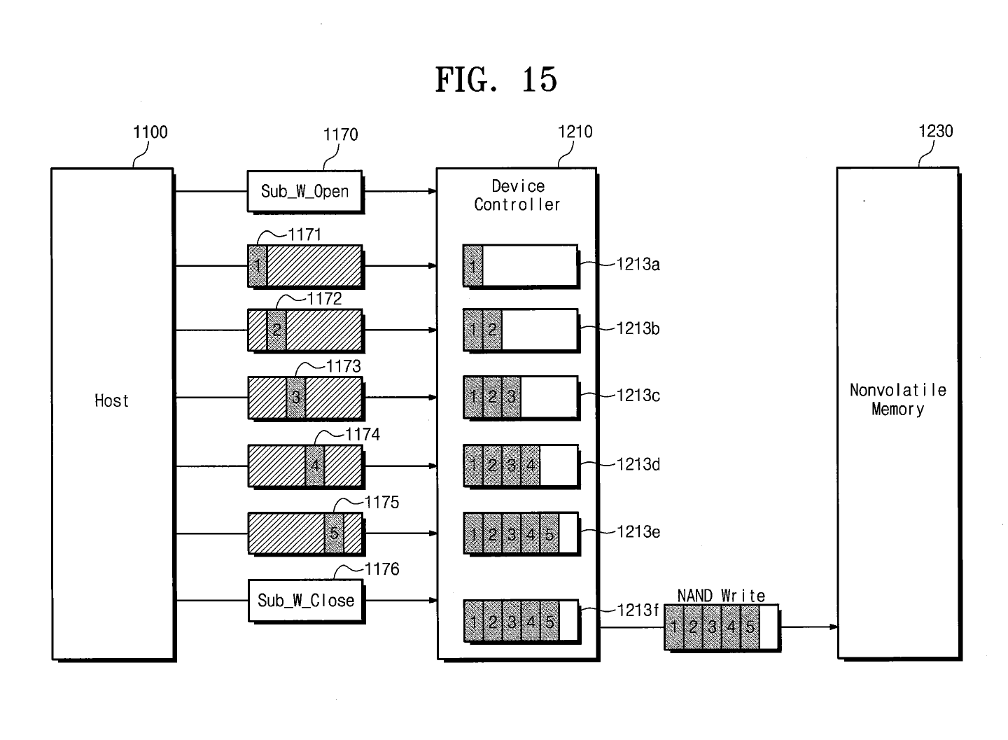

FIG. 15 is a block diagram illustrating a method for writing sub-data, according to embodiments of the inventive concept. Referring to FIG. 15, the host 1100 may use the sub-write open command Sub_W_Open and the sub-write close command Sub_W_Close as a write command about sub-data. In some embodiments, such commands and sub-data may be separated as independent transactions. That is, the sub-write open command Sub_W_Open and the sub-write close command Sub_W_Close may be written in the storage device 1200 independently at a separate transaction from the sub-data, as detailed herein.

If a write request about sub-data is detected, the host 1100 may provide the device controller 1210 with the sub-write open command Sub_W_Open (1170). The host 1100 may write only the sub-write command Sub_W_CMD at the command area 1213_L1 of the RAM 1213. Here, the sub-write open command Sub_W_Open may include a data offset indicating a position at a write unit of each sub-data, size information of data transmitted once, and the like. In this case, the device controller 1210 may understand an intention of the host 1100 to allow transmission of the sub-data.

The host 1100 may write sub-data 1171 at the write area 1213_L2 of the RAM 1213 following the sub-write open command Sub_W_Open. If a write request of pieces of additional sub-data occurs, the host 1100 may sequentially write sub-data 1171, 1172, 1173, 1174, and 1175 at the write area 1213_L2 of the RAM 1213 without sending an additional command. Here, the sub-data 1171, 1172, 1173, 1174, and 1175 stored in the RAM 1213 may pass through a physical layer. For this reason, each of the sub-data 1171, 1172, 1173, 1174, and 1175 may be transmitted by a write unit.

The sub-data 1171, 1172, 1173, 1174, and 1175 write-requested by the sub-write open command Sub_W_Open may be stored and retained in the write area 1213_L2 of the RAM 1213. Programming the sub-data 1171, 1172, 1173, 1174, and 1175 at the nonvolatile memory 1230 may be postponed.

If there is determined that data of which the size is greater than or equal to a specific size is stored in the RAM 1213, the host 1100 may write the sub-write close command Sub_W_Close (1176) at the command area 1213_L1 of the RAM 1213. In some embodiments, the device controller 1210 may identify the sub-write close command Sub_W_Close (1176) and may combine the sub-data 1171, 1172, 1173, 1174, and 1175. The combined sub-data 1171, 1172, 1173, 1174, and 1175 may be programmed at the nonvolatile memory 1230. Merging of the combined sub-data 1171, 1172, 1173, 1174, and 1175 may also be performed.

States 1213a, 1213b, 1213c, 1213d, 1213e, and 1213f of the write area 1213_L2 of the RAM 1213 illustrated in the device controller 1210 sequentially show states in which the sub-data 1171, 1172, 1173, 1174, 1175 are written. The device controller 1210 may identify sub-data with reference to a data offset or data size information defined in the sub-write open command Sub_W_Open (1170) and may store the sub-data at the RAM 1213 based on the identification result.

There is described an embodiment in which management information about the sub-data 1171, 1172, 1173, 1174, and 1175 is provided only using the sub-write open command Sub_W_Open and the sub-write close command Sub_W_Close by the host 1100. A set of a command and data may not be provided, but sub-data provided between the sub-write open command Sub_W_Open and the sub-write close command Sub_W_Close may be accumulated in the write area 1213_L2 of the RAM 1213. The accumulated sub-data may be programmed at the nonvolatile memory 1230 in response to the sub-write close command Sub_W_Close.

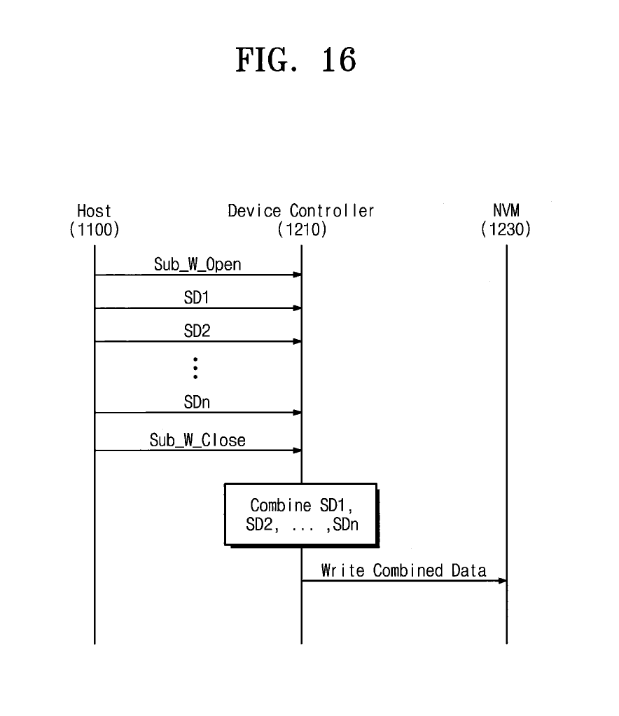

FIG. 16 is a diagram illustrating an embodiment of a method for writing sub-data of FIG. 15. Referring to FIG. 16, the host 1100 may control a point in time to accumulate sub-data at the RAM 1213 using the sub-write open command Sub_W_Open and the sub-write close command Sub_W_Close.

The host 1100 may monitor an occurrence of a write request about sub-data of which the size is smaller than a default transmission unit. If a write request about first sub-data SD1 occurs, the host 1100 may write a sub-write open command Sub_W_Open at the storage device 1200. The sub-write open command Sub_W_Open may include offset information and size information of pieces of sub-data to be transmitted later. Although not shown, the host 1100 may receive a permission message about the sub-write open command Sub_W_Open from the storage device 1200.

Next, the host 1100 may write first sub-data SD1 write-requested at the write area 1213_L2 of the RAM 1213. If a write request of additional sub-data occurs, the host 1100 may write second sub-data SD2 by a write unit without a command. The second sub-data SD may be stored in the write area 1213_L2 of the RAM 1213. With the above description, sub-data SD3 to SDn may be sequentially stored in the write area 1213_L2 of the RAM 1213.

The host 1100 may monitor write requests about sub-data of which the size is smaller than that of the default transmission unit, to detect a size of accumulated sub-data. If the detected size of sub-data reaches a specific size, the host 1100 may provide the storage device 1200 with the sub-write close command Sub_W_Close.

The device controller 1210 may start to accumulate data at the write area 1213_L2 of the RAM 1213 from the first sub-data SD1 in response to the sub-write open command Sub_W_Open. The device controller 1210 may postpone programming sub-data SD2 to SDn, which are stored in the write area 1213_L2 of the RAM 1213, until the sub-write close command Sub_W_Close is provided. The device controller 1210 may combine the accumulated sub-data SD1 to SDn if the sub-write close command Sub_W_Close is written at the command area 1213_L1. The device controller 1210 may program the combined sub-data SD1 to SDn at the nonvolatile memory 1230. Although not shown, in the case where the combined sub-data is data for updating specific data of the nonvolatile memory 1230, the device controller 1210 may perform a read operation of the nonvolatile memory 1230 and an operation to merge the read data with the combined data. In this case, the device controller 1210 may program the merged data at the nonvolatile memory 1230.

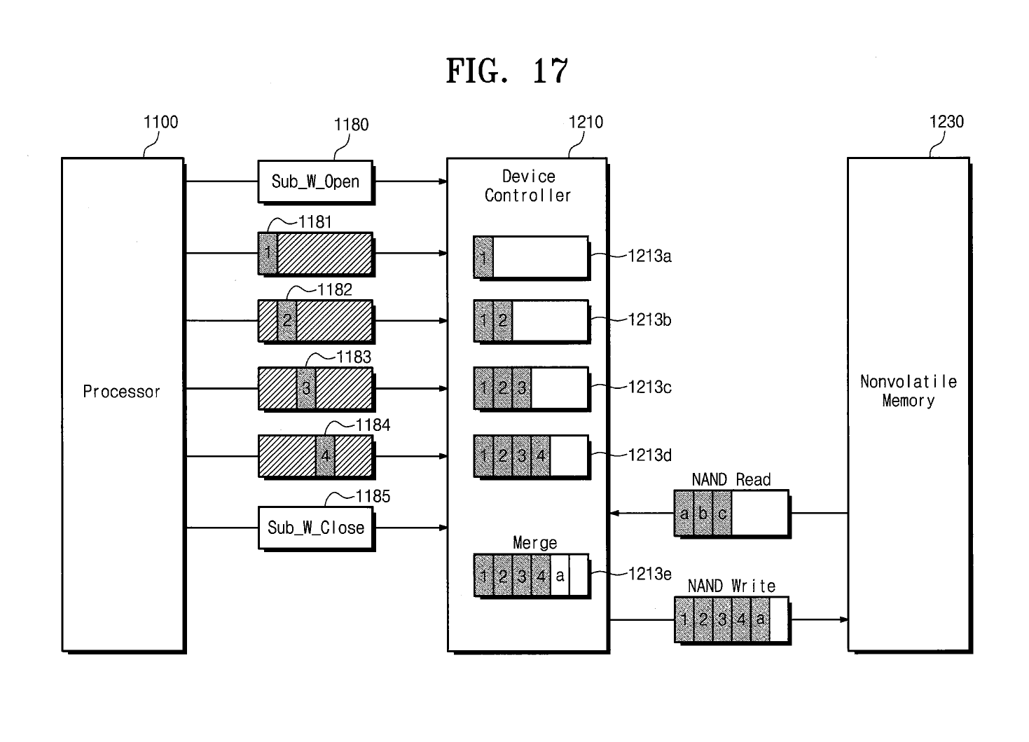

FIG. 17 is a block diagram illustrating the case that a merge operation may be added to the embodiment of FIG. 15. Referring to FIG. 17, the host 1100 may use the sub-write open command Sub_W_Open and the sub-write close command Sub_W_Close as a write command about sub-data.

If a write request about sub-data is detected, the host 1100 may provide the device controller 1210 with the sub-write open command Sub_W_Open (1180). For example, the host 1100 may write the sub-write open command Sub_W_Open at the command area 1213_L1 of the RAM 1213. Here, the sub-write open command Sub_W_Open may include a data offset indicating a position at a default transmission unit of each sub-data, size information of data transmitted once, and the like.

The host 1100 may write sub-data 1181 at the write area 1213_L2 of the RAM 1213 following the sub-write open command Sub_W_Open. If a write request of pieces of additional sub-data occurs, the host 1100 may sequentially write sub-data 1181, 1182, 1183, and 1184 at the write area 1213_L2 of the RAM 1213 without sending an additional command. Here, the sub-data 1181, 1182, 1183, and 1184 stored in the RAM 1213 may pass through a physical layer. For this reason, each of the sub-data 1181, 1182, 1183, 1184, and 1175 may be transmitted by a default transmission unit.

The sub-data 1181, 1182, 1183, and 1184 write-requested by the sub-write open command Sub_W_Open (1180) may be stored and retained in the write area 1213_L2 of the RAM 1213. Programming the sub-data 1181, 1182, 1183, and 1184 at the nonvolatile memory 1230 may be postponed.

If there is determined that data of which the size is greater than or equal to a specific size is stored in the RAM 1213, the host 1100 may write the sub-write close command Sub_W_Close (1185) at the command area 1213_L1 of the RAM 1213. In this case, the device controller 1210 may identify the sub-write close command Sub_W_Close (1185) and may read data to be updated with the sub-data 1181, 1182, 1183, and 1184 from the nonvolatile memory 1230. A merge operation may be performed with respect to the data read from the nonvolatile memory 1230 and the accumulated data. The merged data may be programmed at the nonvolatile memory 1230.

There is described an embodiment in which management information about the sub-data 1181, 1182, 1183, and 1184 is provided using the sub-write open command Sub_W_Open and the sub-write close command Sub_W_Close by the host 1100. For another example, the sub-data 1181, 1182, 1183, and 1184 accumulated in the RAM 1213 may be able to be programmed after being merged with to-be-updated data read from the nonvolatile memory 1230.

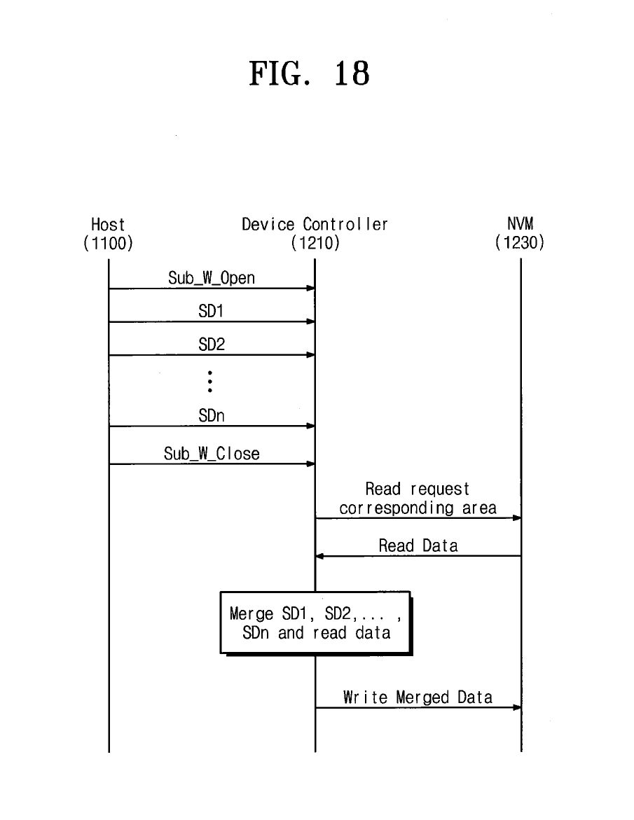

FIG. 18 is a diagram illustrating an embodiment of the method for writing sub-data of FIG. 17. Referring to FIG. 18, the host 1100 may control a point in time to accumulate sub-data at the RAM 1213 using the sub-write open command Sub_W_Open and the sub-write close command Sub_W_Close.

The host 1100 may monitor an occurrence of a write request about sub-data of which the size is smaller than a default transmission unit. If a write request about first sub-data SD1 occurs, the host 1100 may write a sub-write open command Sub_W_Open at the storage device 1200. The sub-write open command Sub_W_Open may include offset information and size information of pieces of sub-data to be transmitted later. Although not shown, the host 1100 may receive a permission message about the sub-write open command Sub_W_Open from the storage device 1200.

Next, the host 1100 may write first sub-data SD1 write-requested at the write area 1213_L2 of the RAM 1213. If a write request of additional sub-data occurs, the host 1100 may write second sub-data SD2 by a write unit without a command. The second sub-data SD2 may be stored in the write area 1213_L2 of the RAM 1213. With the above description, sub-data SD3 to SDn may be sequentially stored in the write area 1213_L2 of the RAM 1213.

The host 1100 may monitor write requests about sub-data of which the size is smaller than that of the write unit, to detect a size of accumulated sub-data. If the detected size of sub-data reaches a specific size, the host 1100 may provide the storage device 1200 with the sub-write close command Sub_W_Close.

The device controller 1210 may start to accumulate data at the write area 1213_L2 of the RAM 1213 from the first sub-data SD1 in response to the sub-write open command Sub_W_Open. The device controller 1210 may postpone programming sub-data SD2 to SDn, which are stored in the write area 1213_L2 of the RAM 1213, until the sub-write close command Sub_W_Close is provided. If the sub-write close command Sub_W_Close is written in the command area 1213_L1 of the RAM 1213, the device controller 1210 may read data to be updated with the accumulated sub-data from the nonvolatile memory 1230.

The read data and the accumulated sub-data SD1 to SDn may be merged. The device controller 1210 may program the merged data at the nonvolatile memory 1230.

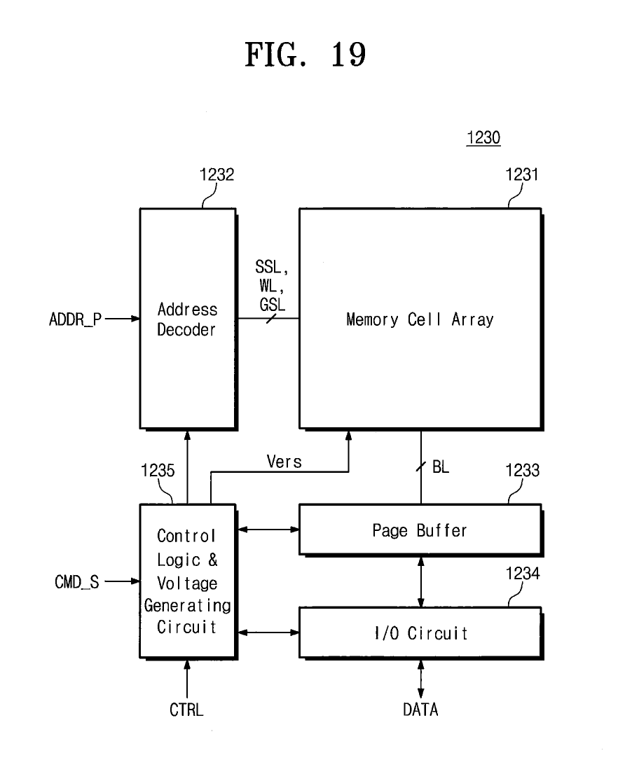

FIG. 19 is a block diagram schematically illustrating an embodiment of one of nonvolatile memories of FIG. 1. Referring to FIG. 19, the nonvolatile memory 1230 may include a memory cell array 1231, an address decoder 1232, a page buffer 1233, an input/output circuit 1234, and a control logic and voltage generator circuit 1235.

The memory cell array 1231 may include a plurality of memory cells. Each of the memory blocks may include a plurality of cell strings. Each of the cell strings may include a plurality of memory cells. The memory cells may be connected with a plurality of word lines WL. Each memory cell may be a single level cell (SLC) storing one bit or a multi-level cell (MLC) storing at least two bits.

The address decoder 1232 may be connected with the memory cell array 1231 through the word lines WL, string selection lines SSL, and ground selection lines GSL The address decoder 1232 may receive and decode a physical address ADDR_P from an external device and may drive the word lines WL based on the decoding result. For example, the address decoder 1232 may decode a physical address ADDR_P received from the external device, may select at least one of the word lines WL based on the decoded physical address ADDR_P, and may drive the selected word line WL. In some embodiments, the physical address ADDR_P may be a physical address which is obtained by converting a storage address ADDR_N (refer to FIG. 1) and corresponds to a first nonvolatile memory 1230. The above-described address conversion operation may be performed by the device controller 1210 or by a flash translation layer (FTL) which is driven by the device controller 1210.

The page buffer 1233 may be connected to the memory cell array 1231 through the bit lines BL. Under control of the control logic and voltage generator circuit 1235, the page buffer 1233 may control the bit lines BL such that data provided from the input/output circuit 1234 is stored in the memory cell array 1231. Under control of the control logic and voltage generator circuit 1235, the page buffer 1233 may read data stored in the memory cell array 1231 and may provide the read data to the input/output circuit 1234. For example, the page buffer 1233 may be provided with data from the input/output circuit 1234 by the page or may read data from the memory cell array 1231 by the page.

The input/output circuit 1234 may receive data from the external device and may transfer the received data to the page buffer 1233. In some embodiments, the input/output circuit 1234 may receive data from the page buffer 1233 and may transmit the received data to the external device (e.g., the device controller 1210). For example, the input/output circuit 1234 may exchange data with the external device in synchronization with the control signal CTRL.

The control logic and voltage generator circuit 1235 may control the address decoder 1232, the page buffer 1233, and the input/output circuit 1234 in response to a storage command CMD_S and a control logic CTRL from the external device. For example, the control logic and voltage generator circuit 1235 may control other components in response to the signals CMD_S and CTRL such that data is stored in the memory cell array 1231. In some embodiments, the control logic and voltage generator circuit 1235 may control other components in response to the signals CMD_S and CTRL such that data stored in the memory cell array 1231 is transmitted to the external device. In some embodiments, the storage command CMD_S received from the external device may be a modified version of the storage command CMD_S of FIG. 1. The control signal CTRL may be a signal which the device controller 1210 provides to control the nonvolatile memory 1230.

The control logic and voltage generator circuit 1235 may generate various voltages required for the nonvolatile memory 1230 to operate. For example, the control logic and voltage generator circuit 1235 may generate a plurality of program voltages, a plurality of pass voltages, a plurality of verification voltages, a plurality of selection read voltages, a plurality of non-selection read voltages, a plurality of erase voltages, and the like. The control logic and voltage generator circuit 1235 may provide the generated voltages to the address decoder 1232 or to a substrate of the memory cell array 1231.

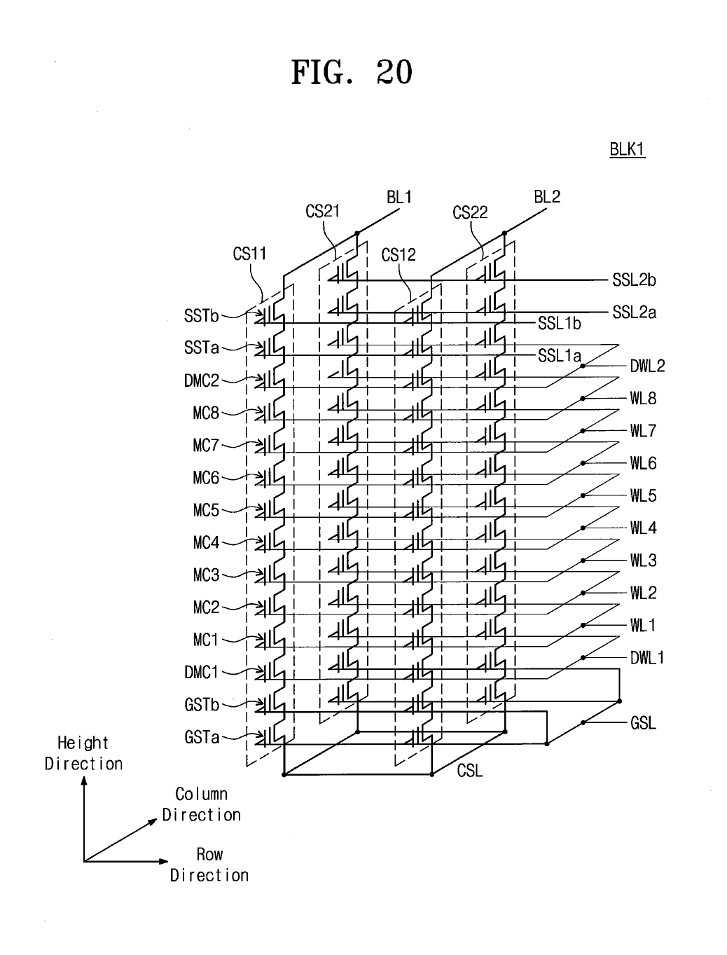

FIG. 20 is a circuit diagram illustrating an embodiment of one of the memory blocks included in a cell array of a memory cell array in FIG. 19. A memory block BLK1 having a three-dimensional structure will be described with reference to FIG. 20. Other memory blocks included in the nonvolatile memory 1230 may have, but are not limited to, a structure which is similar to the memory block BLK1.

Referring to FIG. 20, the memory block BLK1 may include a plurality of cell strings CS11, CS12, CS21, and CS22. The cell strings CS11, CS12, CS21, and CS22 may be arranged along a row direction and a column direction and may form rows and columns.

For example, the cell strings CS11 and CS12 may be connected to string selection lines SSL1a and SSL1b to constitute a first row. The cell strings CS21 and CS22 may be connected to string selection lines SSL2a and SSL2b to constitute a second row.

For example, the cell strings CS11 and CS21 may be connected to a first bit line BL1 to constitute a first column. The cell strings CS12 and CS22 may be connected to a second bit line BL2 to constitute a second column.

Each of the cell strings CS11, CS12, CS21, and CS22 may include a plurality of cell transistors. Each of the cell strings CS11, CS12, CS21, and CS22 may include string selection transistor SSTa and SSTb, a plurality of memory cells MC1 to MC8, ground selection transistors GSTa and GSTb, and dummy memory cells DMC1 and DMC2. In some embodiments, the memory cells included in the cell strings CS11, CS12, CS21, and CS22 may be a charge trap flash (CTF) memory cell.

The memory cells MC1 to MC8 may be serially connected and may be stacked a height direction being a direction perpendicular to a plane defined by a row direction and a column direction. The string selection transistors SSTa and SSTb may be serially connected and may be disposed between the memory cells MC1 to MC8 and a bit line BL. The ground selection transistors GSTa and GSTb may be serially connected and may be disposed between the memory cells MC1 to MC8 and a common source line CSL.

In some embodiments, a first dummy memory cell DMC1 may be disposed between the memory cells MC1 to MC8 and the ground selection transistors GSTa and GSTb. In some embodiments, a second dummy memory cell DMC2 may be disposed between the memory cells MC1 to MC8 and the string selection transistors SSTa and SSTb.

The ground selection transistors GSTa and GSTb of the cell strings CS11, CS12, CS21, and CS22 may be connected in common to a ground selection line GSL. In some embodiments, ground selection transistors in the same row may be connected to the same ground selection line, and ground selection transistors in different rows may be connected to different ground selection lines. For example, the first ground selection transistors GSTa of the cell strings CS11 and CS12 in the first row may be connected to the first ground selection line, and the first ground selection transistors GSTa of the cell strings CS21 and CS22 in the second row may be connected to the second ground selection line.

In some embodiments, although not shown, ground selection transistors at the same height from a substrate (not shown) may be connected to the same ground selection line, and ground selection transistors at different heights therefrom may be connected to different ground selection lines. For example, the ground selection transistors GSTa of the cell strings CS11, CS12, CS21, and CS22 may be connected to the first ground selection line, and the ground selection transistors GSTb thereof may be connected to the second ground selection line.

Memory cells placed at the same height from the substrate (or the ground selection transistors GSTa and GSTb) may be connected in common to the same word line, and memory cells placed at different heights therefrom may be connected to different word lines. For example, memory cells MC1 to MC8 of the cell strings CS11, CS12, CS21, and CS22 may be connected in common to first to eighth word lines WL1 to WL8.

String selection transistors, belonging to the same row, from among the first string selection transistors SSTa placed at the same height may be connected to the same string selection line, and string selection transistors belonging to different rows may be connected to different string selection lines. For example, the first string selection transistors SSTa of the cell strings CS11 and CS12 in the first row may be connected in common to the string selection line SSL1a, and the first string selection transistors SSTa of the cell strings CS21 and CS22 in the second row may be connected in common to the string selection line SSL2a.

Likewise, string selection transistors, belonging to the same row, from among the second string selection transistors SSTb at the same height may be connected to the same string selection line, and string selection transistors in different rows may be connected to different string selection lines. For example, the second string selection transistors SSTb of the cell strings CS11 and CS12 in the first row may be connected in common to a string selection line SSL1b, and the second string selection transistors SSTb of the cell strings CS21 and CS22 in the second row may be connected in common to a string selection line SSL2b.

Although not shown, string selection transistors of cell strings in the same row may be connected in common to the same string selection line. For example, the first and second string selection transistors SSTa and SSTb of the cell strings CS11 and CS12 in the first row may be connected in common to the same string selection line. The first and second string selection transistors SSTa and SSTb of the cell strings CS21 and CS22 in the second row may be connected in common to the same string selection line.

In some embodiments, dummy memory cells at the same height may be connected with the same dummy word line, and dummy memory cells at different heights may be connected with different dummy word lines. For example, the first dummy memory cells DMC1 may be connected to a first dummy word line DWL1, and the second dummy memory cells DMC2 may be connected to a second dummy word line DWL2.

In the memory block BLK1, read and write operations may be performed by the row. For example, one row of the memory block BLK1 may be selected by the string selection lines SSL1a, SSL1b, SSL2a, and SSL2b.

The cell strings CS11 and CS12 in the first row may be respectively connected to the bit lines BL1 and BL2 when a turn-on voltage is supplied to the string selection lines SSL1a and SSL1b and a turn-off voltage is supplied to the string selection lines SSL2a and SSL2b. The cell strings CS21 and CS22 in the second row may be respectively connected to the bit lines BL1 and BL2 when the turn-on voltage is supplied to the string selection lines SSL2a and SSL2b and the turn-off voltage is supplied to the string selection lines SSL1a and SSL1b. As a word line is driven, memory cells, placed at the same height, from among memory cells in cell strings connected to the driven word line may be selected. Read and write operations may be performed with respect to the selected memory cells. The selected memory cells may constitute a physical page.

In the memory block BLK1, memory cells may be erased by the memory block or by the sub-block. When erasing is performed by the memory block, all memory cells MC in the memory block BLK1 may be simultaneously erased according to an erase request. When erasing is performed by the sub-block, a portion of memory cells MC in the memory block BLK1 may be simultaneously erased according to an erase request, and the other thereof may be erase-inhibited. A low voltage (e.g., a ground voltage) may be supplied to a word line connected to erased memory cells MC, and a word line connected to erase-inhibited memory cells MC may be floated.

The memory block BLK1 illustrated in FIG. 20 may be an example. For example, the number of cell strings may increase or decrease, and the number of rows of cell strings and the number of columns of cell strings may increase or decrease according to the number of cell strings. In the memory block BLK1, the number of cell strings (GST, MC, DMC, SST, or the like) may increase or decrease, and/or a height of the memory block BLK1 may increase or decrease according to the number of cell strings (GST, MC, DMC, SST, or the like). Furthermore, the number of lines (GSL, WL, DWL, SSL, or the like) connected with cell transistors may increase or decrease according to the number of cell strings (GST, MC, DMC, SST, or the like).

II. Nonvolatile Memory Module Transmitting Read Data by a Transmission Unit

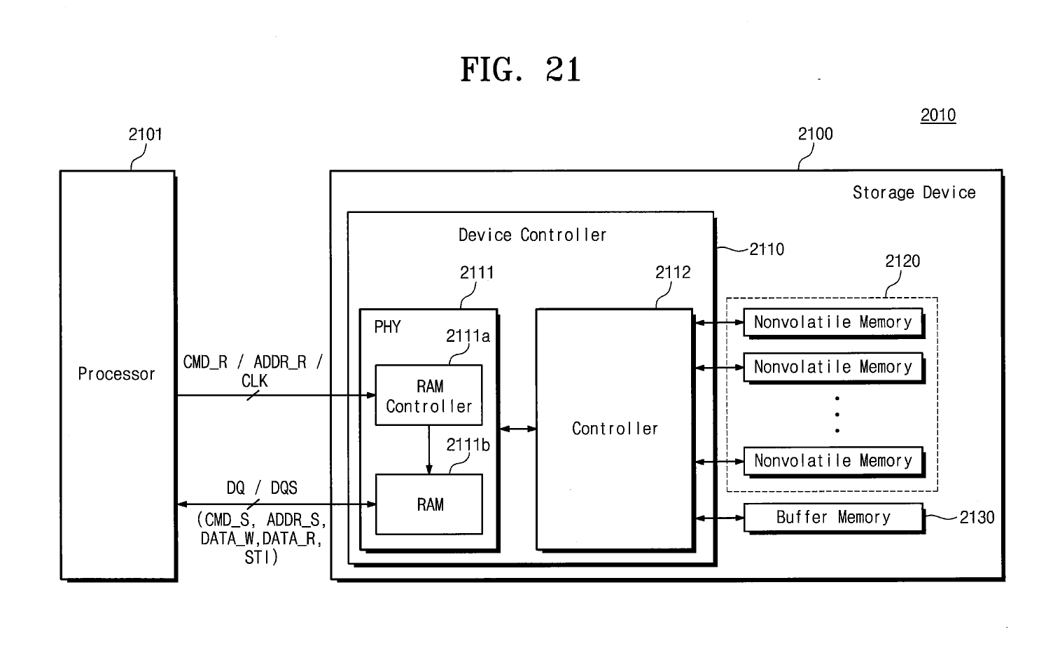

FIG. 21 is a block diagram illustrating a storage system including a storage device according to embodiments of the inventive concept. A storage system 2010 may include a storage device 2100 and a processor 2101. Communication between the storage device 2100 and the processor 2101 and a configuration and an operation of the storage device 2100 will be described with reference to FIG. 21.

The storage device 2100 may perform functions under control of the device controller 2110. For example, in the case where the processor 2101 provides a write request and write data DATA_W to the storage device 2100 to store the write data DATA_W at the storage device 2100, the write data DATA_W may be stored in nonvolatile memories 2120 or a buffer memory 2130 under control of the device controller 2110. For example, in the case where the processor 2101 provides a read request to the storage device 2100 to read read data DATA_R stored in the storage device 2100, the read data DATA_R stored in the nonvolatile memories 2120 or the buffer memory 2130 may be transmitted to the processor 2101 under control of the device controller 2110.

The device controller 2110 may include a physical layer 2111 and a controller 2112. The physical layer 2111 may include a RAM controller 2111a and a RAM 2111b. The RAM controller 2111a may receive a RAM command CMD_R, a RAM address ADDR_R, and a clock signal CLK from the processor 2101. The RAM controller 2111a may control the RAM 2111b based on the RAM command CMD_R and the RAM address ADDR_R.

The RAM 2111b may store or output data based on the RAM command CMD_R and the RAM address ADDR_R. The RAM 2111b may receive a data signal DQ and a data strobe signal DQS from the processor 2101 and may store data corresponding to the data signal DQ. Alternatively, the RAM 2111b may output data stored therein as the data signal DQ, and the outputted data may be provided to the processor 2101.

According to an embodiment of the inventive concept, the data signal DQ may include a storage command CMD_S and a storage address ADDR_S which are provided from the processor 2101 to control the nonvolatile memories 2120. Furthermore, the data signal DQ may include write data DATA_W to be stored in the nonvolatile memories 2120 or data read DATA_R read therefrom. In some embodiments, the data signal DQ may include status information STI associated with the write data DATA_W and the read data DATA_R.

During a write operation associated with the nonvolatile memories 2120, the RAM 2111b may store the storage command CMD_S and the storage address ADDR_S based on the RAM command CMD_R and the RAM address ADDR_R. In addition, the RAM 2111b may temporarily store the write data DATA_W provided from the processor 2101 based on the RAM command CMD_R and the RAM address ADDR_R. Under control of the controller 2112, the storage command CMD_S, the storage address ADDR_S, the write data DATA_W may be provided to the nonvolatile memories 2120. The write data DATA_W may be stored in the nonvolatile memories 2120 based on the storage command CMD_S and the storage address ADDR_S.

During a read operation associated with the nonvolatile memories 2120, the RAM 2111b may store the storage command CMD_S and the storage address ADDR_S based on the RAM command CMD_R and the RAM address ADDR_R. Under control of the controller 2112, the storage command CMD_S and the storage address ADDR_S may be provided to the nonvolatile memories 2120. The read data DATA_R may be read from the nonvolatile memories 2120 based on the storage command CMD_S and the storage address ADDR_S and may be provided to the processor 2101 after being temporarily stored in the RAM 2111b.

That is, the data DATA_W and DATA_R may be exchanged between the processor 2101 and the nonvolatile memories 2120 under control of the controller 2112. To this end, the physical layer 2111 may be defined based on, for example, a DIMM specification and may operate according to a protocol such as, for example, the DDR interface, though the inventive concept is not limited thereto. The device controller 2110 may operate according to an interface specification such as, for example, the DIMM specification. The storage device 2100 may be implemented in the form of a DIMM shape and may communicate with the processor 2101 based on the interface protocol which is defined based on the DIMM specification, though the inventive concept is not limited thereto.

In some embodiments, the RAM command CMD_R, the RAM address ADD_R, and the clock signal CLK may be provided through a command pin which is defined in the DIMM specification. The storage command CMD_S corresponding to a write request or a read request may be transmitted through a data input/output pin, which is defined in the DIMM specification, together with the storage address ADDR_S. The write data or the read data may be also transmitted through the data input/output pin.

Under control of the RAM controller 2111a and the controller 2112, the RAM 2111b may store the status information STI associated with a progress of the write operation or the read operation. The processor 2101 may recognize whether the write operation or the read operation is completed, based on the status information STI. In addition, the processor 2112 may recognize a progress of the write operation or the read operation, based on the status information STI. The status information STI may be also transmitted through the data input/output pin.

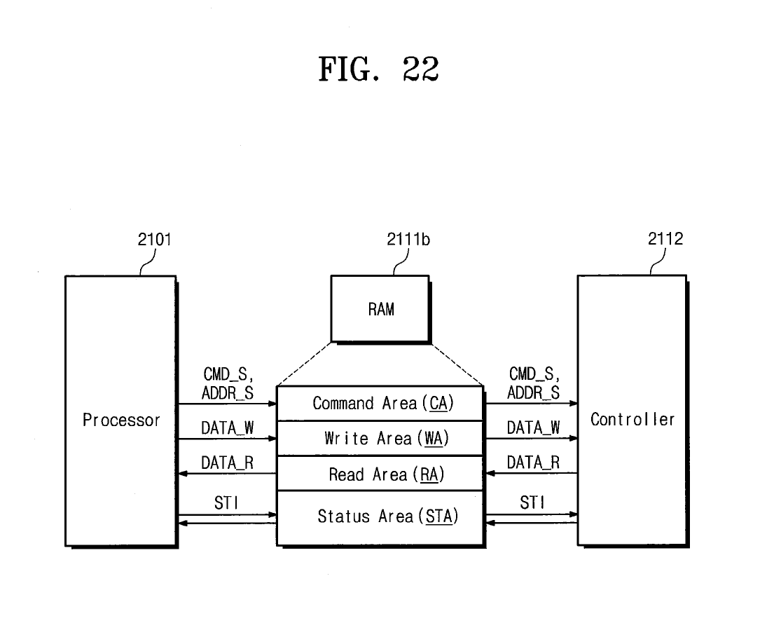

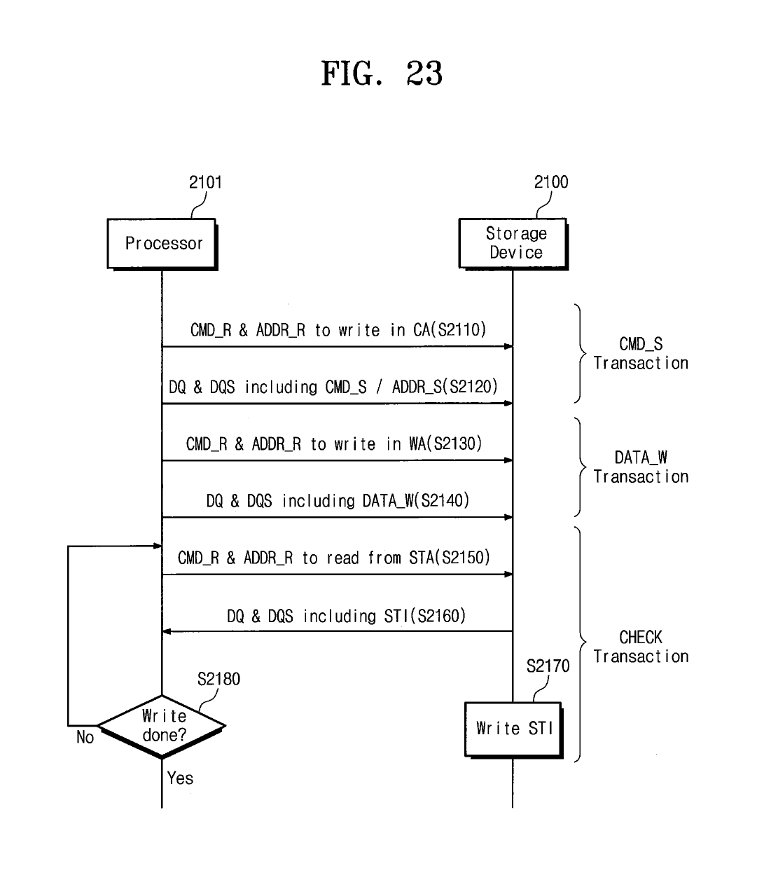

In some embodiments, the RAM 2111b may include a multi-port RAM such as dual port SRAM or a shared RAM. In some embodiments, the RAM 2111b may be respectively accessed by the processor 2101 and the controller 2112 through different ports. A configuration of the RAM 2111b will be described in detail with reference to FIG. 22. In addition, the write operation and the read operation will be described with reference to FIGS. 23 to 28.

The controller 2112 may include a variety of hardware components or software components to control the physical layer 2111 and the nonvolatile memories 2120. For example, the controller 2112 may include an error correction code (ECC) encoding/decoding engine, a scrambler/descrambler, a data buffer, and/or a flash translation layer, though the inventive concept is not limited thereto.

The controller 2112 may detect and correct an error of data through the ECC encoding/decoding engine and may generate or add an ECC code associated with data. The controller 2112 may scramble or descramble data using the scrambler/descrambler. The controller 2112 may temporarily store data read from the RAM 2111b or the nonvolatile memories 2120 in the buffer memory 2130. The controller 2112 may perform translation between a logical address, associated with the storage address ADDR_S, and a physical address using the flash translation layer. To this end, the buffer memory 2130 may store a table including mapping between a logical address and a physical address of the nonvolatile memories 2120.

FIG. 22 is a diagram schematically illustrating a configuration of an embodiment of the RAM 2111b of FIG. 21 and communications among a processor, a RAM, and a controller. In some embodiments, the RAM 2111b may include a command area CA, a write area WA, a read area RA, and a status area STA. The command area CA, the write area WA, the read area RA, and the status area STA may be classified logically or physically.

One of the command area CA, the write area WA, the read area RA, and the status area STA may be selected according to a RAM address ADDR_R (refer to FIG. 21) provided from the processor 2101. In addition, a write operation or a read operation about the selected area may be performed based on a RAM command CMD_R (refer to FIG. 8) provided from the processor 2101. For example, in the case where a RAM write command is provided as the RAM command CMD_R, a write operation may be performed at the selected area. In contrast, in the case where a RAM read command is provided as the RAM command CMD_R, a read operation may be performed at the selected area.

The command area CA may store the storage command CMD_S and the storage address ADDR_S provided from the processor 2101. The controller 2112 may read the storage command CMD_S and the storage address ADDR_S stored in the command area CA. The storage command CMD_S may indicate whether an operation to be performed with respect to one or more nonvolatile memories 2120 is a read operation or a write operation (i.e., whether a received request is a read request or a write request). The storage address ADDR_S may indicate a position of the nonvolatile memories 2120 where a write operation or a read operation is to be performed.

The write area WA and the read data RA may store write data DATA_W and read data DATA_R, respectively. The write data DATA_W provided from the processor 2101 may be temporarily stored in the write area WA and may be then provided to the nonvolatile memories 2120 under control of the controller 2112. The read data DATA_R read from the nonvolatile memories 2120 may be temporarily stored in the read area RA under control of the controller 2112 and may be then provided to the processor 2101.

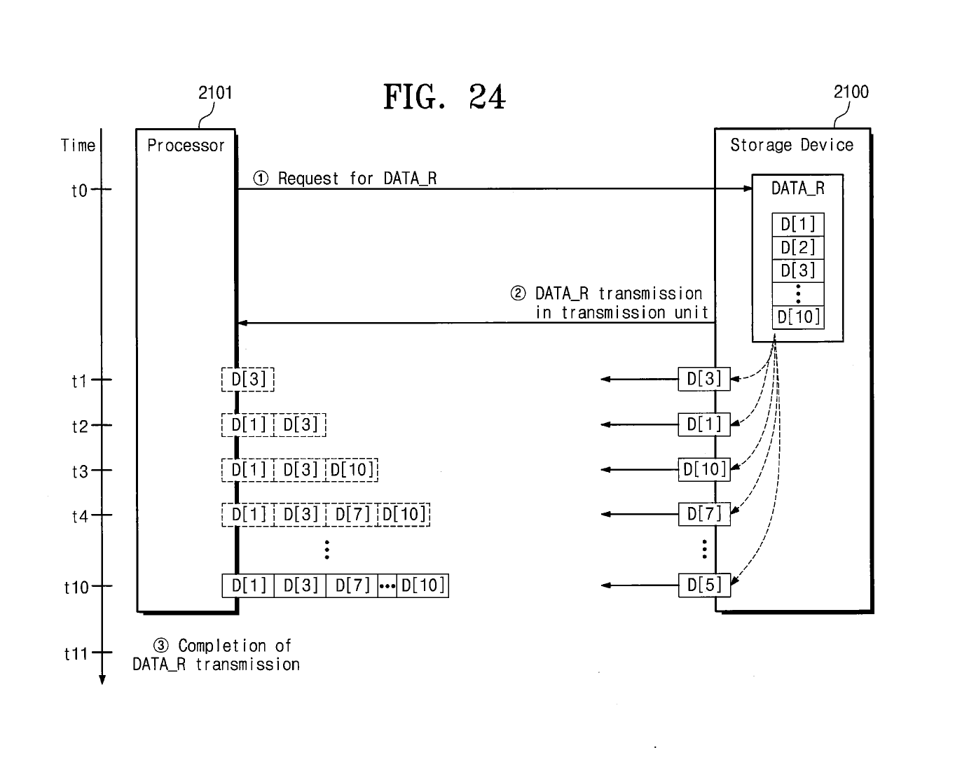

As will be described with reference to FIGS. 24 to 28, instead of read data DATA_R, a plurality of transmission unit data which is generated by dividing the read data DATA_R may be transmitted to the processor 2101. The read area RA of the RAM 2111b may store pieces of transmission unit data constituting the read data DATA_R. Each of the pieces of transmission unit data may be temporarily stored in the RAM 2111b and may be then transmitted to the processor 2101. Each of the pieces of transmission unit data may be transmitted as a data signal DQ (refer to FIG. 21) through a data input/output pin defined in the DIMM specification. According to embodiments of the inventive concept, transmission of the read data DATA_R may be accomplished by transmitting all pieces of transmission unit data.

Under control of the RAM controller 2111a (refer to FIG. 21) and the controller 2112, the status area STA may store the status information STI associated with write data DATA_W and read data DATA_R. The status information STI may include information associated with a progress of a write operation or a read operation. The processor 2101 may recognize whether the write operation or the read operation is completed, based on the status information STI. In addition, the processor 2112 may recognize a progress of the write operation or the read operation, based on the status information STI.

For example, in the case where the processor 2101 intends to store write data DATA_W, it may provide the write data DATA_W to the write area WA. In addition, the processor 2101 may provide the status area STA with information associated with the write data DATA_W and status information STI associated with a request of a write operation. The controller 2112 may control a write operation based on the status information STI such that the write data DATA_W is stored in at least one of the nonvolatile memories 2120. In the case where the controller 2112 stores status information STI, informing a completion of the write operation, in the status area STA, the processor 2101 may recognize the completion of the write operation based on the status information STI. To this end, the processor 2101 may poll the status area STA every specific time (e.g., periodically).

For example, in the case where the processor 2101 intends to read read data DATA_R, the processor 2101 may provide the status area STA with information associated with the read data DATA_R and status information STI associated with a request of a read operation. The controller 2112 may control a read operation based on the status information STI such that the read data DATA_R is read from at least one of the nonvolatile memories 2120. In the case where the controller 2112 stores status information STI, informing a completion of the read operation, in the status area STA, the processor 2101 may recognize the completion of the read operation based on the status information STI. In addition, the processor 2101 may be provided with the read data DATA_R stored in the read area RA.

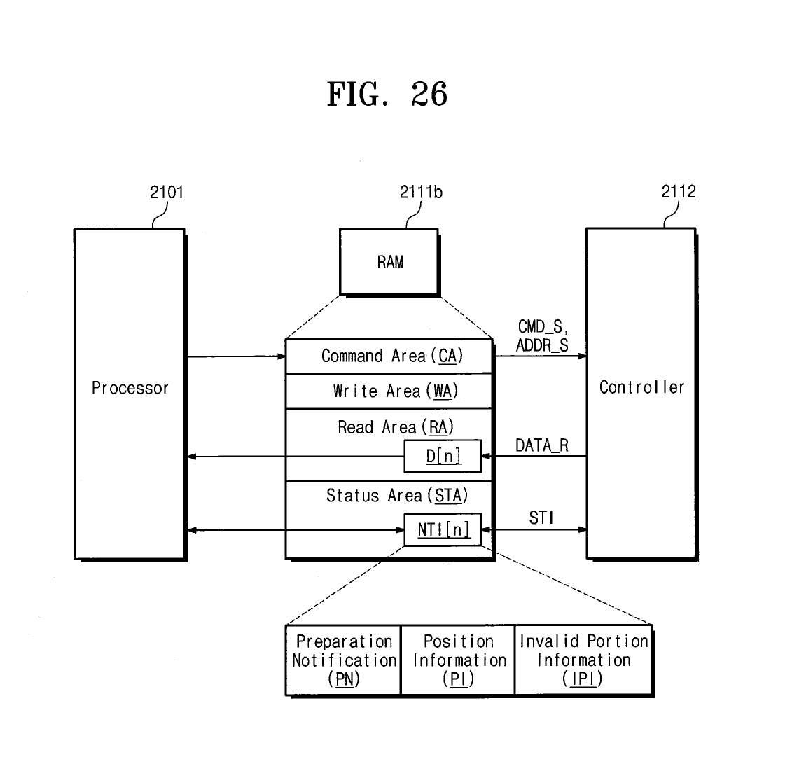

As described above, instead of the read data DATA_R, a plurality of transmission unit data which is generated by dividing the read data DATA_R may be transmitted to the processor 2101. In some embodiments, the status area STA of the RAM 2111b may store “notification data” as the status information STI. The notification data may include information associated with pieces of transmission unit data constituting the read data DATA_R. The notification data will be described in detail with reference to FIGS. 26 to 28.

FIG. 23 is a flow chart for describing an embodiment of a write operation of the storage device 2100 illustrated in FIG. 21. The processor 2101 may store write data DATA_W in the storage device 2100 based on the write procedure of FIG. 23. To help understand the inventive concept, a description will be given with reference to FIGS. 21 and 22.

In step S2110, the processor 2101 may provide a RAM command CMD_R for requesting a write operation about the RAM 2111b to the storage device 2100. In addition, the processor 2101 may provide a RAM address CMD_R for selecting a command area CA of the RAM 2111b to the storage device 2100.

In operation S2120, the processor 2101 provide the storage device 2100 with a data signal DQ and a data strobe signal DQS. In operation S2120, the data signal DQ may include a storage command CMD_S for requesting a write operation about the storage device 2100, in more detail, a write operation about the nonvolatile memories 2120. In addition, the data signal DQ may include a storage address ADDR_S indicating a position of the nonvolatile memories 2120 where the write operation is to be performed.

Steps S2110 and S2120 may compose a command transaction for transmitting a write command about the nonvolatile memories 2120 to the storage device 2100. In the case where operations S2110 and S2120 are performed, the command area CA of the RAM 2111b may store the storage command CMD_S and the storage address ADDR_S. Here, the storage command CMD_S may inform that the write operation is performed at the nonvolatile memories 2120.

In step S2130, the processor 2101 may provide a RAM command CMD_R for requesting a write operation about the RAM 2111b to the storage device 2100. In addition, the processor 2101 may provide a RAM address ADDR_R for selecting a write area WA of the RAM 2111b to the storage device 2100.

In operation S2140, the processor 2101 provide the storage device 2100 with a data signal DQ and a data strobe signal DQS. In operation S2140, the data signal DQ may include write data DATA_W to be stored in the storage device 2100.

Steps S2130 and S2140 may compose a data transaction for transmitting the write data DATA_W to be stored in the nonvolatile memories 2120 to the storage device 2100. In the case where operations S2130 and S2140 are performed, the write area WA of the RAM 2111b may store the write data DATA_W. As the storage command CMD_S, the storage address ADDR_S, and the write data DATA_W are stored in the RAM 2111b, the controller 2112 may control the write operation based on the storage command CMD_S and the storage address ADDR_S.

In step S2150, the processor 2101 may provide a RAM command CMD_R for requesting a read operation about the RAM 2111b to the storage device 2100. In addition, the processor 2101 may provide a RAM address ADDR_R for selecting a status area STA of the RAM 2111b to the storage device 2100.

In operation S2160, the processor 2101 may be provided with the data signal DQ and the data strobe signal DQS from the storage device 2100. In operation S2160, the data signal DQ may include status information associated with the write operation.

In operation S2170, the storage device 2100 may store information associated with the write data DATA_W and the write operation in the status area STA. For example, in the case where the write operation is completed at the storage device 2100, in the case where the write operation is scheduled, or in the case where an instruction of the write operation enters a queue, operation S2170 may be performed.

In operation S2180, the processor 2101 may determine whether the write operation is completed. The processor 2101 may determine whether the write operation is completed, based on the status information STI stored in the status area STA.

Operations S2150 to S2180 may compose a check transaction to check whether the write operation is completed at the nonvolatile memories 2120. If the determination indicates that the write operation is not completed, the processor 2101 may repeat operations S2150 and S2160 to continue to poll whether the write operation is completed. In contrast, if the determination indicates that the write operation is completed, the processor 2101 may request a next operation from the storage device 2100.

FIG. 24 is a flow chart for describing an embodiment of a read operation of the storage device 2100 illustrated in FIG. 21. To help understand the inventive concept, a description will be given with reference to FIGS. 21 and 22.

Referring to FIG. 24, at t0, the processor 2101 may provide a read request to the storage device 2100 (\textcircled{1}). The processor 2101 may provide a read request to the storage device 2100 to read read data DATA_R stored in the storage device 2100. The processor 2101 may provide a storage command CMD_S corresponding to the read request to the storage device 2100. The processor 2101 may provide a storage address ADDR_S, indicating a position where the read data DATA_R is stored, to the storage device 2100.

When receiving the read request, the storage device 2100 may transmit the read data DATA_R to the processor 2101. According to an embodiment of the inventive concept, the storage device 2100 may transmit a plurality of transmission unit data, which is generated by dividing the read data DATA_R, to the processor 2101, not the read data DATA_R (\textcircled{2}).

The storage device 2100 may read the read data DATA_R from a position of the nonvolatile memories 2120 corresponding to the storage address ADDR_S, under control of the device controller 2110. However, in the case where the read data DATA_R is distributed and stored, the entire read data DATA_R may not be read once. In some embodiments, in the case where the size of the read data DATA_R exceeds a unit size of a read operation, the entire read data DATA_R may not be read once.

In the case where the entire read data DATA_R is read and is then transmitted to the processor 2101, the RAM 2111b should have a large capacity to buffer the entire read data DATA_R. Even though the entire read data DATA_R is read once, it may be inefficient to transmit the read data DATA_R to the processor 2101 after the read operation. In this case, it may be efficient to transmit a portion of the read data DATA_R whenever the portion of the read data DATA_R is read.

According to embodiments of the inventive concept, under control of the device controller 2110, the storage device 2100 may transmit each of transmission unit data D[1] to D[10] constituting the read data DATA_R to the processor 2101. For example, it may be assumed that ten transmission unit data D[1] to D[10] constitute the read data DATA_R. However, this example is to help understand the inventive concept, and the inventive concept is not limited thereto.

Here, a transmission unit of the transmission unit data may be variously changed or modified according to various embodiments. The transmission unit may have a size suitable to transmit data. The transmission unit may have a fixed size or a variable size. In some embodiments, the transmission unit may be a packet unit used for a data transfer.

For example, at t1, third transmission unit data D[3] may be read from at least one of the nonvolatile memories 2120, and thus there may be ready to transmit the third transmission unit data D[3]. As there is ready to transmit the third transmission unit data D[3], the device controller 2110 may transmit the third transmission unit data D[3] to the processor 2101. Accordingly, the processor 2101 may receive the third transmission unit data D[3].

Next, at t2, first transmission unit data D[1] may be read from at least one of the nonvolatile memories 2120, and thus there may be ready to transmit the first transmission unit data D[1]. Next, at t3 and t4, tenth transmission unit data D[10] and seventh transmission unit data D[7] may be read from at least one of the nonvolatile memories 2120, and thus there may be ready to transmit the tenth transmission unit data D[10] and the seventh transmission unit data D[7]. As there is ready to transmit the transmission unit data D[1], D[10], and D[7], the device controller 2110 may transmit the transmission unit data D[1], D[10], or D[7] to the processor 2101. The processor 2101 may receive transmission unit data prepared at the storage device 2100 one by one.

Finally, at t10, fifth transmission unit data D[5] may be read, and the fifth transmission unit data D[5] may be transmitted to the processor 2101. The processor 2101 may manage whether a transfer of read data DATA_R is completed (\textcircled{3}). After finally receiving fifth transmission unit data D[5], the processor 2101 may determine that the transfer of the read data DATA_R is completed at t11.

According to embodiments of the inventive concept, as there is ready to transmit transmission unit data D[1] to D[10], the transmission unit data D[1] to D[10] may be transmitted to the processor 2101 under control of the device controller 2110. In some embodiments, each of the transmission unit data D[1] to D[10] may be transmitted to the processor 2101 regardless of an order to constitute the read data DATA_R. That is, each of the transmission unit data D[1] to D[10] may be transmitted to the processor 2101 as soon as they are ready. Transmission of the read data DATA_R to the processor 2101 may be accomplished by transmitting each of the transmission unit data D[1] to D[10] thereto.

According to embodiments of the inventive concept, the RAM 2110b may store prepared transmission unit data D[1] to D[10], not the whole read data DATA_R. Accordingly, it may be possible to use the RAM 2111b with a small capacity. This means that an area occupied by the RAM 2111b and a cost to implement the storage device 2100 may be reduced.

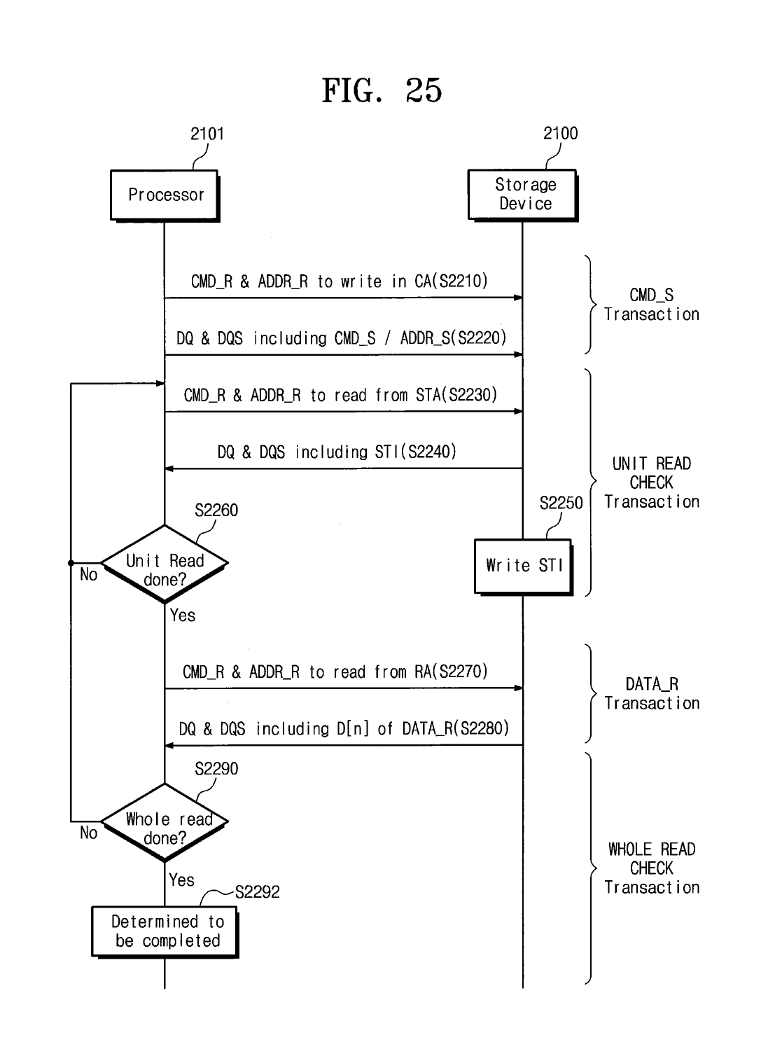

According to embodiments of the inventive concept, the processor 2101 may manage whether to transmit all transmission unit data D[1] to D[10] to the processor 2101 (i.e., whether a read operation is completed). That is, the storage device 2100 may not manage whether all transmission unit data D[1] to D[10] is transmitted, but the storage device 2100 may transmit each of transmission unit data D[1] to D[10]. Thus, an operation load of the storage device 2100 may be reduced. The notification data may be used for the processor 2101 to manage whether a read operation is completed. The notification data is described with reference to FIGS. 25 to 27.

FIG. 25 is a flow chart for describing a read operation of a storage device 2100 illustrated in FIG. 21. The processor 2101 may be provided with read data DATA_R stored in the storage device 2100 based on the read procedure of FIGS. 24 and 25. To help understand the inventive concept, a description will be given with reference to FIGS. 21 and 24.

In step S2210, the processor 2101 may provide a RAM command CMD_R for requesting a write operation about the RAM 2111b to the storage device 2100. In addition, the processor 2101 may provide a RAM address ADDR_R for selecting a command area CA of the RAM 2111b to the storage device 2100.

In operation S2220, the processor 2101 may provide the storage device 2100 with a data signal DQ and a data strobe signal DQS. In operation S2220, the data signal DQ may include a storage command CMD_S for requesting a read operation about the storage device 2100, in more detail, a read operation about the nonvolatile memories 2120. In addition, the data signal DQ may include a storage address ADDR_S indicating a position of the nonvolatile memories 2120 where the read operation is to be performed.

Steps S2210 and S2220 may compose a command transaction for transmitting a read command about the nonvolatile memories 2120 to the storage device 2100. In the case where operations S2210 and S220 are performed, the command area CA of the RAM 2111b may store the storage command CMD_S and the storage address ADDR_S. As the storage command CMD_S and the storage address ADDR_S are stored in the RAM 2111b, the controller 2112 may control the read operation based on the storage command CMD_S and the storage address ADDR_S.

In step S2230, the processor 2101 may provide a RAM command CMD_R for requesting a read operation about the RAM 2111b to the storage device 2100. In addition, the processor 2101 may provide a RAM address ADDR_R for selecting a status area STA of the RAM 2111b to the storage device 2100.

In operation S2240, the processor 2101 may be provided with the data signal DQ and the data strobe signal DQS from the storage device 2100. In operation S2240, the data signal DQ may include status information associated with the read operation.

In operation S2250, the storage device 2100 may store status information STI associated with the read data DATA_R and the read operation in the status area STA. In the case where a read operation associated with a specific one among a plurality of transmission unit data constituting the read data DATA_R is performed at the storage device 2100, operation S2250 may be performed. Here, the status information STI may include notification data. The notification data may indicate that there is ready to transmit the specific transmission unit data stored in the RAM 2111b. In addition, the notification data may include information associated with a position at the read data DATA_R of the prepared transmission unit data.

In operation S2260, the processor 2101 may determine whether the read operation about the specific transmission unit data is completed. The processor 2101 may determine whether the read operation about the specific transmission unit data is completed, based on the status information STI stored in the status area STA (in more detail, the notification data).

Operations S2230 to S2260 may compose a unit read check transaction to check whether specific transmission unit data is read from the nonvolatile memories 2120. If the determination indicates that the read operation is not yet performed, the processor 2101 may repeat operations S2230 and S2240 to continue to poll whether the read operation is performed. In contrast, in the case where the read operation is determined as being performed, operation S2270 may be performed.

In step S2270, the processor 2101 may provide a RAM command CMD_R for requesting a read operation about the RAM 2111b to the storage device 2100. In addition, the processor 2101 may provide a RAM address ADDR_R for selecting a read area RA of the RAM 2111b to the storage device 2100.

In operation S2280, the processor 2101 provide the storage device 2100 with a data signal DQ and a data strobe signal DQS. In operation S2280, the data signal DQ may include transmission unit data D[n], which is ready to transmit, from among pieces of transmission unit data.

Operations S2270 and S2280 may compose a data transaction for transmitting the transmission unit data D[n] to transmit the read data DATA_R from the storage device 2100 to the processor 2101. In the case where operations S2270 and S2280 are performed, the transmission unit data D[n] may be stored in the read area RA of the RAM 2111b and may be then provided to the processor 2101.

In operation S2290, the processor 2101 may determine whether the whole read operation is completed (i.e., all transmission unit data is transmitted). The processor 2101 may determine whether the whole read operation is completed, based on notification data of the status information STI stored in the status area STA. If the determination indicates that the whole read operation is not yet performed, the processor 2101 may repeat operations S2230 to S2280, and thus the processor 2101 may receive pieces of transmission unit data, which are not transmitted, one by one.

In the case where all pieces of transmission unit data are transmitted, in operation S2292, the processor 2101 may determine the whole read operation as being completed. The processor 2101 may request a next operation of the storage device 2100. Operations S2290 and S2292 may compose a whole read check transaction for checking whether the whole read data DATA_R is transmitted.

FIG. 26 is a diagram illustrating transmission of transmission unit data and notification data during a read operation of FIGS. 24 and 25.

The processor 2101 may provide a read request to the storage command 2100 (refer to FIG. 21) by storing a storage command CMD_S and a storage address ADDR_S in the command area CA. In response to the read request, the device controller 2110 (refer to FIG. 21) may control the physical layer 2111 (refer to FIG. 21) and the nonvolatile memories 2120 (refer to FIG. 21) such that a plurality of transmission unit data generated by dividing read data DATA_R is transmitted to the processor 2101 by the controller 2112.

In more detail, transmission unit data D[n], which is ready to transmit, from among the plurality of transmission unit data may be temporarily stored in the read area RA of the RAM 2111b under control of the controller 2112. In addition, under control of the controller 2112, the device controller 2110 may generate notification data NTI[n] corresponding to the transmission unit data D[n] and may store the notification data NTI[n] in the status area STA of the RAM 2111b as status information STI. The processor 2101 may receive the transmission unit data D[n] stored in the read area RA based on the notification data NTI[n].

In some embodiments, the notification data NTI[n] may include preparation notification PN. The preparation notification PN may indicate that there is ready to transmit the transmission unit data D[n] stored in the RAM 2111b. The processor 2101 may recognize preparation of the transmission unit data D[n] based on the preparation notification PN and may receive the transmission unit data D[n].

In some embodiments, the notification data NTI[n] may include position information PI. In addition, the position information PI may include information associated with a position at the read data DATA_R of the transmission unit data D[n]. For example, as in an address corresponding to the transmission unit data D[n], the position information PI may include information necessary to know a relation between the transmission unit data D[n] and the read data DATA_R. The processor 2101 may determine whether the whole transmission unit data is received, based on the position information PI. In addition, after the transmission unit data all is received, the processor 2101 may combine pieces of the transmission unit data into the read data DATA_R based on the position information PI.

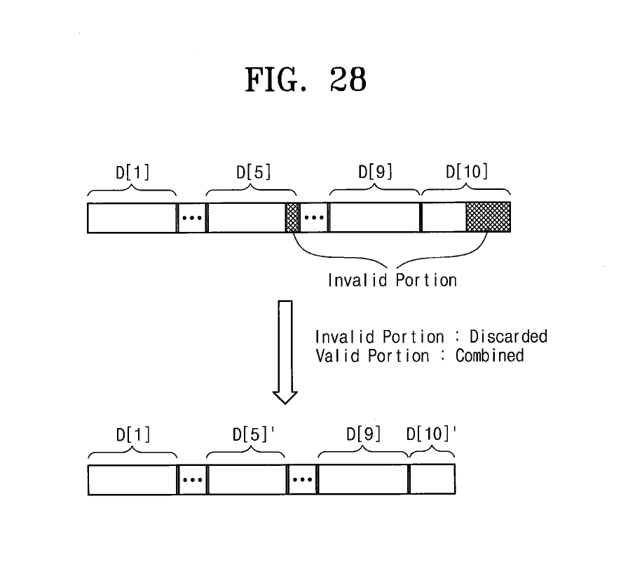

In some embodiments, the notification data NTI[n] may include invalid portion information IPI. The invalid portion information IPI may include information associated with an invalid portion included in the transmission unit data D[n]. In some cases, the transmission unit data D[n] may include an invalid portion which is not included in the read data DATA_R. The invalid portion will be described with reference to FIG. 28.

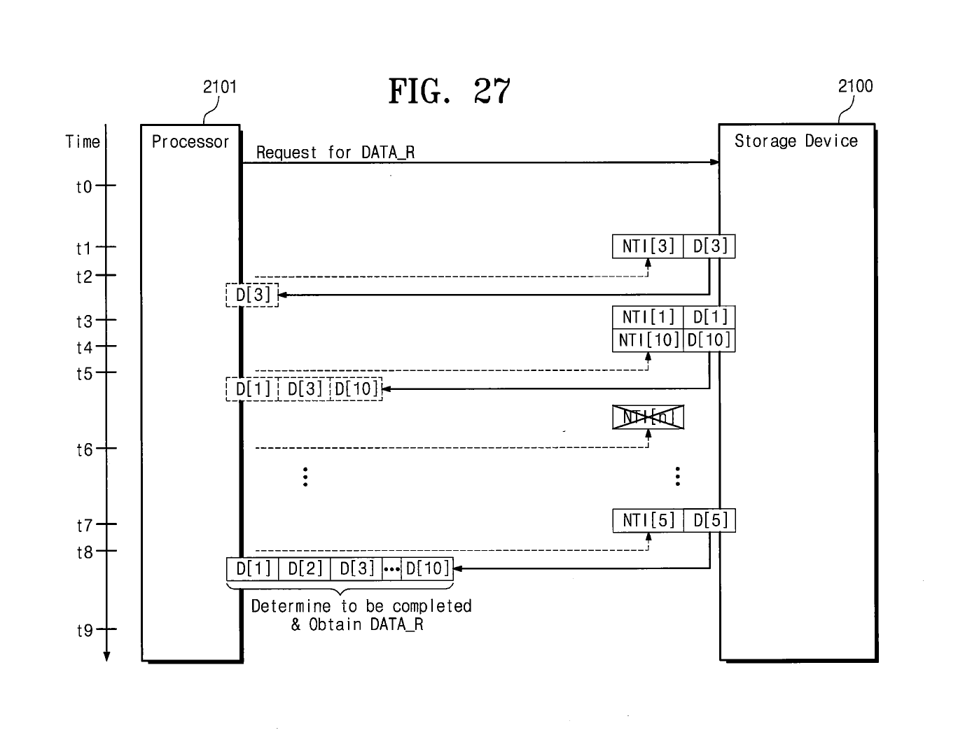

FIG. 27 is a diagram illustrating the procedure for transmitting transmission unit data from a storage device to a host side with reference to notification data of FIG. 26, based on an embodiment of the read operation of FIGS. 24 and 25.

At t0, the processor 2101 may provide the storage device 2100 with a read request associated with read data DATA_R (refer to operations S2210 and S2220 of FIG. 25). In the case where the read request is received, as described above, the storage device 2100 may transmit each of a plurality of transmission unit data constituting the read data DATA_R to the processor 2101. The transmission unit data may be transmitted to the processor one by one as soon as it is ready, regardless of an order to constitute the read data DATA_R.

After providing the read request, the processor 2101 may determine whether notification data is generated at the storage device 2100, at specific times (e.g., periodically or whenever a specific condition is satisfied) (refer to operations S2230 and S2260 of FIG. 25). In the case where the notification data is generated, the processor 2101 may recognize that specific transmission unit data is prepared and may receive the prepared transmission unit data.

For example, at t1, third transmission unit data D[3] may be stored in the RAM 2111b (refer to FIG. 21), and thus there may be ready to transmit the third transmission unit data D[3]. The storage device 2100 may generate notification data NTI[3] for informing preparation of the third transmission unit data D[3].

At t2, the processor 2101 may provide the third transmission unit data D[3] based on the notification data NTI[3] (refer to operations S2270 and S2280 of FIG. 25). In addition, the processor 2101 may obtain information associated with the third transmission unit data D[3] with reference to the notification data NTI[3]. However, since the whole transmission unit data is not yet received, the transmission unit data may be continuously transmitted (refer to an arrow returning to operation S2230 from operation S2290 of FIGS. 25).

At t2 and t3, first transmission unit data D[1] and tenth transmission unit data D[10] may be stored in the RAM 2111b, and thus there may be ready to transmit the first transmission unit data D[1] and the tenth transmission unit data D[10]. The storage device 2100 may generate notification data NTI[1] and NTI[10] which correspond to the first and tenth transmission unit data D[1] and D[10]. In some cases, pieces of transmission unit data may be prepared for the processor 2101 to check the notification data.

At t4, the processor 2101 may receive the first transmission unit data D[1] and the tenth transmission unit data D[10] based on the notification data NTI[1] and NTI[10]. In addition, the processor 2101 may receive information associated with the first transmission unit data D[1] and the tenth transmission unit data D[10] based on the notification data NTI[1] and NTI[10]. Accordingly, the processor 2101 may appropriately arrange the first transmission unit data D[1], the third transmission unit data D[3], and the tenth transmission unit data D[10].

At t6, the processor 2101 may determine whether notification data is generated at the storage device 2100. However, in some cases, transmission unit data may not be prepared (refer to an arrow returning to operation S2230 from operation S2260 of FIG. 25). In this case, the processor 2101 may wait or perform any other operation until next notification data is checked.

At t7, fifth transmission unit data D[5] may be finally stored in the RAM 2111b, and thus there may be ready to transmit the fifth transmission unit data D[5]. The storage device 2100 may generate notification data NTI[5] for informing preparation of the fifth transmission unit data D[5]. At t8, the processor 2101 may provide the fifth transmission unit data D[5] based on the notification data NTI[5]. In addition, the processor 2101 may obtain information associated with the fifth transmission unit data D[5] with reference to the notification data NTI[5].

At t9, the processor 2101 may determine that the transmission unit data D[1] to D[10] all are received, with reference to the notification data NTI[1] to NTI[10]. Accordingly, the processor 2101 may determine that the whole read operation is completed (refer to operation S2292 of FIG. 25). The processor 2101 may obtain the read data DATA_R by appropriately arranging the transmission unit data D[1] to D[10] with reference to the notification data NTI[1] to NTI[10].

To sum up, in the case where a read request is received from the processor 2101, the storage device 2100 may store each of a plurality of transmission unit data generated by dividing the read data, in the RAM 2111b. The storage device 2100 may generate notification data in response to preparation of each transmission unit data. The processor 2101 may receive transmission unit data one by one in response to generation of the notification data. Transmission of the read data to the processor 2101 from the storage device 2100 may be accomplished by transmitting all pieces of transmission unit data. Whether all pieces of transmission unit data are transmitted may be managed by the processor 2101.

FIG. 28 is a diagram illustrating a procedure for obtaining read data by combining valid portions of transmission unit data transmitted according to a read operation of FIGS. 24 and 25.

In some embodiments, at least one of a plurality of transmission unit data constituting read data may be an invalid portion. As used herein, an invalid portion may mean a portion of the data within the transmission data but not included in the read data. In contrast, a portion within the transmission data and included in the read data may be called a valid portion.

In some embodiments, the size of data read from the nonvolatile memories 2120 (refer to FIG. 21) may be smaller than that of the transmission unit data. In this case, the transmission unit data may include data read from the nonvolatile memories 2120 as a valid portion. In addition, an invalid portion may be added to transmission unit data under control of the device controller 2110 (refer to FIG. 21). The invalid portion may be added to the transmission unit data to constitute a full transmission unit. In other words, the invalid portion may be added to the transmission unit data to pad out the data to be a full data transmission unit.

For example, the invalid portion may include meaningless data irrelevant to read data and/or data of a specific pattern. As described with reference to FIG. 26, notification data may include invalid portion information IPI. The invalid portion information IPI may include information which can be used to identify an invalid portion such as a position, content, and a length of the invalid portion.

The processor 2101 may identify the invalid portion included in the plurality of transmission unit data received, based on the notification data including the invalid portion information IPI. Since the invalid portion is irrelevant to the read data, the processor 2101 may discard the invalid portion. In some embodiments, the processor 2101 may recover data other than the invalid portion. That is, the processor 2101 may obtain the read data.

Referring to FIG. 28, for example, the read data may be composed of first transmission unit data D[1] to tenth transmission unit data D[10]. For example, the fifth transmission unit data D[5] and tenth transmission unit data D[10] may include an invalid portion. The processor 2101 may discard an invalid portion included in the fifth transmission unit data D[5] based on notification data corresponding thereto and may obtain the fifth transmission unit data D[5] thus changed. The processor 2101 may discard an invalid portion included in the tenth transmission unit data D[10] based on notification data corresponding thereto and may obtain the tenth transmission unit data D[10] thus changed.

The processor 2101 may combine the changed fifth transmission unit data D[5] and the changed tenth transmission unit data D[10] with pieces of other transmission unit data. That is, the processor 2101 may obtain the read data. The read data thus obtained may only include data, which the processor 2101 requests, without the invalid portion.

According to embodiments described with reference to FIGS. 21 to 28, the processor 2101 may communicate with the device controller 2110 of FIG. 21 through a bus which operates at fast speed. In the case where the storage device 2100 is implemented in a DIMM form and the processor 2101 communicates with the device controller 2110 based on the interface protocol operating in the DDR manner, the processor 2101 may recognize the storage device 2100 as a DIMM device and may perform a read operation and a write operation about the RAM 2111b based on the interface protocol operating in the DDR manner. Accordingly, the operation performance of the storage device 2100 may be improved. Though the DIMM form and DDR protocol are used herein as examples, it will be recognized that other forms and protocols are possible within the scope of the inventive concept.

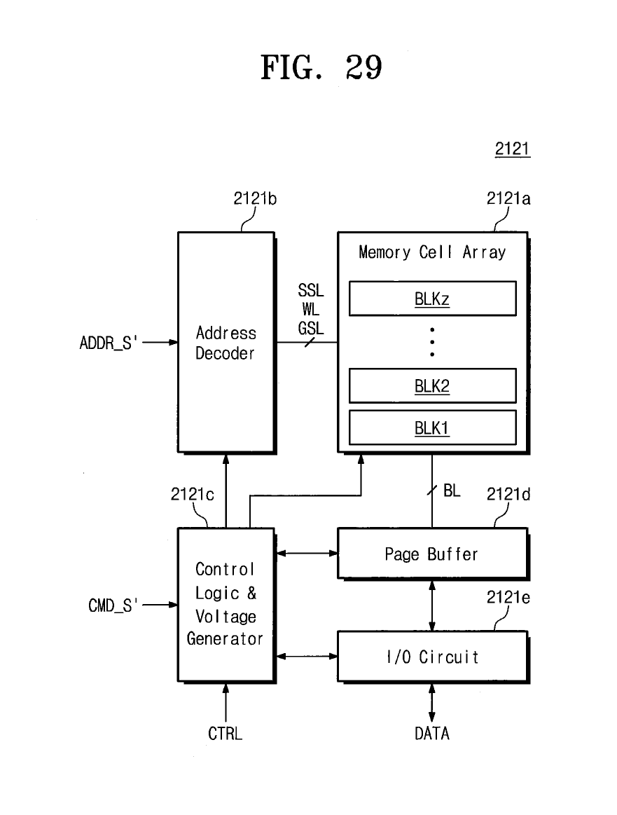

FIG. 29 is a block diagram illustrating an embodiment of the nonvolatile memories 2120 of FIG. 21. At least one of the nonvolatile memories 2120 of FIG. 21 may include a nonvolatile memory 2121. The nonvolatile memory 2121 may include a memory cell array 2121a, an address decoder 2121b, a control logic and voltage generator block 2121c, a page buffer 2121d, and an input/output circuit 2121e.

The memory cell array 2121a may include a plurality of memory blocks BLK1 to BLKz. The memory blocks may include a plurality of cell strings. The cell strings may include a plurality of memory cells. The memory cells may be connected with a plurality of word lines WL. A memory cell may be a single level cell (SLC) storing one bit or a multi-level cell (MLC) storing at least two bits.

According to embodiments of the inventive concept, a three dimensional (3D) memory array may be provided. The 3D memory array may be monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are deposited on the layers of each underlying level of the array.

According to embodiments of the inventive concept, the 3D memory array may include vertical NAND strings that are vertically oriented such that at least one memory cell is located over another memory cell. The at least one memory cell may comprise a charge trap layer. The vertical NAND string may include at least one select transistor located over memory cells, the at least one select transistor having the same structure with the memory cells and being formed monolithically together with the memory cells.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Patent Application Publication No. 2011/0233648.

The address decoder 2121b may be connected with the memory cell array 2121a through the word lines WL, string selection lines SSL, and ground selection lines GSL The address decoder 2121b may decode a storage address ADDR_S′ received from the device controller 2110 (refer to FIG. 21). The address decoder 2121b may select at least one of the word lines WL based on the decoded storage address ADDR_S′ and may drive the at least one word line thus selected.

The control logic and voltage generator block 2121c may receive a storage command CMD_S′ and a control signal CTRL from the device controller 2110. The control logic and voltage generator block 2121c may control the address decoder 2121b, the page buffer 2121d, and the input/output circuit 2121e in response to the received signals. For example, the control logic and voltage generator 2121c may control the address decoder 2121b, the page buffer 2121d, and the input/output circuit 2121e in response to the storage command CMD_S′ and the control signal CTRL such that write data provided from the device controller 2110 is stored in the memory cell array 2121a or such that read data stored in the memory cell array 2121a is read.

The control logic and voltage generator block 2121c may generate various voltages used to operate the nonvolatile memory 2121. For example, the control logic and voltage generator block 2121c may generate a plurality of program voltages, a plurality of pass voltages, a plurality of selection read voltages, a plurality of non-selection read voltages, a plurality of erase voltages, and/or a plurality of verification voltages. The control logic and voltage generator block 2121c may provide the generated voltages to the address decoder 2121b or to a substrate of the memory cell array 2121a.

The page buffer 2121d may be connected with the memory cell array 2121a through the bit lines BL. Under control of the control logic and voltage generator block 2121c, the page buffer 2121d may control the bit lines BL such that write data provided from the input/output circuit 2121e is stored in the memory cell array 2121a. Under control of the control logic and voltage generator block 2121c, the page buffer 2121d may read data stored in the memory cell array 2121a and may provide the read data to the input/output circuit 2121e. For example, the page buffer 2121d may be provided with data from the input/output circuit 2121e by the page or may read data from the memory cell array 2121a by the page. In some embodiments, the page buffer 2121d may include data latches for temporarily storing data read from the memory cell array 2121a or data provided from the input/output circuit 2121e.

The input/output circuit 2121e may be provided with write data from an external device such as the device controller 2110 and may provide the write data to the page buffer 2121d. Alternatively, the input/output circuit 2121e may be provided with read data from the page buffer 2121d and may provide the read data to an external device such as the device controller 2110. For example, the input/output circuit 2121e may exchange data with an external device in synchronization with the control signal CTRL.

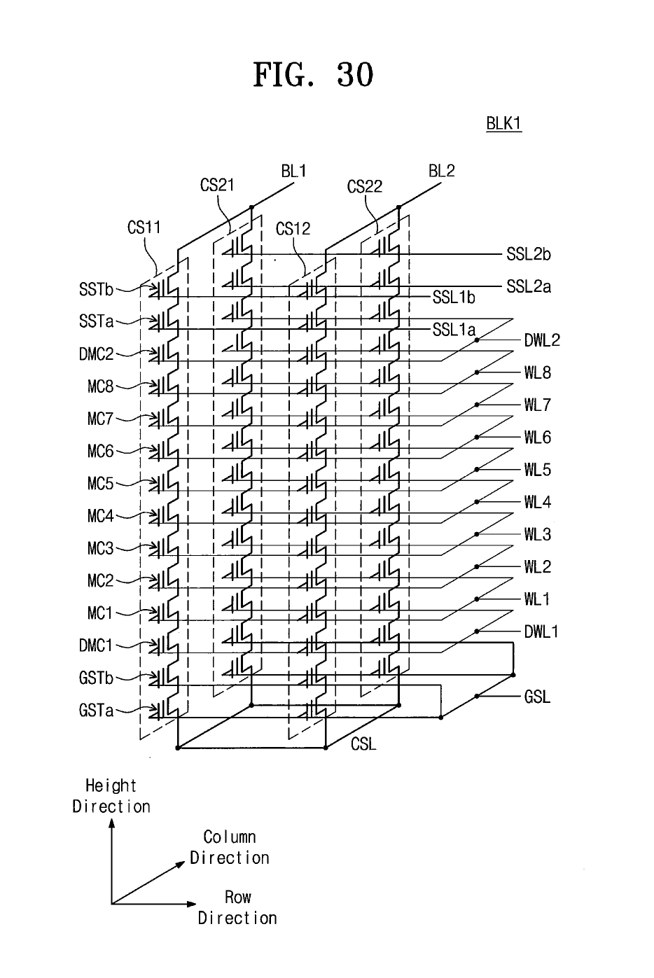

FIG. 30 is a circuit diagram illustrating an embodiment of a memory block of the memory cell array in FIG. 29. A memory block BLK1 having a three-dimensional structure will be described with reference to FIG. 30. In FIG. 30, embodiments of the inventive concept are exemplified as the memory cell array 2121a is a NAND flash memory array. However, the inventive concept is not limited to configuration illustrated in FIG. 30. In addition, other memory blocks may be configured substantially the same as the memory block BLK1.

Referring to FIG. 30, the memory block BLK1 may include a plurality of cell strings CS11, CS12, CS21, and CS22. The cell strings CS11, CS12, CS21, and CS22 may be arranged along a row direction and a column direction and may form rows and columns. For example, the cell strings CS11 and CS12 may be connected to string selection lines SSL1a and SSL1b to constitute a first row. The cell strings CS21 and CS22 may be connected to string selection lines SSL2a and SSL2b to constitute a second row. For example, the cell strings CS11 and CS21 may be connected to a first bit line BL1 to constitute a first column. The cell strings CS12 and CS22 may be connected to a second bit line BL2 to constitute a second column.

Each of the cell strings CS11, CS12, CS21, and CS22 may include a plurality of cell transistors. Each of the cell strings CS11, CS12, CS21, and CS22 may include string selection transistor SSTa and SSTb, a plurality of memory cells MC1 to MC8, ground selection transistors GSTa and GSTb, and dummy memory cells DMC1 and DMC2. In some embodiments, the memory cells included in the cell strings CS11, CS12, CS21, and CS22 may be a charge trap flash (CTF) memory cell.

The memory cells MC1 to MC8 may be serially connected and may be stacked a height direction being a direction perpendicular to a plane defined by a row direction and a column direction. The string selection transistors SSTa and SSTb may be serially connected and may be disposed between the memory cells MC1 to MC8 and a bit line BL. The ground selection transistors GSTa and GSTb may be serially connected and may be disposed between the memory cells MC1 to MC8 and a common source line CSL.

In some embodiments, a first dummy memory cell DMC1 may be disposed between the memory cells MC1 to MC8 and the ground selection transistors GSTa and GSTb. In some embodiments, a second dummy memory cell DMC2 may be disposed between the memory cells MC1 to MC8 and the string selection transistors SSTa and SSTb.

The ground selection transistors GSTa and GSTb of the cell strings CS11, CS12, CS21, and CS22 may be connected in common to a ground selection line GSL. In some embodiments, ground selection transistors in the same row may be connected to the same ground selection line, and ground selection transistors in different rows may be connected to different ground selection lines. For example, the first ground selection transistors GSTa of the cell strings CS11 and CS12 in the first row may be connected to the first ground selection line, and the first ground selection transistors GSTa of the cell strings CS21 and CS22 in the second row may be connected to the second ground selection line.

In some embodiments, although not shown, ground selection transistors at the same height from a substrate (not shown) may be connected to the same ground selection line, and ground selection transistors at different heights therefrom may be connected to different ground selection lines. For example, the first ground selection transistors GSTa of the cell strings CS11, CS12, CS21, and CS22 may be connected to the first ground selection line, and the ground selection transistors GSTb thereof may be connected to the second ground selection line.

Memory cells placed at the same height from the substrate (or the ground selection transistors GSTa and GSTb) may be connected in common to the same word line, and memory cells placed at different heights therefrom may be connected to different word lines. For example, memory cells MC1 to MC8 of the cell strings CS11, CS12, CS21, and CS22 may be connected in common to first to eighth word lines WL1 to WL8.

String selection transistors, belonging to the same row, from among the first string selection transistors SSTa placed at the same height may be connected to the same string selection line, and string selection transistors belonging to different rows may be connected to different string selection lines. For example, the first string selection transistors SSTa of the cell strings CS11 and CS12 in the first row may be connected in common to the string selection line SSL1a, and the first string selection transistors SSTa of the cell strings CS21 and CS22 in the second row may be connected in common to the string selection line SSL2a.

Likewise, string selection transistors, belonging to the same row, from among the second string selection transistors SSTb at the same height may be connected to the same string selection line, and string selection transistors in different rows may be connected to different string selection lines. For example, the second string selection transistors SSTb of the cell strings CS11 and CS12 in the first row may be connected in common to a string selection line SSL1b, and the second string selection transistors SSTb of the cell strings CS21 and CS22 in the second row may be connected in common to a string selection line SSL2b.

Although not shown, string selection transistors of cell strings in the same row may be connected in common to the same string selection line. For example, the first and second string selection transistors SSTa and SSTb of the cell strings CS11 and CS12 in the first row may be connected in common to the same string selection line. The first and second string selection transistors SSTa and SSTb of the cell strings CS21 and CS22 in the second row may be connected in common to the same string selection line.

In some embodiments, dummy memory cells at the same height may be connected with the same dummy word line, and dummy memory cells at different heights may be connected with different dummy word lines. For example, the first dummy memory cells DMC1 may be connected to a first dummy word line DWL1, and the second dummy memory cells DMC2 may be connected to a second dummy word line DWL2.

In the memory block BLK1, read and write operations may be performed by the row. For example, one row of the memory block BLK1 may be selected by the string selection lines SSL1a, SSL1b, SSL2a, and SSL2b.

The cell strings CS11 and CS12 in the first row may be respectively connected to the bit lines BL1 and BL2 when the turn-on voltage is supplied to the string selection lines SSL1a and SSL1b and the turn-off voltage is supplied to the string selection lines SSL2a and SSL2b. The cell strings CS21 and CS22 in the second row may be respectively connected to the bit lines BL1 and BL2 when the turn-on voltage is supplied to the string selection lines SSL2a and SSL2b and the turn-off voltage is supplied to the string selection lines SSL1a and SSL1b. As a word line is driven, memory cells, placed at the same height, from among memory cells in cell strings connected to the driven word line may be selected. Read and write operations may be performed with respect to the selected memory cells. The selected memory cells may constitute a physical page.

In the memory block BLK1, memory cells may be erased by the memory block or by the sub-block. When erasing is performed by the memory block, all memory cells MC in the memory block BLK1 may be simultaneously erased according to an erase request. When erasing is performed by the sub-block, a portion of memory cells MC in the memory block BLK1 may be simultaneously erased according to an erase request, and the other thereof may be erase-inhibited. A low voltage (e.g., a ground voltage) may be supplied to a word line connected to erased memory cells MC, and a word line connected to erase-inhibited memory cells MC may be floated.

A configuration of the memory block BLK1 illustrated in FIG. 30 may be an example. The number of cell strings may increase or decrease, and the number of rows of cell strings and the number of columns of cell strings may increase or decrease according to the number of cell strings. In the memory block BLK1, the number of cell strings (GST, MC, DMC, SST, or the like) may increase or decrease, and/or a height of the memory block BLK1 may increase or decrease according to the number of cell strings (GST, MC, DMC, SST, or the like). Furthermore, the number of lines (GSL, WL, DWL, SSL, or the like) connected with cell transistors may increase or decrease according to the number of cell strings (GST, MC, DMC, SST, or the like).

III. Nonvolatile Memory Module Generating Error Information Accessed by Host

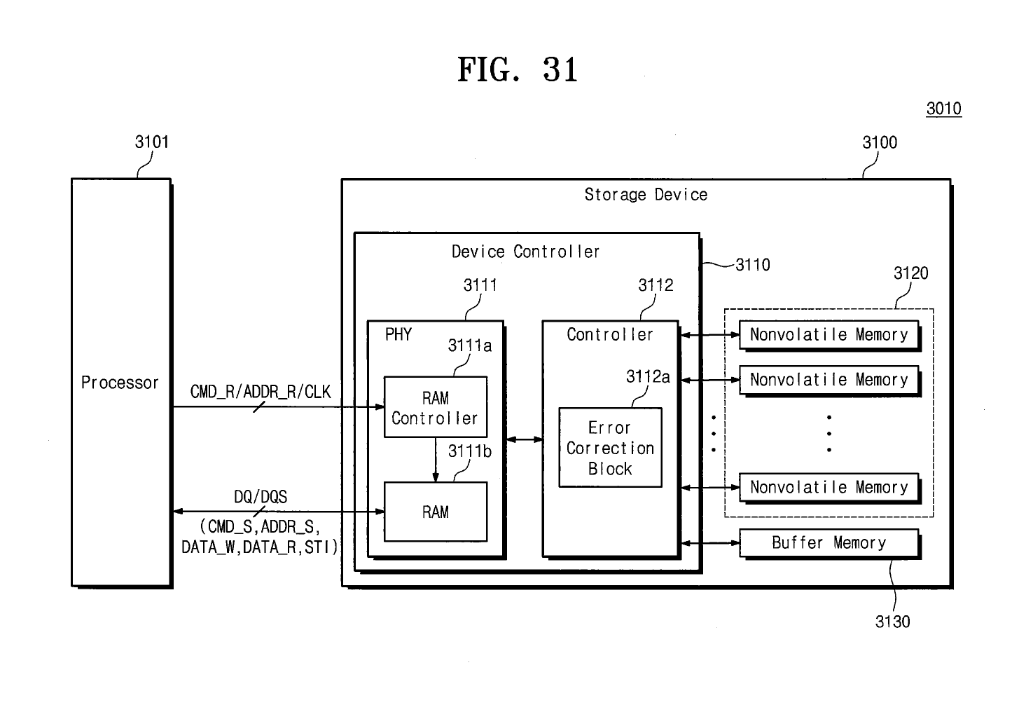

FIG. 31 is a block diagram illustrating a storage system 3010 according to embodiments of the inventive concept. A storage system 3010 may include a storage device 3100 and a processor 3101. Communication between the storage device 3100 and the processor 3101 and a configuration and an operation of the storage device 3100 will be described with reference to FIG. 31.

Under control of the device controller 3110, the storage device 3100 may perform a unique function. For example, in the case where the processor 3101 provides a write request and write data DATA_W to the storage device 3100 to store the write data DATA_W at the storage device 3100, the write data DATA_W may be stored in nonvolatile memories 3120 and/or a buffer memory 3130 under control of the device controller 3110. For example, in the case where the processor 3101 provides a read request to the storage device 3100 to read read data DATA_R stored in the storage device 3100, the read data DATA_R stored in the nonvolatile memories 3120 and/or the buffer memory 3130 may be transmitted to the processor 3101 under control of the device controller 3110.

The device controller 3110 may include a physical layer 3111 and a controller 3112. The physical layer 3111 may include a RAM controller 3111a and a RAM 3111b. The RAM controller 3110a may receive a RAM command CMD_R, a RAM address ADDR_R, and/or a clock signal CLK from the processor 3101. The RAM controller 3111a may control the RAM 3111b based on the RAM command CMD_R and/or the RAM address ADDR_R.

The RAM 3111b may store and/or output data based on the RAM command CMD_R and the RAM address ADDR_R. The RAM 3111b may receive a data signal DQ and a data strobe signal DQS from the processor 3101 and may store data corresponding to the data signal DQ. Alternatively, the RAM 3111b may output data stored therein as the data signal DQ, and the outputted data may be provided to the processor 3101.

According to embodiments of the inventive concept, the data signal DQ may include a storage command CMD_S and a storage address ADDR_S which are provided from the processor 3101 to control the nonvolatile memories 3120. Furthermore, the data signal DQ may include write data DATA_W to be stored in the nonvolatile memories 3120 or data read DATA_R read therefrom. In some cases, the data signal DQ may include status information STI associated with the write data DATA_W and the read data DATA_R.

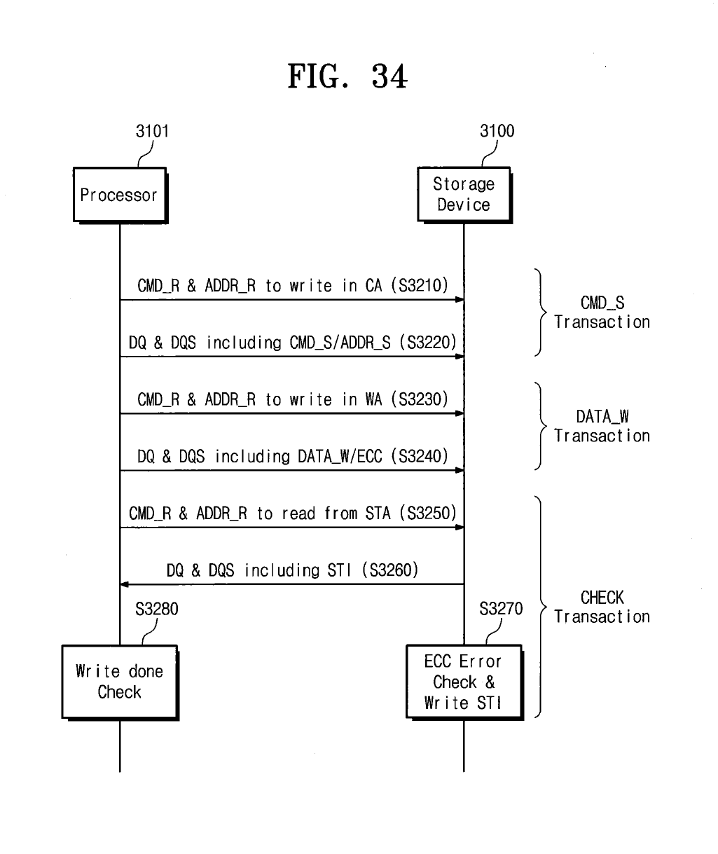

According to embodiments of the inventive concept, the status information STI may include error information. The error information may include information associated with an error of write data DATA_W. The error information will be described in detail with reference to FIGS. 34 to 40.

During a write operation associated with the nonvolatile memories 3120, the RAM 3111b may store the storage command CMD_S and the storage address ADDR_S based on the RAM command CMD_R and/or the RAM address ADDR_R. In addition, the RAM 3111b may temporarily store the write data DATA_W provided from the processor 3101 based on the RAM command CMD_R and/or the RAM address ADDR_R. Under control of the controller 3112, the storage command CMD_S, the storage address ADDR_S, and/or the write data DATA_W may be provided to the nonvolatile memories 3120. The write data DATA_W may be stored in the nonvolatile memories 3120 based on the storage command CMD_S and/or the storage address ADDR_S.

During a read operation associated with the nonvolatile memories 3120, the RAM 3111b may store the storage command CMD_S and/or the storage address ADDR_S based on the RAM command CMD_R and/or the RAM address ADDR_R. Under control of the controller 3112, the storage command CMD_S and/or the storage address ADDR_S may be provided to the nonvolatile memories 3120. The read data DATA_R may be read from the nonvolatile memories 3120 based on the storage command CMD_S and/or the storage address ADDR_S and may be provided to the processor 3101 after being temporarily stored in the RAM 3111b.

That is, the data DATA_W and/or DATA_R may be exchanged between the processor 3101 and the nonvolatile memories 3120 under control of the controller 3112. To this end, the physical layer 3111 may be defined based on a specification such as, for example, the DIMM specification and may operate according to a protocol such as, for example, the DDR interface protocol, though the inventive concept is not limited thereto. The device controller 3110 may operate according to the interface protocol which may be defined by the DIMM specification. The storage device 3100 may be implemented in the form of a DIMM shape and may communicate with the processor 3101 based on the interface protocol which may be defined based on the DIMM specification.

In some embodiments, the RAM command CMD_R, the RAM address ADD_R, and/or the clock signal CLK may be provided through a command pin (such as the command pin defined in the DIMM specification). The storage command CMD_S corresponding to a write request or a read request may be transmitted through a data input/output pin (such as the data input/output pin defined in the DIMM specification), together with the storage address ADDR_S. The write data or the read data may be also transmitted through the data input/output pin.

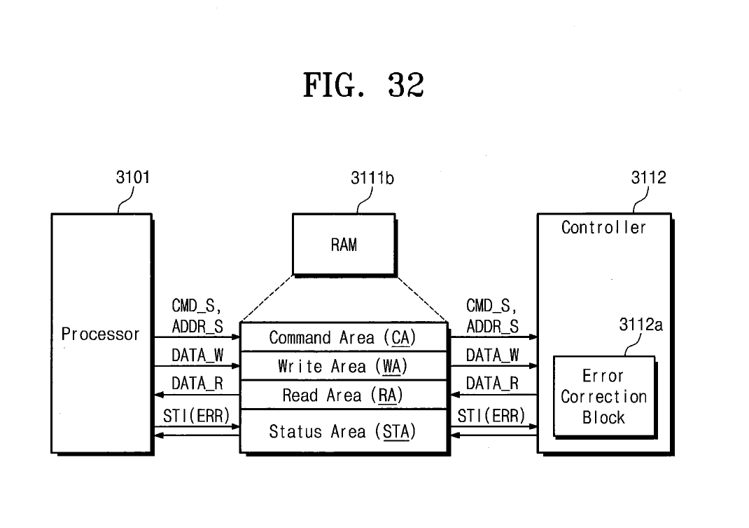

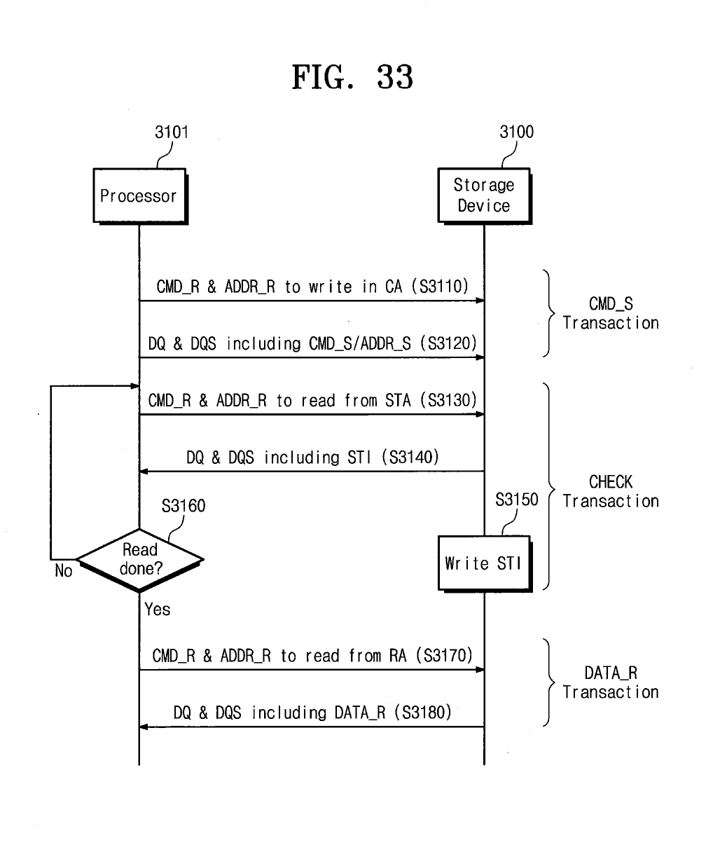

In some embodiments, the RAM 3111b may include a multi-port RAM such as dual port SRAM (DPSRAM) and/or a shared RAM. In some embodiments, the RAM 3111b may be respectively accessed by the processor 3101 and the controller 3112 through different ports. A configuration of the RAM 3111b will be described in detail with reference to FIG. 32. In addition, the write operation and the read operation will be described with reference to FIGS. 33 to 40.

The controller 3112 may include a variety of hardware components or software components to control the physical layer 3111 and the nonvolatile memories 3120. For example, the controller 3112 may include an error correction code (ECC) encoding/decoding engine, a scrambler/descrambler, a data buffer, and/or a flash translation layer.

The controller 3112 may detect and correct an error of data through the ECC encoding/decoding engine and may generate or add an ECC code associated with data. The controller 3112 may scramble or descramble data using the scrambler/descrambler. The controller 3112 may temporarily store data read from the RAM 3111b and/or the nonvolatile memories 3120 in the buffer memory 3130. The controller 3112 may perform translation between a logical address, associated with the storage address ADDR_S, and a physical address using the flash translation layer. To this end, the buffer memory 3130 may store a table including mapping between a logical address and a physical address of the nonvolatile memories 3120.

According to embodiments of the inventive concept, the processor 3101 may provide an error correction code to the storage device 3100 together with write data DATA_W. For example, the processor 3101 may encode the ECC based on at least one of various coding techniques such as a BCH (Bose-Chaudhuri-Hocquenghem) code, an RS (Reed-Solomon) code, and the like. The error correction code may be transmitted to the storage device 3100 through a data input/output pin defined in the DIMM specification.

According to embodiments of the inventive concept, the controller 3112 may include an error correction block 3112a. The error correction block 3112a may decode the error correction code received from the processor 3101. The error correction block 3112a may check an error of the write data DATA_W read from the RAM 3111b with reference to the decoded error correction code. The device controller 3110 may store the error information in the RAM 3111b based on the error detection result of the error correction block 3112a.

The error information may be accessed and monitored by the processor 3101. The processor 3101 may access the RAM 3111b to obtain the error information. The error information may be accessed by the processor 3101 through a data input/output pin defined in the DIMM specification. Embodiments of the error correction block 3112a and the error information will be described with reference to FIGS. 34 to 40.

FIG. 32 is a diagram schematically illustrating a configuration of a RAM of FIG. 31 and communications among a processor 3101, a RAM 3111b, and a controller 3112. In some embodiments, the RAM 3111b may include a command area CA, a write area WA, a read area RA, and a status area STA. The command area CA, the write area WA, the read area RA, and the status area STA may be classified logically and/or physically.

One of the command area CA, the write area WA, the read area RA, and the status area STA may be selected according to a RAM address ADDR_R (refer to FIG. 31) provided from the processor 3101. In addition, a write operation or a read operation about the selected area may be performed based on a RAM command CMD_R (refer to FIG. 31) provided from the processor 3101. For example, in the case where a RAM write command is provided as the RAM command CMD_R, a write operation may be performed at the selected area. In contrast, in the case where a RAM read command is provided as the RAM command CMD_R, a read operation may be performed at the selected area.

The command area CA may store the storage command CMD_S and the storage address ADDR_S provided from the processor 3101. The controller 3112 may read the storage command CMD_S and the storage address ADDR_S stored in the command area CA. The storage command CMD_S may indicate whether an operation to be performed with respect to one or more nonvolatile memories 3120 is a read operation or a write operation (i.e., whether a received request is a read request or a write request). The storage address ADDR_S may indicate a position of the nonvolatile memories 3120 where a write operation or a read operation is to be performed.

The write area WA and the read data RA may store write data DATA_W and read data DATA_R, respectively. The write data DATA_W provided from the processor 3101 may be temporarily stored in the write area WA and may be then provided to the nonvolatile memories 3120 under control of the controller 3112. The read data DATA_R read from the nonvolatile memories 3120 may be temporarily stored in the read area RA under control of the controller 3112 and may be then provided to the processor 3101.

Under control of the RAM controller 3111a (refer to FIG. 31) and the controller 3112, the status area STA may store the status information STI associated with write data DATA_W and/or read data DATA_R. The status information STI may include information associated with a progress of a write operation and/or a read operation. The processor 3101 may recognize whether the write operation and/or the read operation is completed, based on the status information STI. In addition, the processor 3112 may monitor the progress of the write operation and/or the read operation, based on the status information STI.

For example, in the case where the processor 3101 intends to store write data DATA_W, it may provide the write data DATA_W to the write area WA. In addition, the processor 3101 may provide the status area STA with information associated with the write data DATA_W and/or status information STI associated with a request of a write operation. The controller 3112 may control a write operation based on the status information STI such that the write data DATA_W is stored in at least one of the nonvolatile memories 3120. In the case where the controller 3112 stores status information STI, informing a completion of the write operation, in the status area STA, the processor 3101 may recognize the completion of the write operation based on the status information STI. To this end, the processor 3101 may poll the status area STA at a specific time (e.g., periodically).

As will be described with reference to FIGS. 34 to 40, the write data DATA_W may be received together with the error correction code. The error correction code may be stored in the write area WA together with the write data DATA_W. The error correction block 3112a may check an error of the write data DATA_W with reference to the decoded error correction code. Based on the error detection result, the error information ERR may be stored in the status area STA as status information STI. The processor 3101 may monitor the error information ERR and may actively cope with an error the write data DATA_W.

For example, in the case where the processor 3101 intends to read read data DATA_R, the processor 3101 may provide the status area STA with information associated with the read data DATA_R and status information STI associated with a request of a read operation. The controller 3112 may control a read operation based on the status information STI such that the read data DATA_R is read from at least one of the nonvolatile memories 3120. In the case where the controller 3112 stores status information STI, informing a completion of the read operation, in the status area STA, the processor 3101 may recognize the completion of the read operation based on the status information STI. In addition, the processor 3101 may be provided with the read data DATA_R stored in the read area RA.

FIG. 33 is a flow chart for describing an embodiment of a read operation of the storage device 3100 illustrated in FIG. 31. The processor 3101 may be provided with read data DATA_R stored in the storage device 3100 based on the read procedure of FIG. 33. To help understand the inventive concept, a description will be given with reference to FIGS. 31 and 32.

In step S3110, the processor 3101 may provide a RAM command CMD_R for requesting a write operation about the RAM 3111b to the storage device 3100. In addition, the processor 3101 may provide a RAM address CMD_R for selecting a command area CA of the RAM 3111b to the storage device 3100.

In operation S3120, the processor 3101 provide the storage device 3100 with a data signal DQ and a data strobe signal DQS. In operation S3120, the data signal DQ may include a storage command CMD_S for requesting a read operation about the storage device 3100, in more detail, a read operation about the nonvolatile memories 3120. In addition, the data signal DQ may include a storage address ADDR_S indicating a position of the nonvolatile memories 3120 where the read operation is to be performed.

Steps S3110 and S3120 may compose a command transaction for transmitting a read command about the nonvolatile memories 3120 to the storage device 3100. In the case where operations S3110 and S3120 are performed, the command area CA of the RAM 3111b may store the storage command CMD_S and the storage address ADDR_S.

Here, the storage command CMD_S may inform that the read operation is performed at the nonvolatile memories 3120. The read operation may be performed at a position of the nonvolatile memories 3120 corresponding to the storage address ADDR_S. As the storage command CMD_S and the storage address ADDR_S are stored in the RAM 3111b, the controller 3112 may control the read operation based on the storage command CMD_S and the storage address ADDR_S.

In step S3130, the processor 3101 may provide a RAM command CMD_R for requesting a read operation about the RAM 3111b to the storage device 3100. In addition, the processor 3101 may provide a RAM address ADDR_R for selecting a status area STA of the RAM 3111b to the storage device 3100.

In operation S3140, the processor 3101 may be provided with the data signal DQ and the data strobe signal DQS from the storage device 3100. In operation S3140, the data signal DQ may include status information associated with the read operation.

In operation S3150, the storage device 3100 may store information STI associated with the read data DATA_R and the read operation in the status area STA. For example, in the case where the read operation is completed at the storage device 3100, operation S3150 may be performed.

In operation S3160, the processor 3101 may determine whether the read operation is completed. The processor 3101 may determine whether the read operation is completed, based on the status information STI stored in the status area STA.

Operations S3130 to S3160 may compose a check transaction to check whether the read operation is completed at the nonvolatile memories 3120. If the determination indicates that the read operation is not completed, the processor 3101 may repeat operations S3130 and S3140 to continue to poll whether the read operation is completed. In the case where the read operation is determined as being performed, operation S3170 may be performed.

In step S3170, the processor 3101 may provide a RAM command CMD_R for requesting a read operation about the RAM 3111b to the storage device 3100. In addition, the processor 3101 may provide a RAM address ADDR_R for selecting a read area RA of the RAM 3111b to the storage device 3100.

In operation S3180, the processor 3101 provide the storage device 3100 with a data signal DQ and a data strobe signal DQS. In operation S3180, the data signal DQ may include read data DATA_R read from the storage device 3100.

Operations S3170 and S3180 may compose a data transaction for transmitting the read data DATA_R from the storage device 3100 to the processor 3101. In the case where operations S3170 and S3180 are performed, the read data DATA_R may be stored in the read area RA of the RAM 3111b and may be then provided to the processor 3101. After operation S3180 is completed, the processor 3101 may request a next operation from the storage device 3100.

FIG. 34 is a flow chart for describing an embodiment of a write operation of the storage device 3100 illustrated in FIG. 31. The processor 3101 may store write data DATA_W in the storage device 3100 based on the write procedure of FIG. 34. To help understand the inventive concept, a description will be given with reference to FIGS. 31 and 32.

In step S3210, the processor 3101 may provide a RAM command CMD_R for requesting a write operation about the RAM 3111b to the storage device 3100. In addition, the processor 3101 may provide a RAM address ADDR_R for selecting a command area CA of the RAM 3111b to the storage device 3100.

In operation S3220, the processor 3101 may provide the storage device 3100 with a data signal DQ and a data strobe signal DQS. In operation S3220, the data signal DQ may include a storage command CMD_S for requesting a write operation about the storage device 3100, in more detail, a write operation about the nonvolatile memories 3120. In addition, the data signal DQ may include a storage address ADDR_S indicating a position of the nonvolatile memories 3120 where the write operation is to be performed.

Steps S3210 and S3220 may compose a command transaction for transmitting a write command about the nonvolatile memories 3120 to the storage device 3100. In the case where operations S3210 and S3220 are performed, the command area CA of the RAM 3111b may store the storage command CMD_S and the storage address ADDR_S. Here, the storage command CMD_S may inform that the write operation is performed at the nonvolatile memories 3120. The write operation may be performed at a position of the nonvolatile memories 3120 corresponding to the storage address ADDR_S.

In step S3230, the processor 3101 may provide a RAM command CMD_R for requesting a write operation about the RAM 3111b to the storage device 3100. In addition, the processor 3101 may provide a RAM address ADDR_R for selecting a write area WA of the RAM 3111b to the storage device 3100.

In operation S3240, the processor 3101 may provide the storage device 3100 with a data signal DQ and a data strobe signal DQS. In operation S3240, the data signal DQ may include write data DATA_W to be stored in the storage device 3100. In addition, the data signal DQ may include an error correction code ECC used to check an error of the write data DATA_W.

Steps S3230 and S3240 may compose a data transaction for transmitting the write data DATA_W to be stored in the nonvolatile memories 3120 to the storage device 3100. In the case where operations S3230 and S3240 are performed, the write area WA of the RAM 3111b may store the write data DATA_W and the error correction code ECC.

As the storage command CMD_S, the storage address ADDR_S, the write data DATA_W, and the error correction code ECC are stored in the RAM 3111b, the controller 3112 may check an error of the write data DATA_W with reference to the error correction code ECC. In addition, the controller 3112 may control a write operation based on the storage command CMD_S and the storage address ADDR_S.

In step S3250, the processor 3101 may provide a RAM command CMD_R for requesting a read operation about the RAM 3111b to the storage device 3100. In addition, the processor 3101 may provide a RAM address ADDR_R for selecting a status area STA of the RAM 3111b to the storage device 3100.

In operation S3260, the processor 3101 may be provided with the data signal DQ and the data strobe signal DQS from the storage device 3100. In operation S3260, the data signal DQ may include status information associated with the write operation.

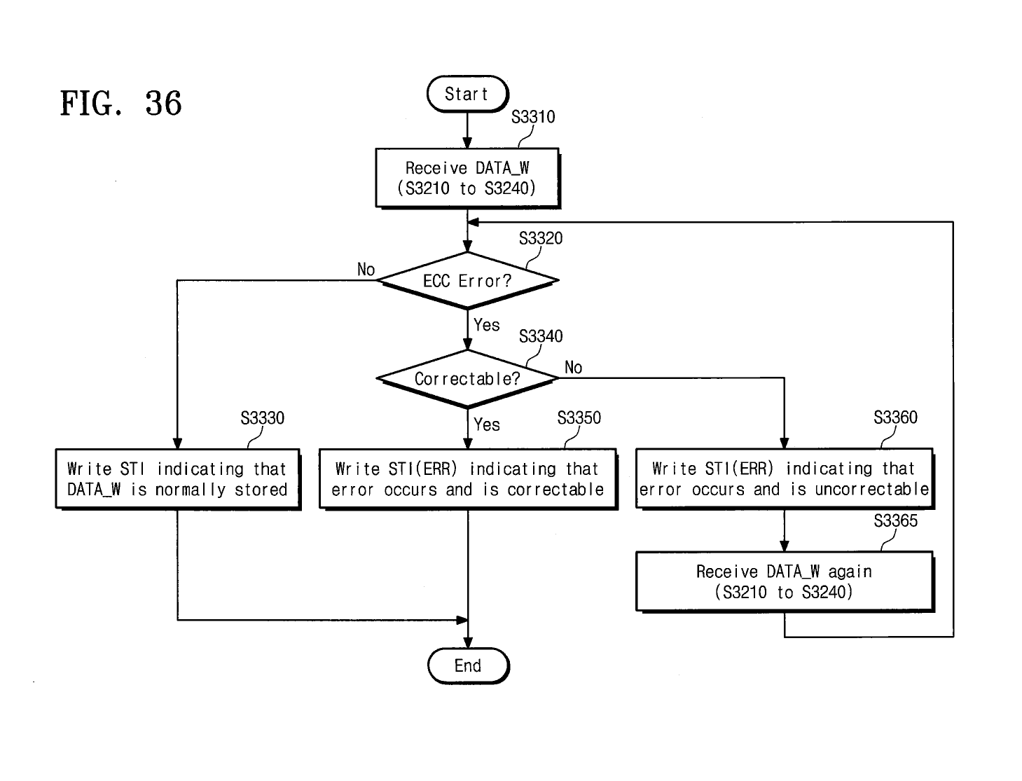

In operation S3270, the storage device 3100 may store information associated with the write data DATA_W and the write operation in the status area STA. According to embodiments of the inventive concept, the storage device 3100 may determine whether the write data DATA_W includes an error, with reference to the error correction code ECC. In addition, the storage device 3100 may generate error information ERR as status information STI based on the error detection result and may store the error information ERR in the status area STA. For example, in the case where the write operation is completed at the storage device 3100, in the case where the write operation is scheduled, in the case where an instruction of the write operation enters a queue, or in the case where an error occurs from the write data DATA_W, operation S3270 may be performed. Operation S3270 will be further described with reference to FIG. 36.

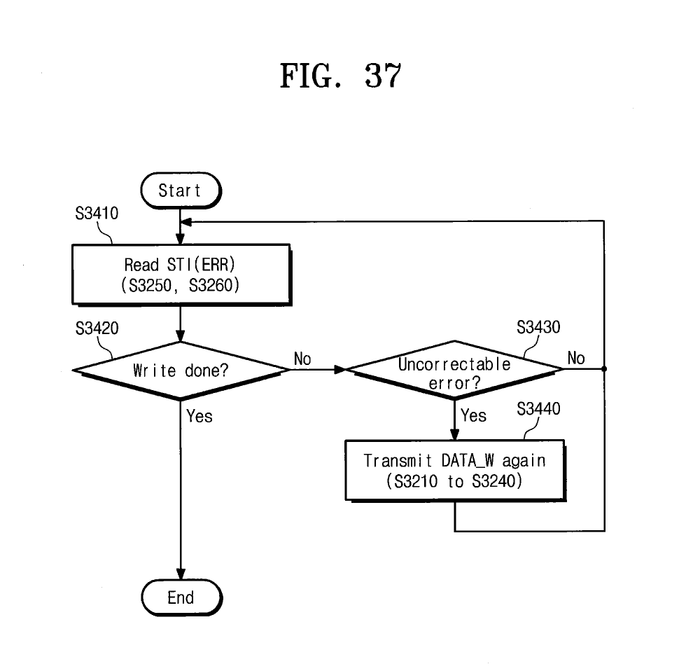

In operation S3280, the processor 3101 may determine whether the write operation is completed or whether an error occurs from the write data DATA_W. The processor 3101 may determine whether the write operation is completed, based on the status information STI stored in the status area STA. The processor 3101 may obtain the error information ERR stored in the status area STA and may actively cope with an error the write data DATA_W. Operation S3280 will be further described with reference to FIG. 37.

Operations S3250 to S3280 may compose a check transaction to check whether the write operation is completed at the nonvolatile memories 3120. If the determination indicates that the write operation is not completed, the processor 3101 may repeat operations S3250 and S3260 to continue to poll whether the write operation is completed. In some embodiments, in the case where there is determined that an error exists in the write data DATA_W, the processor 3101 may recognize an error through the error information ERR. In contrast, if the determination indicates that the write operation is completed, the processor 3101 may request a next operation from the storage device 3100.

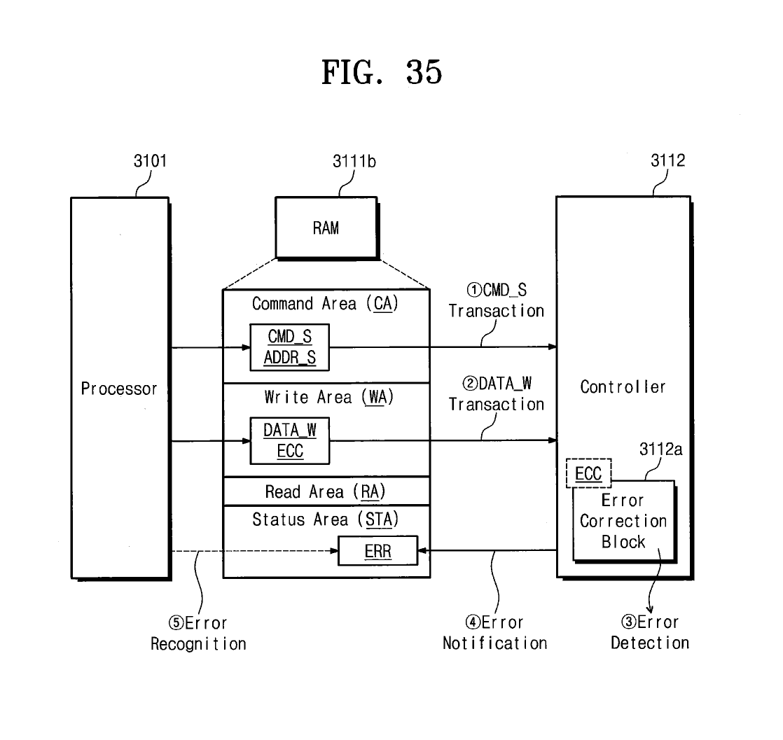

FIG. 35 is a diagram illustrating a procedure for communicating an error of write data during a write operation of FIG. 34. To help understand the inventive concept, a description will be given with reference to FIG. 31.

During a write operation, the processor 3101 may provide a storage command CMD_S and a storage address ADDR_S to the controller 3112 to store write data DATA_W in at least one of the nonvolatile memories 3120. The storage command CMD_S and the storage address ADDR_S may be transmitted through a command area CA of the RAM 3111b (\textcircled{1}). Afterwards, the processor 3101 may provide the controller 3112 with the write data DATA_W and the error correction code ECC. For example, the write data DATA_W and the error correction code ECC may be transmitted through the write area WA (\textcircled{2}).

The error correction block 3112a of the controller 3112 may be provided with the error correction code ECC. The error correction block 3112a may check an error of the write data DATA_W with reference to the error correction code (\textcircled{3}). In some cases, an error may not exist at the write data DATA_W. In some cases, the write data DATA_W may include a correctable error. In some cases, the write data DATA_W may include an uncorrectable error.

The error correction block 3112a may store the error information ERR in the status area STA of the RAM 3111b based on the error detection result of the error correction block 3112a (\textcircled{4}). For example, the error information ERR may include information associated with whether an error is detected from the write data DATA_W. For example, the error information ERR may include information associated with whether an error is detected from the write data DATA_W. For example, the error information ERR may include information associated with whether a correctable error is corrected.

The processor 3101 may access the status area STA of the RAM 3111b. The processor 3101 may access the status area STA at a specific time (e.g., periodically) to obtain the error information ERR stored in the status area STA. The processor 3101 may determine whether the error information ERR is stored in the status area STA, at the specific time (\textcircled{5}). Accordingly, the processor 3101 may obtain information associated with an error of the write data DATA_W and may actively cope with the error.

FIG. 36 is a flow chart illustrating a procedure for checking an error and generating error information during a write operation of FIG. 34 at a storage device 3100 of FIG. 31. To help understand the inventive concept, a description will be given with reference to FIGS. 31, 34, and 35.

In operation S3310, the storage device 3100 may receive write data DATA_W from the processor 3101 by the device controller 3110. The write data DATA_W may be received together with an error correction code ECC. Operation S3310 may be performed according to operations S3210 to S3240 of FIG. 34.

In operation S3320, the storage device 3100 may check an error of the write data DATA_W by the error correction block 3112a. The error correction block 3112a may check an error of the write data DATA_W with reference to the error correction code. In the case where no error is detected in operation S3320, the storage device 3100 may store the write data DATA_W in at least one of the nonvolatile memories 3120 by the device controller 3110.

In addition, in the case where no error is detected in operation S3320, operation S3330 may be performed. In operation S3330, the storage device 3100 may store status information STI in the status area STA of the RAM 3111b by the device controller 3110. Here, the status information STI may indicate that the write data DATA_W is normally stored. The processor 3101 may recognize completion of the write operation, based on the status information STI.

In the case where an error is detected in operation S3320, operation S3340 may be performed. In operation S3340, the storage device 3100 may determine whether the error detected by the error correction block 3112a is correctable. To determine whether an error is correctable based on the error correction code ECC may be well known, and thus a description thereof is omitted.

In the case where the detected error is determined in operation S3340 as being correctable, the storage device 3100 may correct the detected error by the error correction block 3112a. After the detected error is corrected, the storage device 3100 may store the write data DATA_W in at least one of the nonvolatile memories 3120 by the device controller 3110.

In addition, in the case where the detected error is determined in operation S3340 as being correctable, operation S3350 may be performed. In operation S3350, the storage device 3100 may store error information ERR in the status area STA of the RAM 3111b by the device controller 3110. Here, the error information ERR may indicate that an error is detected from the write data DATA_W and/or the detected error is correctable.

In the case where the detected error is corrected, the error information ERR may further indicate that the detected error is corrected. In addition, in the case where the write data DATA_W is stored after the detected error is corrected, the error information ERR or the status information STI may indicate that the write data DATA_W is normally stored. The processor 3101 may recognize occurrence of an error, correction of the error, and/or completion of the write operation, based on the status information STI and/or the error information ERR.

In the case where the detected error is determined in operation S3340 as being uncorrectable, operation S3360 may be performed. In operation S3360, the storage device 3100 may store error information ERR in the status area STA of the RAM 3111b by the device controller 3110. Here, the error information ERR may indicate that an error is detected from the write data DATA_W and/or the detected error is uncorrectable.

The processor 3101 may recognize occurrence of an error and non-correction of the error, based on the error information ERR. In this case, in operation S3365, the storage device 3100 may again receive the write data DATA_W from the processor 3101 based on the error information ERR. Operation S3365 may be performed according to operations S3210 to S3240 of FIG. 34. After the write data DATA_W is again received, in operation S3320, the storage device 3100 may check an error of the again received write data DATA_W.

FIG. 37 is a flow chart illustrating a procedure for checking error information during a write operation of FIG. 34 at a storage device 3100 of FIG. 31. To help understand the inventive concept, a description will be given with reference to FIGS. 31, 34, and 35.

After transmitting the write data DATA_W and the error correction code ECC to the storage device 3100, the processor 3101 may poll the status area STA of the RAM 3111b during a check time. In step S3410, the processor 3101 may determine whether the status information STI and/or the error information ERR is stored in the status area STA. Operation S3410 may be performed according to operations S3250 to S3260 of FIG. 34.

In operation S3420, the processor 3101 may determine whether the write operation is completed, based on the status information STI and/or the error information ERR. As described with reference to FIG. 36, in the case where the error of the write data DATA_W is not detected, the write data DATA_W may be stored in at least one of the nonvolatile memories 3120. In some embodiments, after a correctable error is detected and the detected error is corrected, the write data DATA_W may be stored in at least one of the nonvolatile memories 3120. In the case where the write data DATA_W is stored and the write operation is completed, the processor 3101 may request a next operation.

In contrast, in the case where the write operation is determined as being not completed, operation S3430 may be performed. In operation S3430, the processor 3101 may determine whether an uncorrectable error occurs from the write data DATA_W. In the case where an uncorrectable error does not occur, the write data DATA_W may not be fully stored. Accordingly, the processor 3101 may again determine, in operation S3410, whether the status information STI and/or the error information ERR is stored in the status area STA.

In the case where an uncorrectable error is detected in operation S3430, operation S3440 may be performed. In operation S3440, the processor 3101 may again transmit the write data DATA_W to the storage device 3100. Operation S3440 may be performed according to operations S3210 to S3240 of FIG. 34. After the write data DATA_W is again transmitted, the processor 3101 may determine, in operation S3410, whether the status information STI and/or the error information ERR is stored in the status area STA, with regard to the retransmitted write data DATA_W.

According to embodiments of the inventive concept, whether an error of the write data DATA_W occurs at the storage device 3100 may be monitored by the processor 3101. Accordingly, the processor 3101 may check a status of the write data DATA_W and may actively cope with the error. With the above description, reliability to store write data DATA_W may be improved.

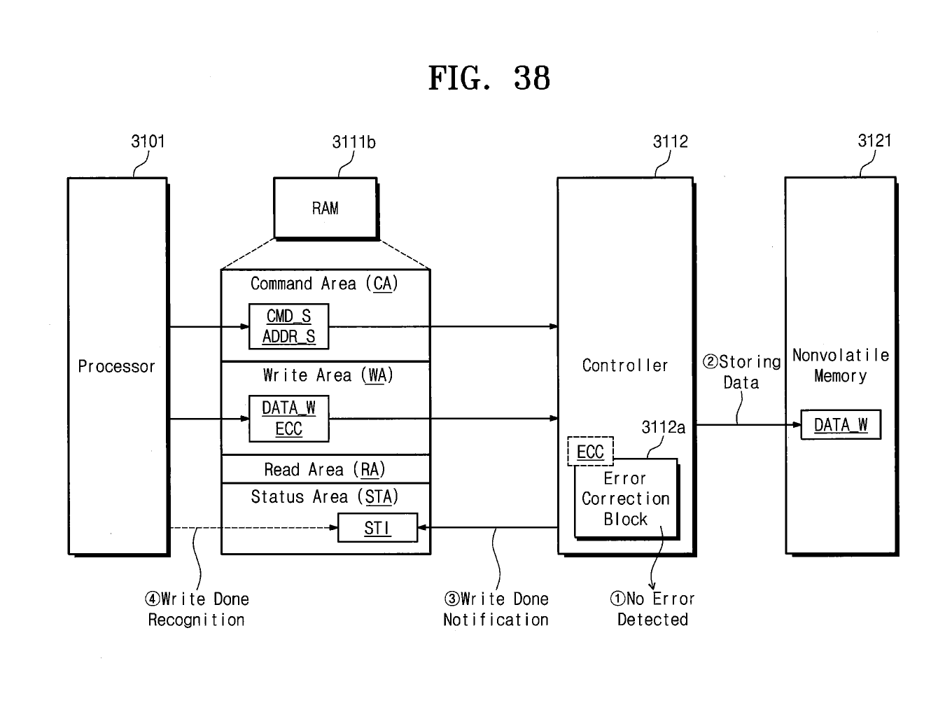

FIG. 38 is a diagram illustrating operations corresponding to the case that an error of write data does not occur during the write operation of FIG. 34.

After the processor 3101 provides write data DATA_W and an error correction code ECC to the controller 3112 through the write area WA, the error correction block 3112a may check an error of the write data DATA_W with reference to the error correction code ECC (\textcircled{1}). In some cases, an error may not be detected from the write data DATA_W. In this case, under control of the controller 3112, the write data DATA_W may be stored in at least one (e.g., 3121) of the nonvolatile memories 3120 (\textcircled{2}).

In the case where the write operation is completed after the write data DATA_W is stored in the nonvolatile memory 3121, the controller 3112 may store status information STI in the status area STA (\textcircled{3}). Here, the status information STI may indicate that the write data DATA_R is normally stored. The processor 3101 may recognize completion of the write operation, based on the status information STI (\textcircled{4}).

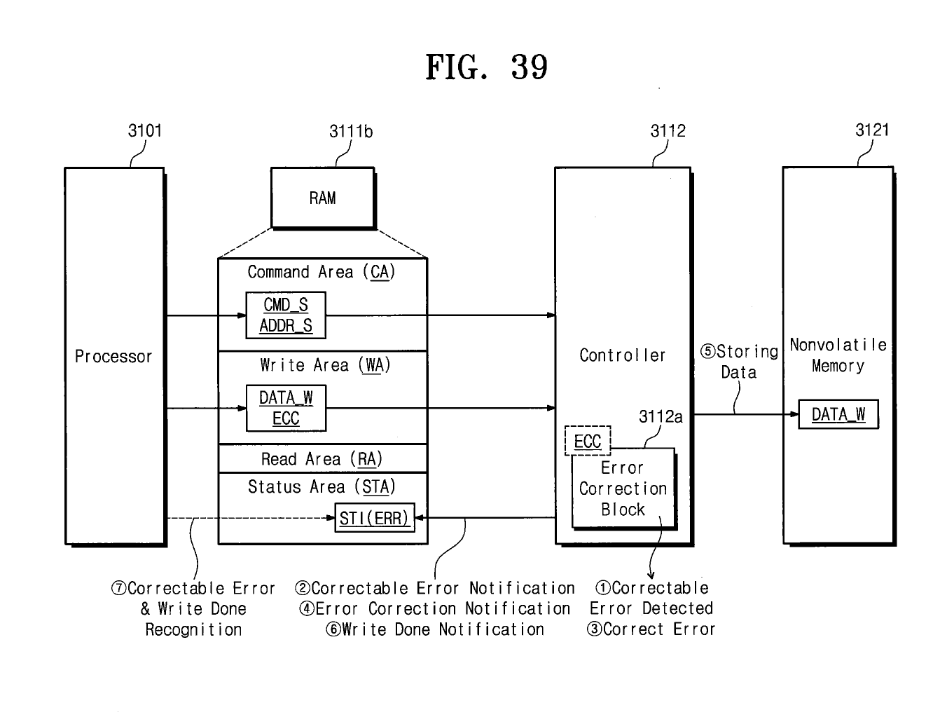

FIG. 39 is a diagram illustrating operations corresponding to the case that a correctable error of write data occurs during the write operation of FIG. 34.

After the processor 3101 provides write data DATA_W and an error correction code ECC to the controller 3112 through the write area WA, the error correction block 3112a may check an error of the write data DATA_W with reference to the error correction code ECC (\textcircled{1}). The error correction block 3112a may detect an error of the write data DATA_W. In some cases, however, it may be possible to correct the detected error.

In some embodiments, the controller 3112 may store error information ERR in the status area STA of the RAM 3111b to notify the processor 3101 that a correctable error is detected (\textcircled{2}). Here, the error information ERR may indicate that an error is detected from the write data DATA_W or the detected error is correctable. Afterwards, the error correction block 3112a may correct the detected error based on the error correction code ECC (\textcircled{3}). In some embodiments, the controller 3112 may store error information ERR in the status area STA of the RAM 3111b to notify the processor 3101 that the error is corrected (\textcircled{4}). Here, the error information ERR may indicate that the detected error is corrected.

After the detected error is detected, under control of the controller 3112, the write data DATA_W may be stored in at least one (e.g., 3121) of the nonvolatile memories 3120 (refer to FIG. 31) (\textcircled{5}). The controller 3112 may store the status information STI and/or the error information ERR in the status area STA of the RAM 3111b to notify the processor 3101 that the write data DATA_R is stored (\textcircled{6}). Here, the status information STI and/or the error information ERR may indicate that the write data DATA_R is normally stored.

The processor 3101 may recognize occurrence of an error, correction of the error, and completion of the write operation, based on the status information STI and/or the error information ERR (\textcircled{7}).

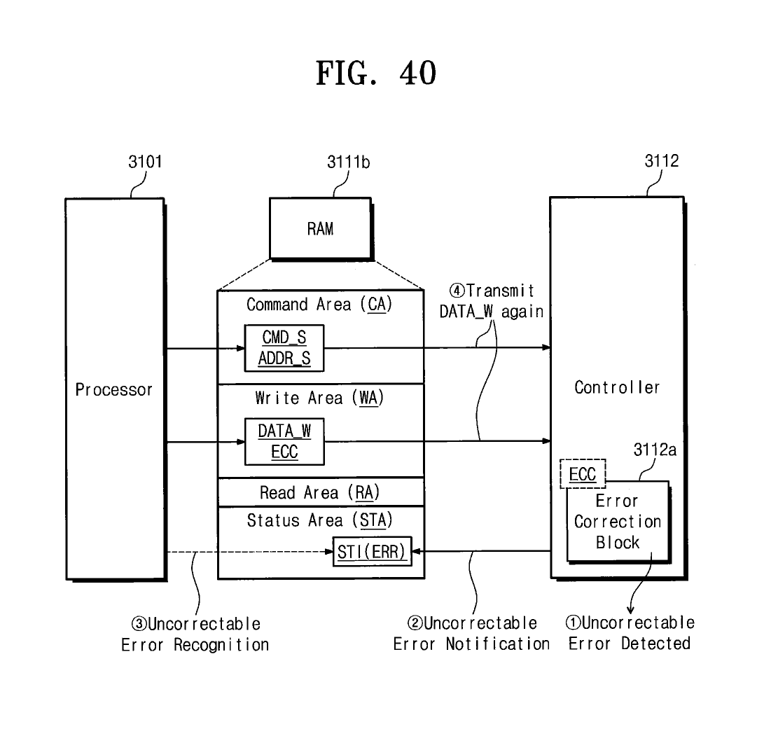

FIG. 40 is a diagram illustrating operations corresponding to the case that an uncorrectable error of write data occurs during the write operation of FIG. 34.

After the processor 3101 provides write data DATA_W and an error correction code ECC to the controller 3112 through the write area WA, the error correction block 3112a may check an error of the write data DATA_W with reference to the error correction code ECC (\textcircled{1}). The error correction block 3112a may detect an error of the write data DATA_W. In some cases, however, it may be impossible to correct the detected error.

The controller 3112 may store error information ERR in the status area STA of the RAM 3111b to notify the processor 3101 that an uncorrectable error is detected from the write data DATA_W (\textcircled{1}). Here, the error information ERR may indicate that an uncorrectable error is detected from the write data DATA_W. The processor 3101 may recognize occurrence of an error and non-correction of the error, based on the error information ERR (\textcircled{3}).

Since an uncorrectable error is detected from the write data DATA_W, the processor 3101 may retransmit the write data DATA_W to the controller 3112 (\textcircled{4}). The controller 3112 may check an error of the retransmitted write data by the error correction block 3112a. The controller 3112 may generate the status information STI or the error information ERR based on an error detection result.

According to embodiments described with reference to FIGS. 31 to 40, the processor 3101 of FIG. 31 may communicate with the device controller 3112 of FIG. 31 through a bus which operates at fast speed. In the case where the storage device 3100 is implemented in a DIMM form and the processor 3101 communicates with the device controller 3112 based on the interface protocol operating in the DDR manner, the processor 3101 may recognize the storage device 3100 as a DIMM device and may perform a read operation and a write operation about the RAM 3111b based on the interface protocol operating in the DDR manner. Accordingly, the operation performance of the storage device 3100 may be improved.

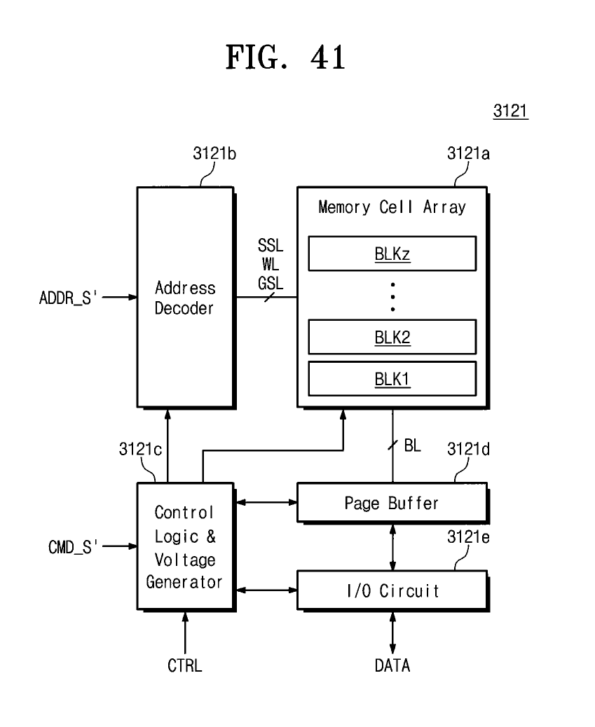

FIG. 41 is a block diagram illustrating one of nonvolatile memories of FIG. 31. At least one of nonvolatile memories 3120 of FIG. 31 may include a nonvolatile memory 3121. The nonvolatile memory 3121 may include a memory cell array 3121a, an address decoder 3121b, a control logic and voltage generator block 3121c, a page buffer 3121d, and an input/output circuit 3121e.

The memory cell array 3121a may include a plurality of memory blocks BLK1 to BLKz. The memory blocks may include a plurality of cell strings. The cell strings may include a plurality of memory cells. The memory cells may be connected with a plurality of word lines WL. A memory cell may be a single level cell (SLC) storing one bit or a multi-level cell (MLC) storing at least two bits.

In some embodiments of the inventive concept, a three dimensional (3D) memory array may be provided. The 3D memory array may be monolithically formed in one or more physical levels of arrays of memory cells having an active area disposed above a silicon substrate and circuitry associated with the operation of those memory cells, whether such associated circuitry is above or within such substrate.

In some embodiments of the inventive concept, the 3D memory array may include vertical NAND strings that are vertically oriented such that at least one memory cell is located over another memory cell. The at least one memory cell may comprise a charge trap layer. A vertical NAND string may include at least one select transistor located over memory cells, the at least one select transistor having the same structure with the memory cells and being formed monolithically together with the memory cells.

The address decoder 3121b may be connected with the memory cell array 3121a through the word lines WL, string selection lines SSL, and ground selection lines GSL The address decoder 3121b may decode a storage address ADDR_S′ received from the device controller 3110 (refer to FIG. 31). The address decoder 3121b may select at least one of the word lines WL based on the decoded storage address ADDR_S′ and may drive the at least one word line thus selected.

The control logic and voltage generator block 3121c may receive a storage command CMD_S′ and a control signal CTRL from the device controller 3110. The control logic and voltage generator block 3121c may control the address decoder 3121b, the page buffer 3121d, and the input/output circuit 3121e. For example, the control logic and voltage generator 3121c may control the address decoder 121b, the page buffer 3121d, and the input/output circuit 3121e in response to the storage command CMD_S′ and the control signal CTRL such that write data provided from the device controller 3110 is stored in the memory cell array 3121a or such that read data stored in the memory cell array 3121a is read.

The control logic and voltage generator block 3121c may generate various voltages used to operate the nonvolatile memory 3121. For example, the control logic and voltage generator block 3121c may generate a plurality of program voltages, a plurality of pass voltages, a plurality of selection read voltages, a plurality of non-selection read voltages, a plurality of erase voltages, and/or a plurality of verification voltages. The control logic and voltage generator block 3121c may provide the generated voltages to the address decoder 3121b or to a substrate of the memory cell array 3121a.

The page buffer 3121d may be connected with the memory cell array 3121a through the bit lines BL. Under control of the control logic and voltage generator block 3121c, the page buffer 3121d may control the bit lines BL such that write data provided from the input/output circuit 3121e is stored in the memory cell array 3121a. Under control of the control logic and voltage generator block 3121c, the page buffer 3121d may read data stored in the memory cell array 3121a and may provide the read data to the input/output circuit 3121e. For example, the page buffer 3121d may be provided with data from the input/output circuit 3121e by the page or may read data from the memory cell array 3121a by the page. In some embodiments, the page buffer 3121d may include data latches for temporarily storing data read from the memory cell array 3121a or data provided from the input/output circuit 3121e.

The input/output circuit 3121e may be provided with write data from an external device such as the device controller 3110 and may provide the write data to the page buffer 3121d. Alternatively, the input/output circuit 3121e may be provided with read data from the page buffer 3121d and may provide the read data to an external device such as the device controller 3110. For example, the input/output circuit 3121e may exchange data with an external device in synchronization with the control signal CTRL.

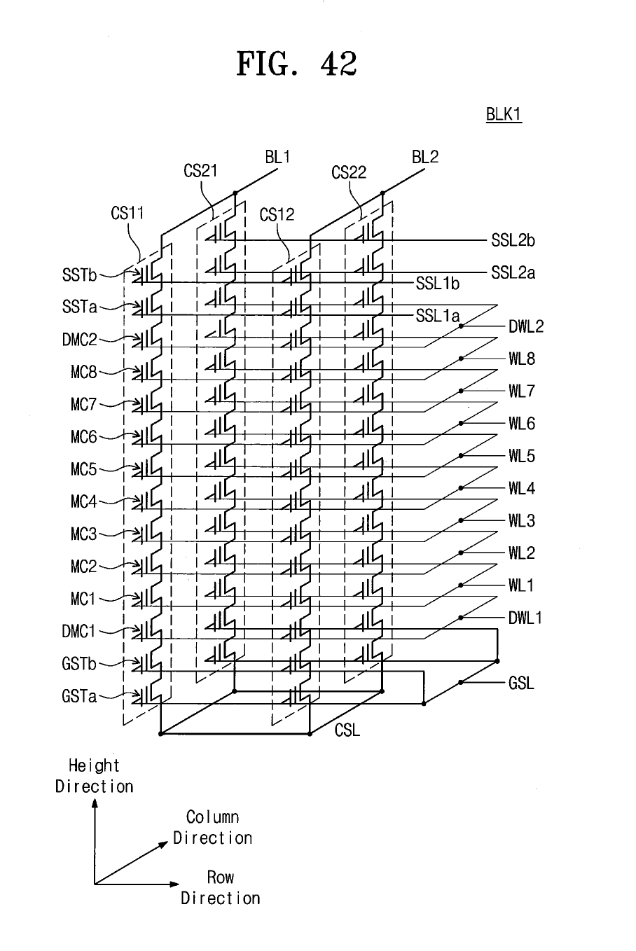

FIG. 42 is a circuit diagram illustrating an embodiment of a memory block of the memory cell array in FIG. 41. A memory block BLK1 having a three-dimensional structure will be described with reference to FIG. 42. In FIG. 42, embodiments of the inventive concept are exemplified as the memory cell array 3121a of FIG. 41 is a NAND flash memory array. However, the inventive concept is not limited to configuration illustrated in FIG. 42. In addition, other memory blocks may be configured substantially the same as the memory block BLK1.

Referring to FIG. 42, the memory block BLK1 may include a plurality of cell strings CS11, CS12, CS21, and CS22. The cell strings CS11, CS12, CS21, and CS22 may be arranged along a row direction and a column direction and may form rows and columns. For example, the cell strings CS11 and CS12 may be connected to string selection lines SSL1a and SSL1b to constitute a first row. The cell strings CS21 and CS22 may be connected to string selection lines SSL2a and SSL2b to constitute a second row. For example, the cell strings CS11 and CS21 may be connected to a first bit line BL1 to constitute a first column. The cell strings CS12 and CS22 may be connected to a second bit line BL2 to constitute a second column.

Each of the cell strings CS11, CS12, CS21, and CS22 may include a plurality of cell transistors. Each of the cell strings CS11, CS12, CS21, and CS22 may include string selection transistor SSTa and SSTb, a plurality of memory cells MC1 to MC8, ground selection transistors GSTa and GSTb, and dummy memory cells DMC1 and DMC2. In some embodiments, the memory cells included in the cell strings CS11, CS12, CS21, and CS22 may be a charge trap flash (CTF) memory cell.

The memory cells MC1 to MC8 may be serially connected and may be stacked a height direction being a direction perpendicular to a plane defined by a row direction and a column direction. The string selection transistors SSTa and SSTb may be serially connected and may be disposed between the memory cells MC1 to MC8 and a bit line BL. The ground selection transistors GSTa and GSTb may be serially connected and may be disposed between the memory cells MC1 to MC8 and a common source line CSL.

In some embodiments, a first dummy memory cell DMC1 may be disposed between the memory cells MC1 to MC8 and the ground selection transistors GSTa and GSTb. In some embodiments, a second dummy memory cell DMC2 may be disposed between the memory cells MC1 to MC8 and the string selection transistors SSTa and SSTb.

The ground selection transistors GSTa and GSTb of the cell strings CS11, CS12, CS21, and CS22 may be connected in common to a ground selection line GSL. In some embodiments, ground selection transistors in the same row may be connected to the same ground selection line, and ground selection transistors in different rows may be connected to different ground selection lines. For example, the first ground selection transistors GSTa of the cell strings CS11 and CS12 in the first row may be connected to the first ground selection line, and the first ground selection transistors GSTa of the cell strings CS21 and CS22 in the second row may be connected to the second ground selection line.

In some embodiments, although not shown, ground selection transistors at the same height from a substrate (not shown) may be connected to the same ground selection line, and ground selection transistors at different heights therefrom may be connected to different ground selection lines. For example, the ground selection transistors GSTa of the cell strings CS11, CS12, CS21, and CS22 may be connected to the first ground selection line, and the ground selection transistors GSTb thereof may be connected to the second ground selection line.

Memory cells placed at the same height from the substrate (or the ground selection transistors GSTa and GSTb) may be connected in common to the same word line, and memory cells placed at different heights therefrom may be connected to different word lines. For example, memory cells MC1 to MC8 of the cell strings CS11, CS12, CS21, and CS22 may be connected in common to first to eighth word lines WL1 to WL8.

String selection transistors, belonging to the same row, from among the first string selection transistors SSTa placed at the same height may be connected to the same string selection line, and string selection transistors belonging to different rows may be connected to different string selection lines. For example, the first string selection transistors SSTa of the cell strings CS11 and CS12 in the first row may be connected in common to the string selection line SSL1a, and the first string selection transistors SSTa of the cell strings CS21 and CS22 in the second row may be connected in common to the string selection line SSL2a.

Likewise, string selection transistors, belonging to the same row, from among the second string selection transistors SSTb at the same height may be connected to the same string selection line, and string selection transistors in different rows may be connected to different string selection lines. For example, the second string selection transistors SSTb of the cell strings CS11 and CS12 in the first row may be connected in common to a string selection line SSL1b, and the second string selection transistors SSTb of the cell strings CS21 and CS22 in the second row may be connected in common to a string selection line SSL2b.

Although not shown, string selection transistors of cell strings in the same row may be connected in common to the same string selection line. For example, the first and second string selection transistors SSTa and SSTb of the cell strings CS11 and CS12 in the first row may be connected in common to the same string selection line. The first and second string selection transistors SSTa and SSTb of the cell strings CS21 and CS22 in the second row may be connected in common to the same string selection line.

In some embodiments, dummy memory cells at the same height may be connected with the same dummy word line, and dummy memory cells at different heights may be connected with different dummy word lines. For example, the first dummy memory cells DMC1 may be connected to a first dummy word line DWL1, and the second dummy memory cells DMC2 may be connected to a second dummy word line DWL2.

In the memory block BLK1, read and write operations may be performed by the row. For example, one row of the memory block BLK1 may be selected by the string selection lines SSL1a, SSL1b, SSL2a, and SSL2b.

The cell strings CS11 and CS12 in the first row may be respectively connected to the bit lines BL1 and BL2 when the turn-on voltage is supplied to the string selection lines SSL1a and SSL1b and the turn-off voltage is supplied to the string selection lines SSL2a and SSL2b. The cell strings CS21 and CS22 in the second row may be respectively connected to the bit lines BL1 and BL2 when the turn-on voltage is supplied to the string selection lines SSL2a and SSL2b and the turn-off voltage is supplied to the string selection lines SSL1a and SSL1b. As a word line is driven, memory cells, placed at the same height, from among memory cells in cell strings connected to the driven word line may be selected. Read and write operations may be performed with respect to the selected memory cells. The selected memory cells may constitute a physical page.

In the memory block BLK1, memory cells may be erased by the memory block or by the sub-block. When erasing is performed by the memory block, all memory cells MC in the memory block BLK1 may be simultaneously erased according to an erase request. When erasing is performed by the sub-block, a portion of memory cells MC in the memory block BLK1 may be simultaneously erased according to an erase request, and the other thereof may be erase-inhibited. A low voltage (e.g., a ground voltage) may be supplied to a word line connected to erased memory cells MC, and a word line connected to erase-inhibited memory cells MC may be floated.

A configuration of the memory block BLK1 illustrated in FIG. 42 may be an example. The number of cell strings may increase or decrease, and the number of rows of cell strings and the number of columns of cell strings may increase or decrease according to the number of cell strings. In the memory block BLK1, the number of cell strings (GST, MC, DMC, SST, or the like) may increase or decrease, and a height of the memory block BLK1 may increase or decrease according to the number of cell strings (GST, MC, DMC, SST, or the like). Furthermore, the number of lines (GSL, WL, DWL, SSL, or the like) connected with cell transistors may increase or decrease according to the number of cell strings (GST, MC, DMC, SST, or the like).

IV. Nonvolatile Memory Module Performing Error Correction

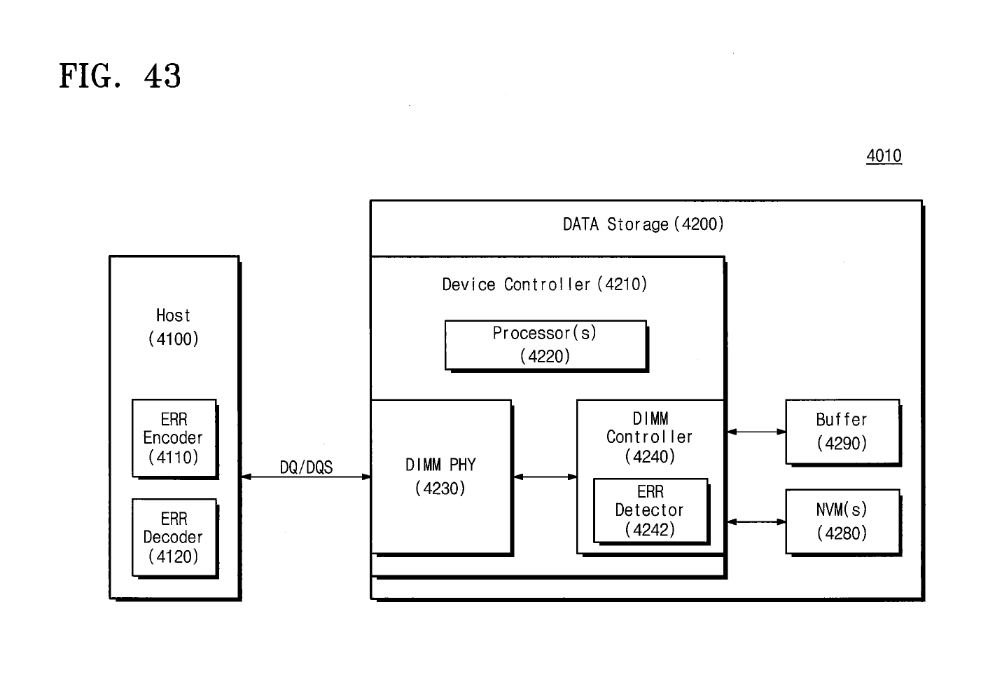

FIG. 43 is a block diagram illustrating a storage system 4010 according to embodiments of the inventive concept. Referring to FIG. 43, a storage system 4010 may include a host 4100 and data storage 4200.

The host 4100 may access the data storage 4200 to perform a read operation and/or a write operation with respect to the data storage 4200. The host 4100 may access a physical layer 4230 of a device controller 4210. The host 4100 may include an ECC encoder 4110 and an ECC decoder 4120. The ECC encoder 4110 may encode data to be transmitted to the data storage 4200. For example, the ECC encoder 4120 may add an error correcting code (ECC) parity to data (e.g., a storage command, read data, write data, and the like) transmitted to the data storage 4200. The ECC parity may be used to detect and correct an error included in data transmitted to the data storage 4200. The ECC decoder 4120 may decode data (e.g., read data) transferred from the data storage 4200 to determine whether an error exists.

The data storage 4200 may include a device controller 4210 which controls an overall operation of the data storage 4200. The device controller 4210 may include a DIMM PHY (i.e., a physical layer) 4230 for interfacing with the host 4100. The data storage 4200 may be connected with the host 4100 through a high-speed interface such as a DIMM interface. That is, the DIMM PHY 4230 may interface with the host 4100 based on a protocol such as, for example, DDR (e.g., DDR2, DDR3, DDR4, etc.). The device controller 4210 may include a DIMM controller 4240 which controls data exchange between the physical layer 4230 and a nonvolatile memory 4280. The DIMM controller 4240 may include an error detector 4242 which determines whether data received from the host 4100 is erroneous.

According to embodiments of the inventive concept, the device controller 4210 may determine whether an error is included in data received from the host 4100, using hardware (i.e., an error detector 4242). The device controller 4210 may drive error correction firmware to correct a detected error. That is, error detection may be made using hardware, while error correction may be made using firmware. That is, a chip size may be reduced.

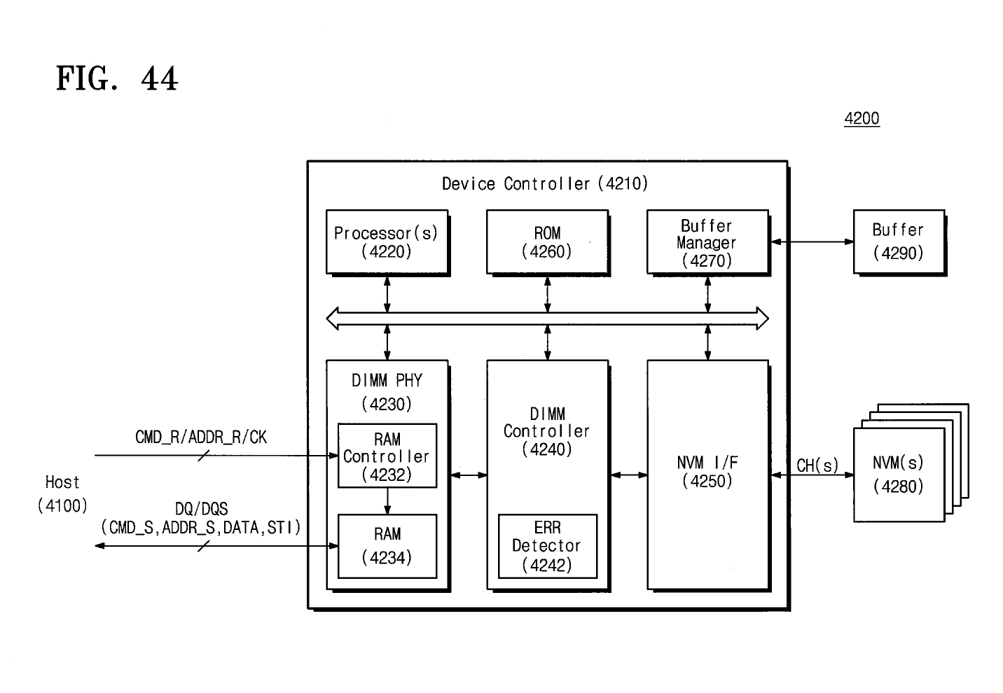

FIG. 44 is a block diagram illustrating a configuration of data storage 4200 illustrated in FIG. 43. Referring to FIG. 44, the data storage 4200 may include a controller 4210, a nonvolatile memory 4280, and a buffer 4290.

The device controller 4210 may include at least one processor 4220, a DIMM PHY (i.e., a physical layer) 4230, a DIMM controller 4240, a nonvolatile memory interface 4250, a ROM 4260, and a buffer manager 4270.

The processor 4220 may perform an overall operation of the device controller 4210. The processor 4220 may drive firmware for driving the device controller 4210. For example, the processor 4220 may load and drive firmware for correcting an error detected by the error detector 4242. For example, the firmware may be loaded and driven on a storage space such as a cache memory of the processor 4220 and/or the buffer 4290.

The DIMM PHY 4230 may include a RAM controller 4232 which receives a RAM command CMD_R, a RAM address ADDR_R, and a clock CK from the host 4100. The DIMM PHY 4230 may include a RAM 4234 which exchanges data with the host 4100 using data DQ and a data strobe signal DQS. At this time, data CMD_S, ADDR_S, DATA, and STI may be stored in a space of the RAM 4234 which is selected according to the RAM address ADDR_R from the host 4100. In some embodiments, data received from the host 4100 may be encoded data to which an ECC parity is added.

The RAM 4234 may be divided into an area to store a storage command CMD_S and a storage address ADDR_S, an area to store data, and an area to store status information STI. However, the scope and spirit of the inventive concept may not be limited thereto. For example, the RAM 4234 may be implemented with a ring buffer which stores the storage command CMD_S, the storage address ADDR_S, the data, and/or the status information STI.

The DIMM controller 4240 may access the RAM 4234 to process data stored in the RAM 4234. For example, the DIMM controller 4240 may read write data to be stored in the nonvolatile memory 4280 and may transmit the read data to the nonvolatile memory 4280. The DIMM controller 4240 may provide data read from the nonvolatile memory 4280 to the RAM 4234. For example, the DIMM controller 4240 may include an error detector which detects an error of encoded data (e.g., CMD_S, ADDR_S, DATA, and the like) transmitted from the host 4100.

The nonvolatile memory interface 4250 may provide an interface between the device controller 4210 and the nonvolatile memory 4280. For example, the device controller 4210 may exchange data with the nonvolatile memory 4280 through the nonvolatile memory interface 4250.

Various operations or firmware which is required to operate the device controller 4210 may be stored in the ROM 4260. For example, the ROM 4260 may store firmware for correcting an error detected by the error detector 4242. The ROM 4260 may store code data for interfacing with the host 4100.

The buffer manager 4270 may provide an interface between the device controller 4210 and the buffer 4290.

The nonvolatile memory device 4280 may include, for example, a three-dimensional memory array. In some embodiments of the inventive concept, a three dimensional (3D) memory array is provided. The 3D memory array may be monolithically formed in one or more physical levels of arrays of memory cells having an active area disposed above a silicon substrate and circuitry associated with the operation of those memory cells, whether such associated circuitry is above or within such substrate.

In some embodiments of the inventive concept, the 3D memory array includes vertical NAND strings that are vertically oriented such that at least one memory cell is located over another memory cell. The at least one memory cell may comprise a charge trap layer. A vertical NAND string may include at least one select transistor located over memory cells, the at least one select transistor having the same structure with the memory cells and being formed monolithically together with the memory cells. However, the scope and spirit of the inventive concept may not be limited thereto. For example, the nonvolatile memory 4280 may include a planar memory array.

The nonvolatile memory 4280 may be connected to the nonvolatile memory interface 4240 through the channels CH(s). The nonvolatile memory 4280 may include, for example, at least one of nonvolatile memories such as a PRAM, a RRAM, a MRAM, a FeRAM, and the like.

The buffer memory 4290 may be used as a working memory, a buffer memory, or a cache memory of the device controller 4210. For example, the buffer memory 4290 may include various random access memories such as a DRAM, an SRAM, a PRAM, and the like.

According to an embodiment of the inventive concept, the device controller 4210 may determine whether an error is included in data received from the host 4100, using hardware (i.e., the error detector 4242). The device controller 4210 may drive firmware to correct a detected error. That is, the device controller 4210 may correct an error using not hardware but firmware, and thus a chip size of a device including the same may be reduced.

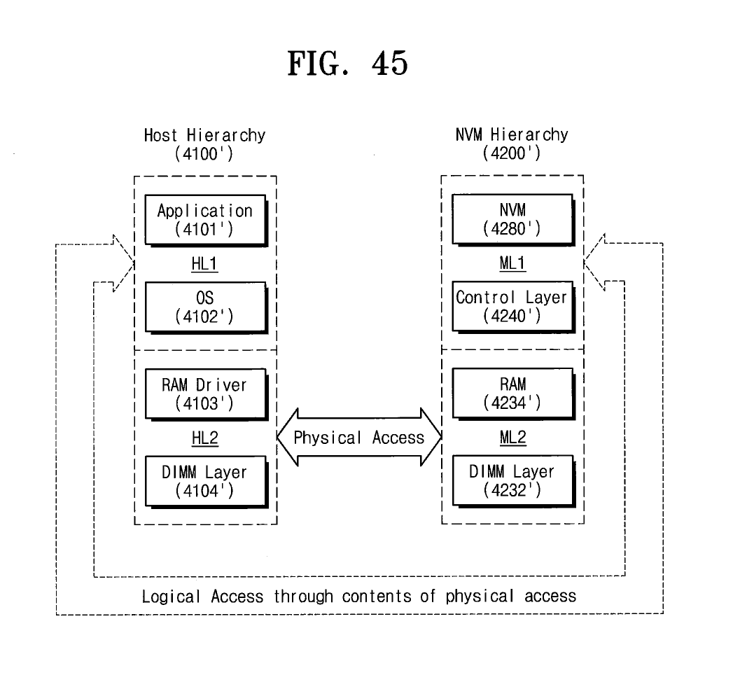

FIG. 45 is a diagram illustrating data storage and software layers according to embodiments of the inventive concept. Referring to FIG. 45, host layer software 4100′ may be driven on a host 4100. Software or firmware 4200′ of a nonvolatile memory layer may be driven on the storage device 4200.

The host layer 4100′ may include a variety of software layers. An application program 4101′ and an operating system 4102′ may be included in a host upper layer HL1. The application program 4101′ may be driven as a basic service and may be software of an upper layer driven by a user. The operating system 4102′ may perform an overall control operation of the computing system 4010 such as program execution, file access, driving of an application program, control of the storage device 4200, and the like.

A RAM driver 4103′ and/or a DIMM layer driver 4104′ may be a host lower layer HL2 for an access to the storage device 4200. The RAM driver 4103′ and/or the DIMM layer driver 4104′ may be substantially included in a kernel of an operating system 4102′. The RAM driver 4103′ may perform a control operation for an access to a RAM 4234′ of the storage device 4200 with respect to an access request from the host upper layer HL1. For example, the RAM driver 4103′ may be a control module for controlling the RAM 4234′ of the storage device 4200 at an operating system (4102′) level. The RAM driver 4103′ may be called if the application program 4101′ or the operating system 4102′ requests an access to the RAM 4234′. In addition, the DIMM layer driver 4104′ may be called together with the RAM driver 4103′ to support access to the RAM 4234′ at an actual physical layer level.

The nonvolatile memory layer 4200′ may include a memory upper layer ML1 and a memory lower layer ML2. The memory upper layer ML1 may control access to the nonvolatile memory 4280′ according to an upper command CMD_R or an upper address ADDR_R written at the RAM 4234′. The memory upper layer ML1 may perform an access to the nonvolatile memory 4280′ by the controller layer 4240′ and a memory management operation. For example, a control about the nonvolatile memory 4280′ such as garbage collection, wear leveling, stream control, and the like may be performed by the controller layer 4240′. In some embodiments, interfacing between the RAM 4234′ and the host 4100 may be performed on the memory lower layer ML2. That is, the memory lower layer ML2 may perform an operation for writing or reading data at or from the RAM 4234′ using a RAM command CMD_R or a RAM address ADDR_R provided through the RAM controller 4232. The memory lower layer ML2 may access the RAM 4234′ based on a request of the memory upper layer ML1.

Firmware or software with the above-described layer structure (hierarchy) may allow the host to access the nonvolatile memory 4280. That is, an access to the nonvolatile memory 4280 included in the storage device 4200 of a DIMM form may be performed by decoding a command CMD_R and an address ADDR_R provided through the RAM 4234.

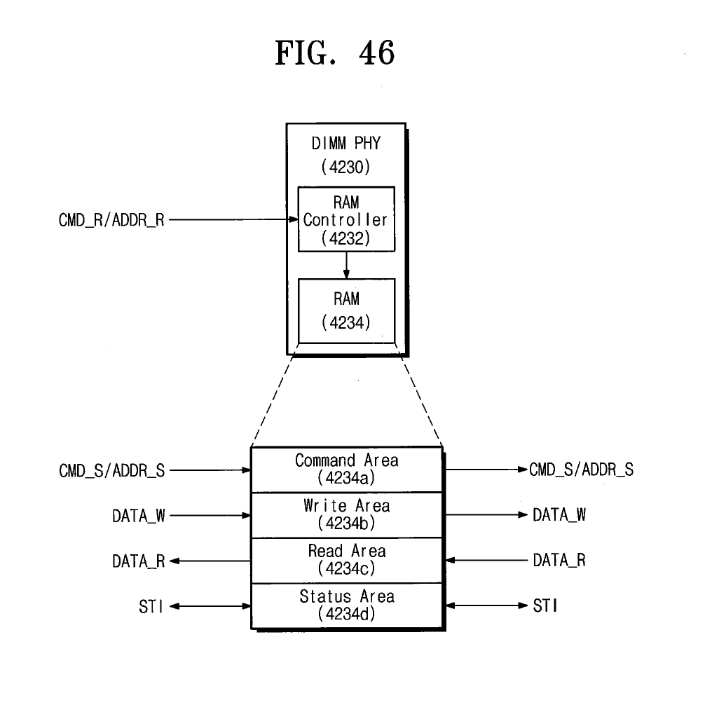

FIG. 46 is a block diagram illustrating a structure of the RAM illustrated in FIG. 44. Referring to FIG. 46, the RAM 4234 may include a command area 4234a, a write area 4234b, a read area 4234c, and a status area 4234d. Data received from the host 4100 or the DIMM controller 4240 may be stored in one of the command area 4234a, the write area 4234b, the read area 4234c, and the status area 4234d, based on a RAM command CMD_R, a RAM address ADDR_R, and a clock CK received from the host 4100. For example, the RAM 4234 may be a dual port SRAM which is simultaneously accessed by a host 4100 and the DIMM controller 4240.

The command area 4234a may store a storage command CMD_S and a storage address ADDR_S provided from the host 4100 under control of the RAM controller 4232. The DIMM controller 4240 may read the storage command CMD_S and the storage address ADDR_S stored in the command area 4234a.

The write area 4234b may store received write data DATA_W under control of the RAM controller 4232. The DIMM controller 4240 may read write data DATA_W stored in the write area 4234b of the RAM 4234.

The read area 4234c may store received read data DATA_R under control of the RAM controller 4232. The DIMM controller 4240 may read the read data DATA_R stored in the read area 4234c of the RAM 4234.

The status area 4234d may store status information STI associated with whether the storage command CMD_S is completely processed. The status information STI stored in the status area 4234d may be transmitted to the host 4100 or to the DIMM controller 4240. For example, the host 4100 may provide next write data to the write area 4234b with reference to the status information STI. Alternatively, the DIMM controller 4240 may provide next read data to the read area 4234c with reference to the status information STI. The status information STI may also include information associated with data in which an error is not corrected. In some embodiments, the host 4100 may retransmit the data, of which the error is not corrected, to the device controller 4210 with reference to the status information STI.

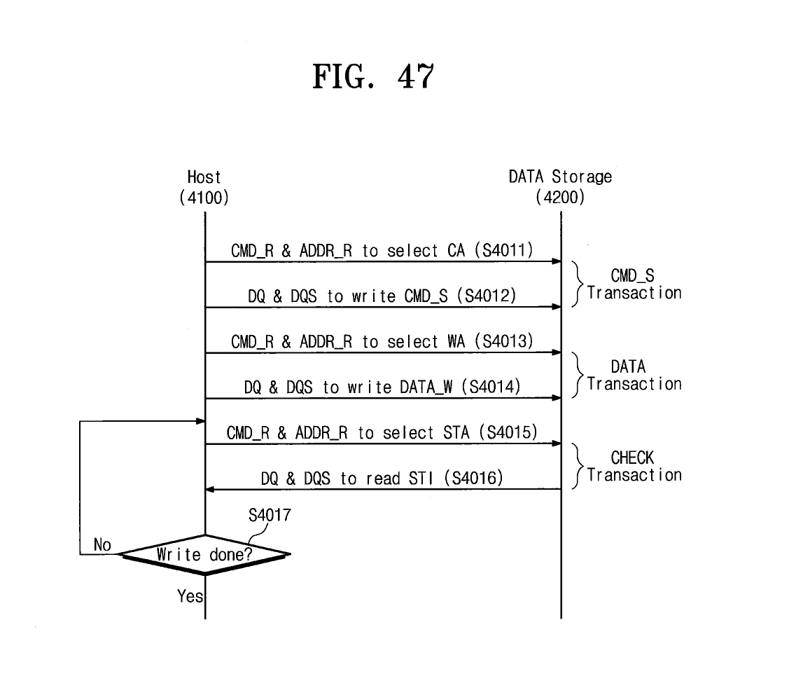

FIG. 47 is a flow chart illustrating an embodiment of a write operation of the data storage 4200 illustrated in FIG. 44.

In step S4011, the processor 4100 may provide the data storage 4200 with a RAM address ADDR_R and a RAM command CMD_R for selecting the command area 4234a of the RAM 4234.

In step S4012, the host 4100 may provide the data storage 4200 with a data signal DQ and a data strobe signal DQS for writing a storage command CMD_S at the selected command area 4234a. For example, the data signal DQ and the data strobe signal DQS of step S4012 may include the storage command CMD_S for a write operation. For example, steps S4011 and S4012 may be a transaction about the storage command CMD_S.

In step S4013, the host 4100 may provide the data storage 4200 with a RAM address ADDR_R and a RAM command CMD_R for selecting the write area 4234b of the RAM 4234.

In step S4014, the host 4100 may provide the data storage 4200 with a data signal DQ and a data strobe signal DQS for storing write data DATA_W at the selected write area 4234b. For example, the data signal DQ and the data strobe signal DQS of step S4014 may include the write data DATA_W. For example, steps S4013 and S4014 may be a transaction about the write data DATA_W.

In step S4015, the host 4100 may provide the data storage 4200 with a RAM address ADDR_R and a RAM command CMD_R for selecting the status area 4234d of the RAM 4234.

For example, the host 4100 may receive the status information STI, which is written in the status area 4234d, through the data signal DQ and the data strobe signal DQS. In some embodiments, the data signal DQ and the data strobe signal DQS of step S4016 may include the status information STI and may be signals provided to the host 4100 from the RAM 4234.

In step S4017, the host 4100 may determine whether the write operation is completed, based on the read status information STI. For example, in the case where processing of the write data DATA_W stored in the write area 4234b of the RAM 4234 is completed, the DIMM controller 4240 of the data storage 4200 may write the status information STI, indicating the completion of the write operation, at the status area 4234d of the RAM 4234. In this case, in step S4016, the status information STI indicating the completion of the write operation may be provided to the host 4100. The host 4100 may determine whether the write operation is completed, based on the received status information STI.

In the case where the received status information STI indicates that the write operation is not completed, the host 4100 may iteratively perform steps S4015 and S4017. In the case where the received status information STI indicates that the write operation is completed, the write operation of the user system 4010 may be ended. In some embodiments, operations of steps S4015 to S4017 may be a transaction for checking the completion of the write operation.

If the write operation is not completed, the DIMM controller 4240 of the data storage 4200 may not write the status information STI at the RAM 4234. In this case, in step S4016, the status information STI may not be transferred to the host 4100, or any other status information may be transferred. If not receiving the status information STI or receiving any other status information, the host 4100 may determine the write operation has not been completed and may iteratively perform steps S4015 to S4017.

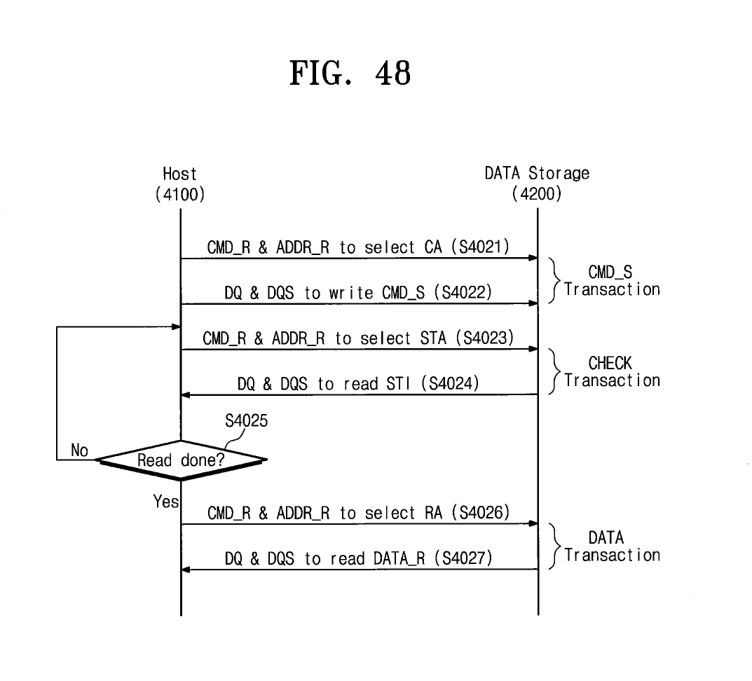

FIG. 48 is a flow chart illustrating an embodiment of a read operation of the data storage 4200 illustrated in FIG. 44.

In step S4021, the host 4100 may provide the data storage 4200 with a RAM address ADDR_R and a RAM command CMD_R for selecting the command area 4234a of the RAM 4234.

In step S4022, the host 4100 may provide the data storage 4200 with a data signal DQ and a data strobe signal DQS for writing a storage command CMD_S at the selected command area 4234a. For example, the data signal DQ and the data strobe signal DQS of step S4022 may include the storage command CMD_S for a read operation. For example, operations of steps S4021 and S4022 may be a transaction about the storage command CMD_S.

In step S4023, the host 4100 may provide the data storage 4200 with a RAM address ADDR_R and a RAM command CMD_R for selecting the status area 4234d.

For example, the host 4100 may read the status information STI, which is written in the status area 4234d, through the data signal DQ and the data strobe signal DQS. In some embodiments, the data signal DQ and the data strobe signal DQS of step S4024 may include the status information STI and may be signals provided to the host 4100 from the RAM 4234.

In step S4025, the host 4100 may determine whether the read operation is completed, based on the read status information STI. In the case where the read operation is not completed, the host 4100 may iteratively perform operations of steps S4023 to S4024 periodically. In some embodiments, operations of steps S4023 to S4025 may be a transaction for checking the completion of the read operation.

If the read operation about the data storage 4200 is not completed, the DIMM controller 4240 of the data storage 4200 may not write the status information STI, indicating the completion of the read operation, at the RAM 4234. In this case, in step S4024, the status information STI may not be transferred to the host 4100. In the case where the status information STI is not transferred, the host 4100 may iteratively perform steps S4023 to S4025.

In step S4026, if the status information STI indicates that the read operation is completed, the host 4100 may provide the data storage 4200 with a RAM address ADDR_R and a RAM command CMD_R for selecting the read area 4234c of the RAM 4234.

In step S4027, the host 4100 may read the read data DATA_R, which is stored in the read area 4234c, through the data signal DQ and the data strobe signal DQS. For example, the data signal DQ and the data strobe signal DQS of step S4027 may include the read data DATA_R and may be signals provided to the host 4100 from the RAM 4234.

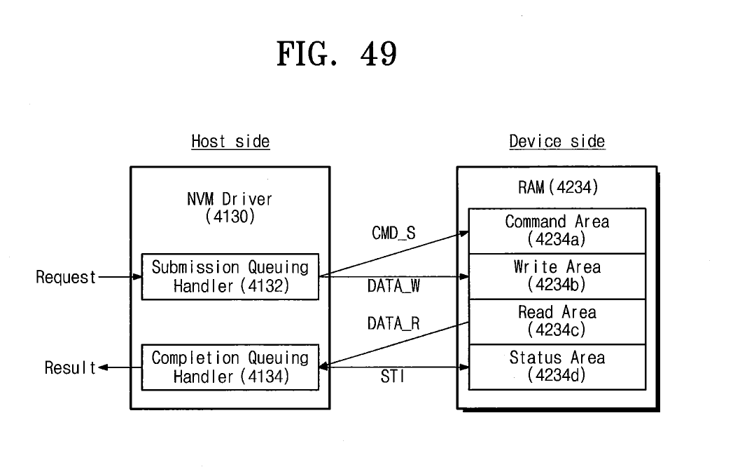

FIG. 49 is a block diagram illustrating communications between a host 4100 and data storage 4200. Referring to FIG. 49, data exchange between the host 4100 and the data storage 4200 may be performed in a queuing manner.

A NVM driver 4130 of the host 4100 may include a submission queuing hander 4132 and a completion queuing handler 4134. As an access to the data storage 4200 is requested by the host 4100, the submission queuing hander 4132 may transfer a command CMD_S, which is needed to control a nonvolatile memory 4280 of the data storage 4200, to the command area 4234a.

In the case where the access request is a write operation, the submission queuing hander 4132 may transmit write data to the write area 4234b and a storage command CMD_S associated with the write operation to the command area 4234a, respectively. In the case where the access request is a read operation, the submission queuing hander 4132 may transmit a storage command CMD_S associated with the read operation to the command area 4234a.

The completion queuing handler 4134 may fetch status information, indicating whether processing of the storage command CMD_S is completed, from the status area 4234d and may fetch read data according to the read request from the read area 4234c. The completion queuing handler 4134 may output the read status information or read data to an upper layer as a resultant value.

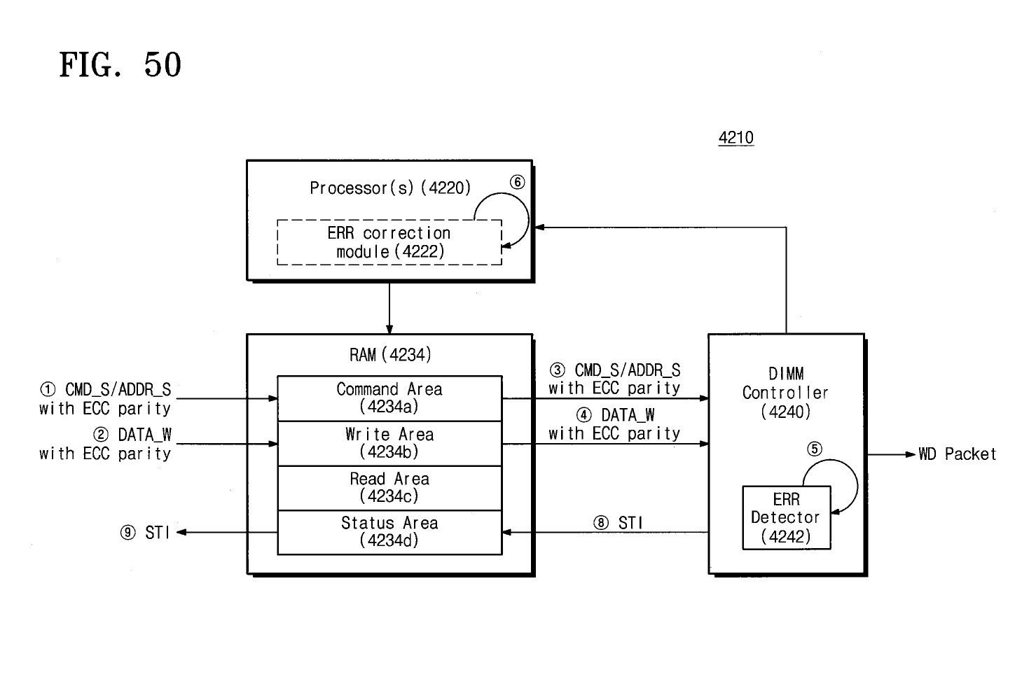

FIG. 50 is a block diagram illustrating the procedure for detecting and correcting an error, according to embodiments of the inventive concept. An embodiment of the device controller 4210 illustrated in FIG. 44 is exemplified in FIG. 50.

First or all, a storage command CMD_S and a storage address ADDR_S for controlling write data to be stored in the nonvolatile memory 4280 may be received from the host 4100 (\textcircled{1}). At this time, the storage command CMD_S and the storage address ADDR_S may be encoded at the host 4100. That is, data to which an ECC parity is added may be may be encoded at the host 4100. The storage command CMD_S and the storage address ADDR_S may be stored in the command area 4234a.

After the storage command CMD_S and the storage address ADDR_S are transferred, write data DATA_W corresponding thereto may be received (\textcircled{2}). The write data DATA_W may be encoded at the host 4100. That is, the write data DATA_W may be data to which an ECC parity is added. The write data DATA_W may be stored in the write area 4234b.

The DIMM controller 4240 may access the RAM 4234 and may read the storage command CMD_S and the storage address ADDR_S (\textcircled{3}). The DIMM controller 4240 may access the RAM 4234 to read write data DATA_W (\textcircled{4}).

The error detector 4242 may detect whether an error arises from the storage command CMD_S, the storage address ADDR_S, and the write data DATA_W read from the RAM 4234 (\textcircled{5}). In some embodiments, the error detector 4242 may be an intellectual property (IP) implemented with hardware. An error may be detected using an ECC parity added when data is encoded by the host 4100.

If an error is detected from data read from the RAM 4234, the processor 4220 may drive an error correction module 4222 to correct the detected error (\textcircled{6}). The error correction module 4222 may be implemented in the form of firmware and may be stored in the ROM 4260 or the nonvolatile memory 4280 of the device controller 4210.

If the error is corrected, the error-corrected data CMD_S, ADDR_S, DATA_W, and the like may be provided to the nonvolatile memory 4280 in the form of packet data WD packet. In contrast, if the error is not corrected even by the error correction module 4222, the DIMM controller 4240 may update the status information STI. In this case, the status information STI may indicate that data received from the host is erroneous.

Afterwards, the host 4100 may transmit data (e.g., at least one of CMD_S, ADDR_S, and DATA_W) to the RAM 4234 with reference to the status information STI stored in the status information 4234d.

An embodiment of the inventive concept is exemplified as a detection operation of the error detector 4242 is executed after the storage command CMD_S, the storage address ADDR_S, and the write data DATA_W are provided to the DIMM controller 4240. However, the scope and spirit of the inventive concept may not be limited thereto. For example, if the DIMM controller 4240 accesses the RAM 4234 to read data, it may immediately detect whether the read data is erroneous.

The device controller 4210 may detect an error of data received from the host 4100 using hardware and may correct the detected error using software. Thus, a chip size of a semiconductor device including the device controller 4210 may be reduced.

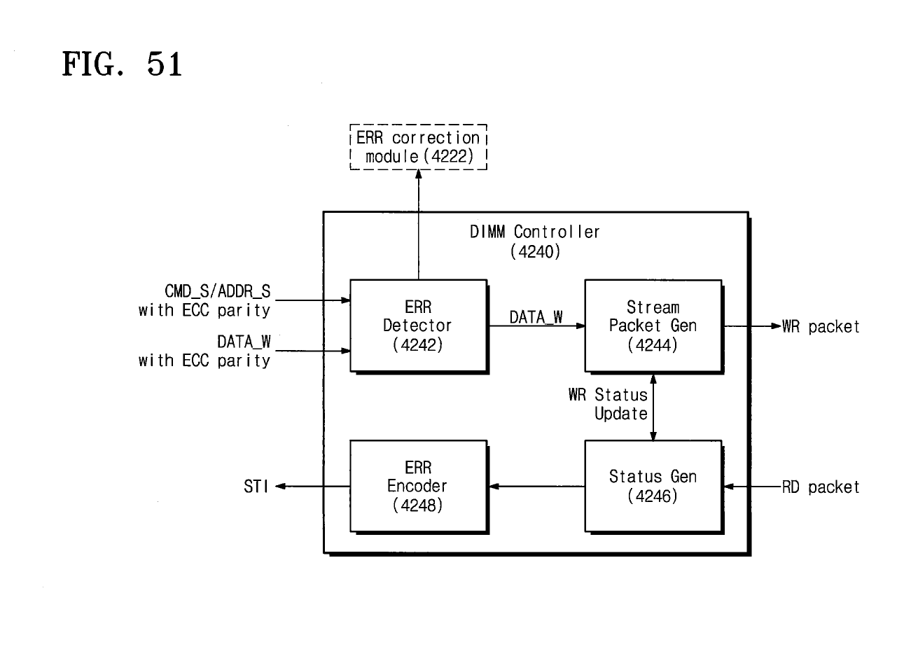

FIG. 51 is a block diagram illustrating an embodiment of the DIMM controller 4240 illustrated in FIG. 50. Referring to FIG. 51, the DIMM controller 4240 may include an error detector 4242, a stream packet generator 4244, a status information generator 4246, and an ECC encoder 4248.

The error detector 4242 may check whether data read from the RAM 4234 is erroneous. For example, the error detector 4242 may check whether data read from the RAM 4234 is erroneous, using an ECC parity added when data is encoded by the host 4100. If the error is detected, the processor 4220 (refer to FIG. 50) may drive the error correction module 4222. The processor 4220 may correct the detected error using the error correction module 4222.

If the detected error is corrected by the error correction module 4222, the stream packet generator 4244 may process write data DATA_W in the form of a stream packet. The processed packet data WR packet may be programmed in the nonvolatile memory 4280.

In contrast, if the error is not corrected even by the error correction module 4222, the status information generator 4246 may update the status information STI. At this time, the updated status information STI may include information associated with data (e.g., CMD_S, DATA_W, and the like) from which an error is detected. The status information generator 4246 may output the status information STI to the ECC encoder 4248.

The ECC encoder 4248 may encode the status information STI provided from the status information generator 4246. For example, the status information generator 4246 may add a parity bit to the status information STI. The ECC encoder 4248 may transfer the status information STI to the status area 4234d of the RAM 4234. Afterwards, the host 4100 may retransmit data, from which an error is detected, to the data storage 4200 with reference to the status information STI stored in the status information 4234d.

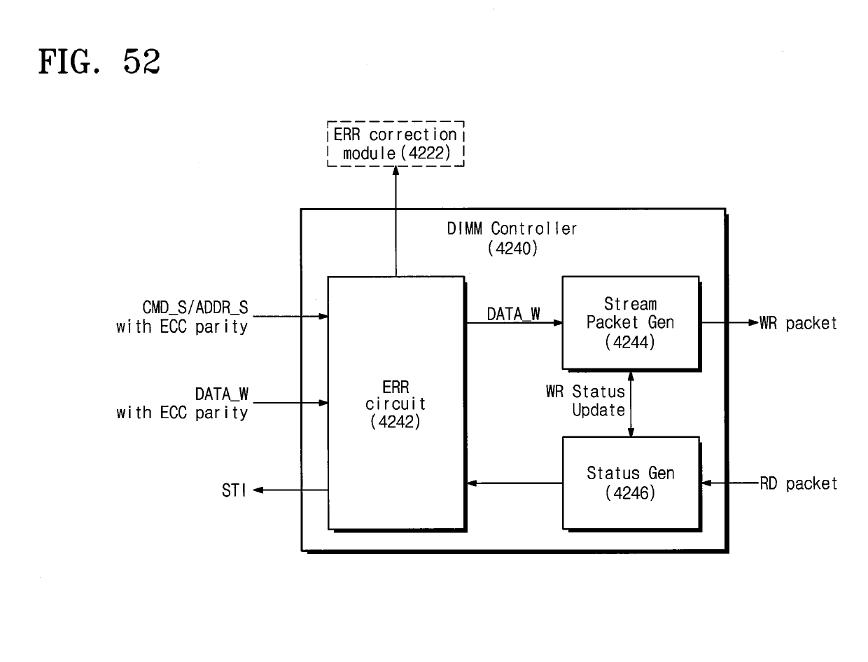

In some embodiments, a function to detect an error of data received from the RAM 4234 and a function to encode data to be transmitted to the RAM 4234 may be performed by one IP. This will be described in detail with reference to FIG. 52.

FIG. 52 is a block diagram illustrating an embodiment of the DIMM controller 4240 illustrated in FIG. 50, according to embodiments of the inventive concept. Referring to FIG. 52, the DIMM controller 4240 may include an ECC circuit 4242, the stream packet generator 4244, and the status information generator 4246.

The ECC circuit 4242 may check whether data read from the RAM 4234 is detected. For example, the ECC circuit 4242 may check whether data read from the RAM 4234 is erroneous, using an ECC parity added when data is encoded by the host 4100. If the error is detected, the processor 4220 may drive the error correction module 4222. The processor 4220 may correct the detected error using the error correction module 4222.

If the detected error is corrected by the error correction module 4222, the stream packet generator 4244 may process write data DATA_W in the form of a stream packet. The processed packet data WR packet may be programmed in the nonvolatile memory 4280.

In contrast, if the error is not corrected even by the error correction module 4222, the status information generator 4246 may update the status information STI. At this time, the updated status information STI may include information associated with data (e.g., CMD_S, DATA_W, and the like) from which an error is detected. The status information generator 4246 may output the status information STI to the ECC circuit 4242.

The ECC circuit 4242 may encode the status information STI provided from the status information generator 4246. For example, the status information generator 4246 may add a parity bit to the status information STI. The ECC circuit 4242 may transfer the status information STI to the status area 4234d of the RAM 4234. Afterwards, the host 4100 may retransmit data, from which an error is detected, to the data storage 4200 with reference to the status information STI stored in the status information 4234d.

According to embodiments of the inventive concept, the DIMM controller 4240 may detect an error of data received from the host 4100 using hardware and may correct the detected error using software. The DIMM controller 4240 may drive firmware to correct the detected error. Thus, a chip size of a semiconductor device including the DIMM controller 4240 may be reduced. In addition, in the case where the detected error is not corrected, the host 4100 may retransmit data as status information is sent to the host 4100.

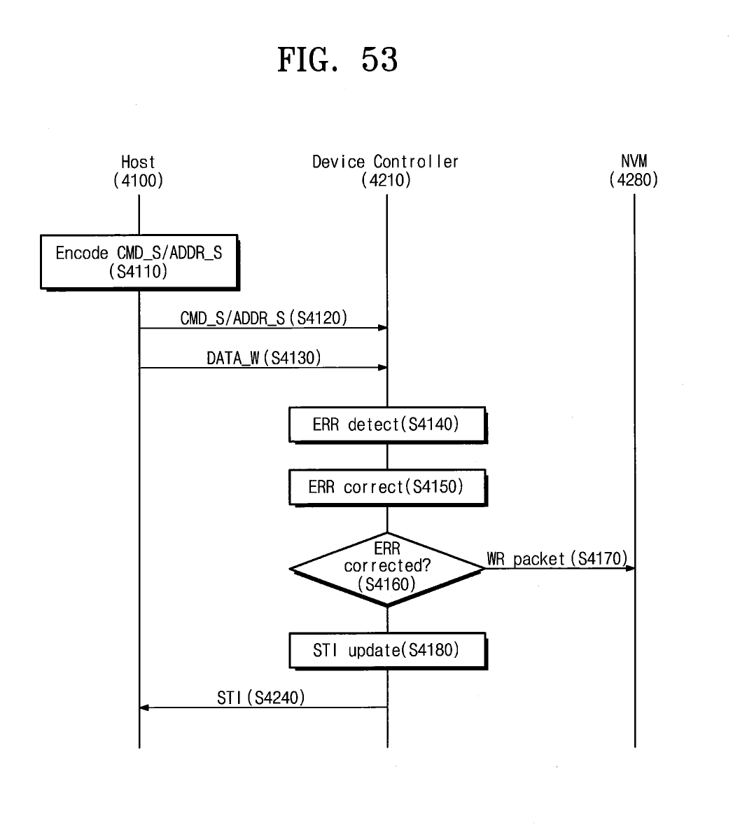

FIG. 53 is a flow chart illustrating a method for detecting and correcting an error of data received from a host on a storage system according to embodiments of the inventive concept.

In step S4110, the host 4100 may encode a storage command CMD_S, a storage address ADDR_S, and write data DATA_W. For example, the host 4100 may add an ECC parity to data (e.g., a storage command, read data, write data, and the like) transmitted to the data storage 4200. The ECC parity may be used to detect and correct an error included in data transmitted to the data storage 4200.

In step S4120, the device controller 4210 may receive the storage command CMD_S and the storage address ADDR_S from the host 4100. For example, the storage command CMD_S and the storage address ADDR_S thus received may be stored in the command area 4234a of the RAM 4234 included in the physical layer 4230 (refer to FIG. 46).

In step S4130, the device controller 4210 may receive write data DATA_W corresponding to the storage command CMD_S and the storage address ADDR_S. For example, the write data DATA_W may be stored in the write area 4234b of the RAM 4234 included in the physical layer 4230 of the device controller 4210.

In step S4140, there may be determined whether an error is detected from data received from the host 4100. For example, the DIMM controller 4240 (refer to FIG. 50) included in the device controller 4210 may read data stored in the command area 4234a or the read area 4234b and may determine whether an error is detected from the read data. In some embodiments, an error may be detected by hardware included in the DIMM controller 4240: the error detector 4242 of FIG. 51 or the ECC circuit 4242 of FIG. 52.

In step S4150, the detected error may be corrected. The error may be corrected by driving separate error correction firmware at the processor 4220. For example, firmware for error correction may be stored in the ROM 4260 of FIG. 44 and/or the nonvolatile memory 4280 included in the device controller 4210 and may be loaded and driven on the processor 4220.

In step S4160, there may be determined whether the error is detected. If the error is corrected by the error correction firmware (Yes), write data may be sent to the nonvolatile memory in the form of a stream packet WR packet. Otherwise (NO), the procedure may proceed to step S4180.

In step S4180, the status information STI may be updated. The updated status information STI may be stored in the status area 4234d of the RAM 4234. The updated status information STI may include information associated with data from which the error is detected. For example, the status information STI may include information associated with a position (i.e., a logical address) of the write data DATA_W where an error is detected.

In step S4190, the status information STI may be provided to the host 4100. For example, the host 4100 may fetch the status information STI through periodic polling or an interrupt manner Afterwards, the host 4100 may retransmit data, from which an error is detected, to the device controller 4210.

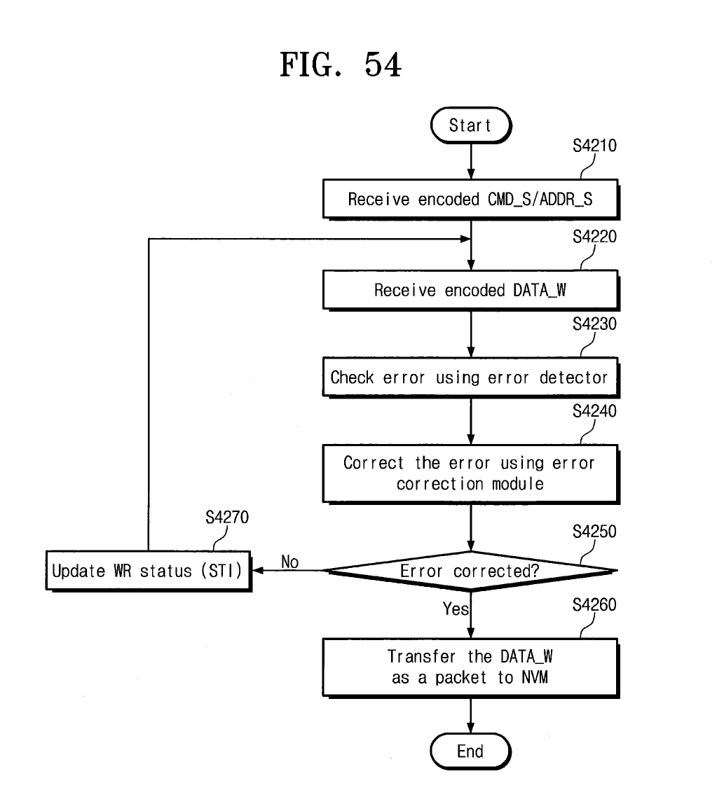

FIG. 54 is a flow chart illustrating an operating method of a device controller 4210 according to embodiments of the inventive concept.

In step S4210, there may be received an encoded storage command CMD_S and an encoded storage address ADDR_S from the host 4100. For example, the encoded data may include an ECC parity. For example, the storage command CMD_S and the storage address ADDR_S thus received may be stored in the command area 4234a of the RAM 4234 included in the physical layer 4230.

In step S4220, there may be received encoded write data DATA_W corresponding to the storage command CMD_S and the storage address ADDR_S. The write data DATA_W may be stored in the write area 4234b of the RAM 4234.

In step S4230, an error of data received from the host 4100 may be checked. An error may be detected using an ECC parity added when data is encoded by the host 4100. This may be accomplished by the error detector 4242 included in the DIMM controller 4240.

In step S4240, the detected error may be corrected. This may be accomplished by driving separate error correction firmware at the processor 4220. For example, firmware for error correction may be stored in the ROM 4260 and/or the nonvolatile memory 4280 included in the device controller 4210 and may be loaded and driven on the processor 4220.

In step S4250, there may be determined whether the error is corrected. An operation branch may occur according to the determination result. If the error is corrected (Yes), the procedure may proceed to step S4260. Otherwise (NO), the procedure may proceed to step S4270.

In step S4260, write data may be transferred to the nonvolatile memory 4280 in the form of a stream packet. Afterwards, the stream packet may be programmed in the nonvolatile memory 4280.

In step S4270, the status information STI may be updated. The updated status information STI may include information associated with data from which the error is detected. The status information STI may be stored in the status area 4234d of the RAM 4234. Afterwards, the host 4100 may retransmit data (e.g., CMD_S, ADDR_S, DATA_W, and the like), from which an error is detected, to the device controller 4210.

An embodiment of the inventive concept is exemplified as the storage command CMD_S and the storage address ADDR_S are first received (S4210), the write data DATA_W is next received (S4220), and an error is then checked (S4230). However, an error detecting operation may be first performed with respect to the storage command CMD_S and the storage address ADDR_S in the case where the DIMM controller 4240 (refer to FIG. 50) receives the storage command CMD_S and the storage address ADDR_S stored in the read area 4234a before reading write data stored in the write area 4234b.

An embodiment of the inventive concept is exemplified as step S4210 is executed after step S4270. However, step S4220 may be executed after execution of step S4270 if the status data STI indicates that the write data DATA_W is error-free or that an error is detected from only the storage command CMD_S and/or the storage address ADDR_S.

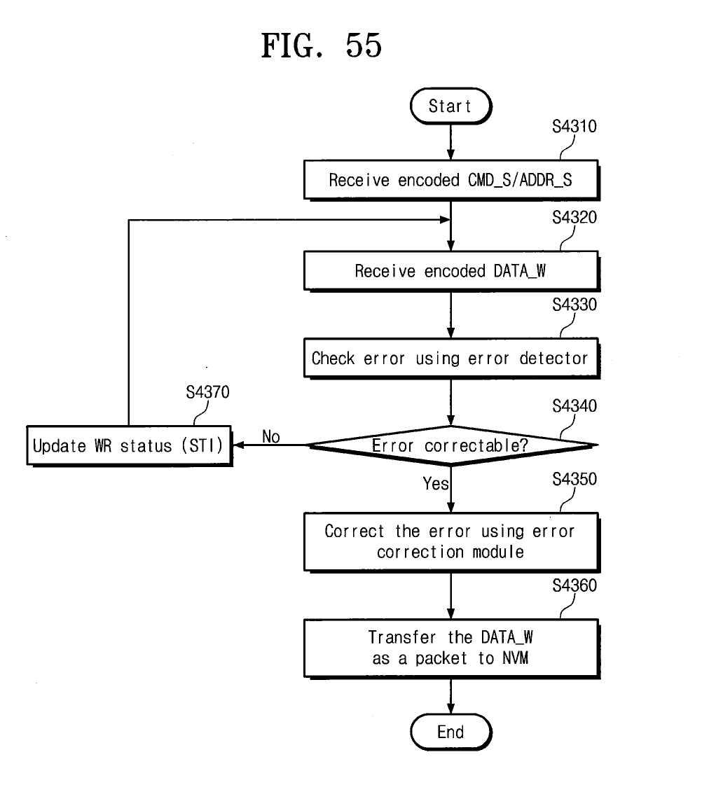

FIG. 55 is a flow chart illustrating an operating method of a device controller 4210 according to embodiments of the inventive concept. An operating method of FIG. 55 may be similar that of FIG. 54, and a duplicated description is thus omitted.

In step S4310, there may be received an encoded storage command CMD_S and an encoded storage address ADDR_S.

In step S4320, encoded write data DATA_W may be received.

In step S4330, an error of the received data may be checked. This may be accomplished by the error detector 4242 included in the DIMM controller 4240.

In step S4340, there may be determined whether the detected error is correctable. To determine whether an error is correctable using an ECC parity may be well known, and a detailed description thereof is thus omitted. An operation branch may occur according to the determination result. If the error is corrected (Yes), the procedure may proceed to step S4350. Otherwise (No), the procedure may proceed to step S4370.

In step S4350, the detected error may be corrected. This may be accomplished by driving separate error correction firmware at the processor 4220.

In step S4360, write data may be transferred to the nonvolatile memory 4280 in the form of a stream packet. Afterwards, the stream packet may be programmed in the nonvolatile memory 4280.

In step S4370, the status information STI may be updated. The updated status information STI may include information associated with data from which the error is detected. The status information STI may be stored in the status area 4234d of the RAM 4234. Afterwards, the host 4100 may retransmit data (e.g., CMD_S, ADDR_S, DATA_W, and the like), from which an error is detected, to the device controller 4210.

An embodiment of the inventive concept is exemplified as the storage command CMD_S and the storage address ADDR_S are first received (S4310), the read data DATA_R is next received (S4320), and an error is then checked (S4330). However, an error detecting operation may be first performed with respect to the storage command CMD_S and the storage address ADDR_S in the case where the DIMM controller 4240 (refer to FIG. 50) receives the storage command CMD_S and the storage address ADDR_S stored in the read area 4234a before reading write data stored in the write area 4234b.

An embodiment of the inventive concept is exemplified as step S4310 is executed after step S4370. However, step S4320 may be executed after execution of step S4370 if the status data STI indicates that the write data DATA_W is error-free or that an error is detected from only the storage command CMD_S and/or the storage address ADDR_S.

According to embodiments of the inventive concept, the DIMM controller 4240 may detect an error of data received from the host 4100 using hardware. The DIMM controller 4240 may drive firmware to correct the detected error. Thus, a chip size of a semiconductor device including the DIMM controller 4240 may be reduced. In addition, in the case where the detected error is not corrected, the host 4100 may retransmit data as status information is sent to the host 4100. That is, error information may be managed, and the managed error information may be transferred to the host 4100. In this case, it may be possible improve reliability to receive data from the host 4100.

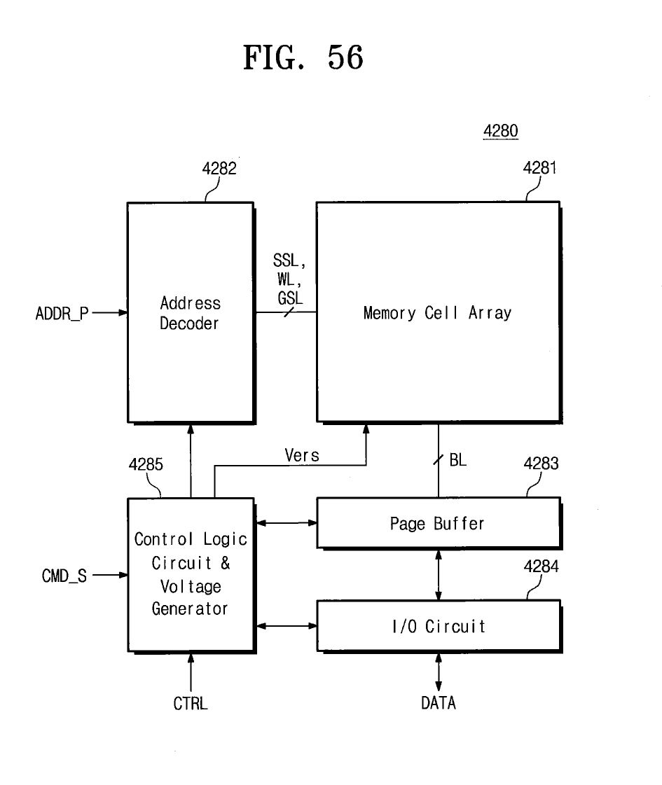

FIG. 56 is a block diagram illustrating an embodiment of the nonvolatile memories 4280 described in FIG. 44. Referring to FIG. 56, the nonvolatile memory 4280 may include a memory cell array 4281, an address decoder 4282, a page buffer 4283, an input/output circuit 4284, and a control logic and voltage generator circuit 4285.

The memory cell array 4281 may include a plurality of memory cells. Each of the memory blocks may include a plurality of cell strings. Each of the cell strings may include a plurality of memory cells. The memory cells may be connected with a plurality of word lines WL. Each memory cell may be a single level cell (SLC) storing one bit or a multi-level cell (MLC) storing at least two bits.

The address decoder 4282 may be connected with the memory cell array 4281 through the word lines WL, string selection lines SSL, and ground selection lines GSL The address decoder 4282 may receive and decode a physical address ADDR_P from an external device and may drive the word lines WL based on the decoding result. For example, the address decoder 4282 may decode a physical address ADDR_P received from the external device, may select at least one of the word lines WL based on the decoded physical address ADDR_P, and may drive the selected word line WL. In some embodiments, the physical address ADDR_P may be a physical address of the nonvolatile memory 4280 which is obtained by converting a storage address ADDR_S. The above-described address conversion operation may be performed by the device controller 4210 or by a flash translation layer (FTL) which is driven by the device controller 4210.

The page buffer 4283 may be connected to the memory cell array 4281 through the bit lines BL. Under control of the control logic and voltage generator circuit 4285, the page buffer 4283 may control the bit lines BL such that data provided from the input/output circuit 4284 is stored in the memory cell array 4281. Under control of the control logic and voltage generator circuit 4285, the page buffer 4283 may read data stored in the memory cell array 4281 and may provide the read data to the input/output circuit 4284. For example, the page buffer 4283 may be provided with data from the input/output circuit 4284 by the page or may read data from the memory cell array 4281 by the page.

The input/output circuit 4284 may receive data from the external device and may transfer the received data to the page buffer 4283. In some embodiments, the input/output circuit 4284 may receive data from the page buffer 4283 and may transmit the received data to the external device (e.g., the DIMM controller 4240). For example, the input/output circuit 4284 may exchange data with the external device in synchronization with the control signal CTRL.

The control logic and voltage generator circuit 4285 may control the address decoder 4282, the page buffer 4283, and the input/output circuit 4284 in response to a storage command CMD_S and a control logic CTRL from the external device. For example, the control logic and voltage generator circuit 4285 may control other components in response to the signals CMD_S and CTRL such that data is stored in the memory cell array 4281. In some embodiments, the control logic and voltage generator circuit 4285 may control other components in response to the signals CMD_S and CTRL such that data stored in the memory cell array 4281 is transmitted to the external device. In some embodiments, the storage command CMD_S received from the external device may be a modified version of the storage command CMD_S of FIG. 44. The control signal CTRL may be a signal which the device controller 4210 provides to control the nonvolatile memory 4280.

The control logic and voltage generator circuit 4285 may generate various voltages required for the nonvolatile memory 4280 to operate. For example, the control logic and voltage generator circuit 4285 may generate a plurality of program voltages, a plurality of pass voltages, a plurality of verification voltages, a plurality of selection read voltages, a plurality of non-selection read voltages, a plurality of erase voltages, and the like. The control logic and voltage generator circuit 4285 may provide the generated voltages to the address decoder 4282 or to a substrate of the memory cell array 4281.

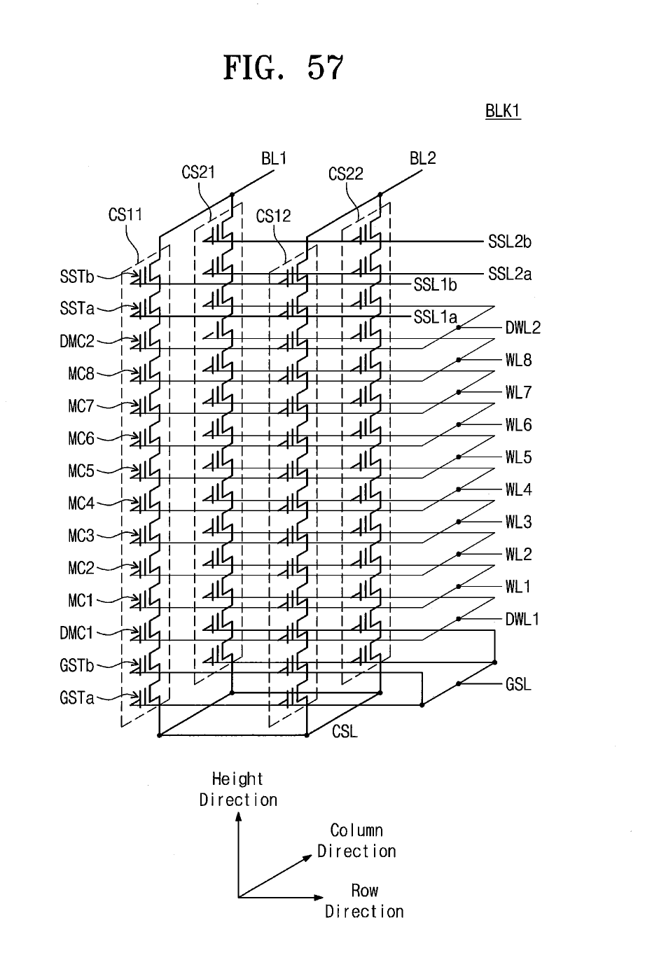

FIG. 57 is a circuit diagram illustrating an embodiment of the memory blocks included in the memory cell array in FIG. 56. In some embodiments, a memory block BLK1 having a 3-dimensional structure will be described with reference to FIG. 57. Other memory blocks respectively included in the nonvolatile memories 4280 may have, but are not limited to, a structure which is similar to the memory block BLK1.

Referring to FIG. 57, the memory block BLK1 may include a plurality of cell strings CS11, CS12, CS21, and CS22. The cell strings CS11, CS12, CS21, and CS22 may be arranged along a row direction and a column direction and may form rows and columns.

For example, the cell strings CS11 and CS12 may be connected to string selection lines SSL1a and SSL1b to constitute a first row. The cell strings CS21 and CS22 may be connected to string selection lines SSL2a and SSL2b to constitute a second row.

For example, the cell strings CS11 and CS21 may be connected to a first bit line BL1 to constitute a first column. The cell strings CS12 and CS22 may be connected to a second bit line BL2 to constitute a second column.

Each of the cell strings CS11, CS12, CS21, and CS22 may include a plurality of cell transistors. Each of the cell strings CS11, CS12, CS21, and CS22 may include string selection transistor SSTa and SSTb, a plurality of memory cells MC1 to MC8, ground selection transistors GSTa and GSTb, and dummy memory cells DMC1 and DMC2. In some embodiments, the memory cells included in the cell strings CS11, CS12, CS21, and CS22 may be a charge trap flash (CTF) memory cell.

The memory cells MC1 to MC8 may be serially connected and may be stacked a height direction being a direction perpendicular to a plane defined by a row direction and a column direction. The string selection transistors SSTa and SSTb may be serially connected and may be disposed between the memory cells MC1 to MC8 and a bit line BL. The ground selection transistors GSTa and GSTb may be serially connected and may be disposed between the memory cells MC1 to MC8 and a common source line CSL.

In some embodiments, a first dummy memory cell DMC1 may be disposed between the memory cells MC1 to MC8 and the ground selection transistors GSTa and GSTb. In some embodiments, a second dummy memory cell DMC2 may be disposed between the memory cells MC1 to MC8 and the string selection transistors SSTa and SSTb.

The ground selection transistors GSTa and GSTb of the cell strings CS11, CS12, CS21, and CS22 may be connected in common to a ground selection line GSL. In some embodiments, ground selection transistors in the same row may be connected to the same ground selection line, and ground selection transistors in different rows may be connected to different ground selection lines. For example, the first ground selection transistors GSTa of the cell strings CS11 and CS12 in the first row may be connected to the first ground selection line, and the first ground selection transistors GSTa of the cell strings CS21 and CS22 in the second row may be connected to the second ground selection line.

In some embodiments, although not shown, ground selection transistors at the same height from a substrate (not shown) may be connected to the same ground selection line, and ground selection transistors at different heights therefrom may be connected to different ground selection lines. For example, the first ground selection transistors GSTa of the cell strings CS11, CS12, CS21, and CS22 may be connected to the first ground selection line, and the second ground selection transistors GSTb thereof may be connected to the second ground selection line.

Memory cells placed at the same height from the substrate (or the ground selection transistors GSTa and GSTb) may be connected in common to the same word line, and memory cells placed at different heights therefrom may be connected to different word lines. For example, memory cells MC1 to MC8 of the cell strings CS11, CS12, CS21, and CS22 may be connected in common to first to eighth word lines WL1 to WL8.

String selection transistors, belonging to the same row, from among the first string selection transistors SSTa placed at the same height may be connected to the same string selection line, and string selection transistors belonging to different rows may be connected to different string selection lines. For example, the first string selection transistors SSTa of the cell strings CS11 and CS12 in the first row may be connected in common to the string selection line SSL1a, and the first string selection transistors SSTa of the cell strings CS21 and CS22 in the second row may be connected in common to the string selection line SSL2a.

Likewise, string selection transistors, belonging to the same row, from among the second string selection transistors SSTb at the same height may be connected to the same string selection line, and string selection transistors in different rows may be connected to different string selection lines. For example, the second string selection transistors SSTb of the cell strings CS11 and CS12 in the first row may be connected in common to a string selection line SSL1b, and the second string selection transistors SSTb of the cell strings CS21 and CS22 in the second row may be connected in common to a string selection line SSL2b.

Although not shown, string selection transistors of cell strings in the same row may be connected in common to the same string selection line. For example, the first and second string selection transistors SSTa and SSTb of the cell strings CS11 and CS12 in the first row may be connected in common to the same string selection line. The first and second string selection transistors SSTa and SSTb of the cell strings CS21 and CS22 in the second row may be connected in common to the same string selection line.

In some embodiments, dummy memory cells at the same height may be connected with the same dummy word line, and dummy memory cells at different heights may be connected with different dummy word lines. For example, the first dummy memory cells DMC1 may be connected to a first dummy word line DWL1, and the second dummy memory cells DMC2 may be connected to a second dummy word line DWL2.

In the memory block BLK1, read and write operations may be performed by the row. For example, one row of the memory block BLK1 may be selected by the string selection lines SSL1a, SSL1b, SSL2a, and SSL2b.

The cell strings CS11 and CS12 in the first row may be respectively connected to the bit lines BL1 and BL2 when a turn-on voltage is supplied to the string selection lines SSL1a and SSL1b and a turn-off voltage is supplied to the string selection lines SSL2a and SSL2b. The cell strings CS21 and CS22 in the second row may be respectively connected to the bit lines BL1 and BL2 when the turn-on voltage is supplied to the string selection lines SSL2a and SSL2b and the turn-off voltage is supplied to the string selection lines SSL1a and SSL1b. As a word line is driven, memory cells, placed at the same height, from among memory cells in cell strings connected to the driven word line may be selected. Read and write operations may be performed with respect to the selected memory cells. The selected memory cells may constitute a physical page.

In the memory block BLK1, memory cells may be erased by the memory block or by the sub-block. When erasing is performed by the memory block, all memory cells MC in the memory block BLK1 may be simultaneously erased according to an erase request. When erasing is performed by the sub-block, a portion of memory cells MC in the memory block BLK1 may be simultaneously erased according to an erase request, and the other thereof may be erase-inhibited. A low voltage (e.g., a ground voltage) may be supplied to a word line connected to erased memory cells MC, and a word line connected to erase-inhibited memory cells MC may be floated.

The memory block BLK1 illustrated in FIG. 57 may be an example. For example, the number of cell strings may increase or decrease, and the number of rows of cell strings and the number of columns of cell strings may increase or decrease according to the number of cell strings. In the memory block BLK1, the number of cell strings (GST, MC, DMC, SST, or the like) may increase or decrease, and/or a height of the memory block BLK1 may increase or decrease according to the number of cell strings (GST, MC, DMC, SST, or the like). Furthermore, the number of lines (GSL, WL, DWL, SSL, or the like) connected with cell transistors may increase or decrease according to the number of cell strings (GST, MC, DMC, SST, or the like).

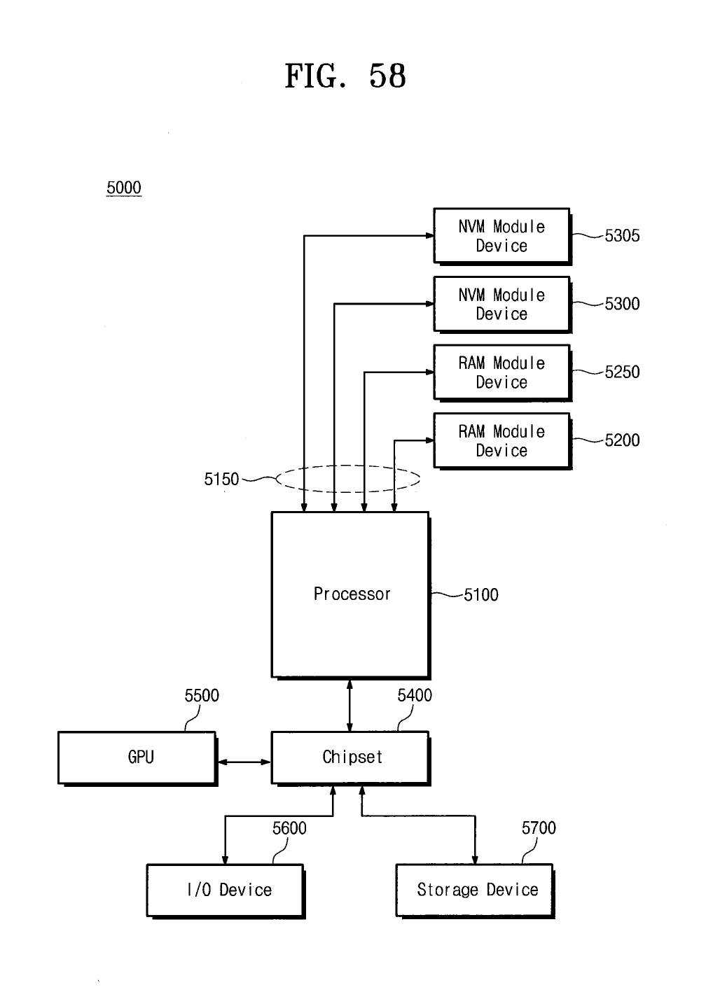

FIG. 58 is a block diagram illustrating a computing system 5000 to which a nonvolatile memory module according to the inventive concept may be applied. Referring to FIG. 58, a computing device 5000 may include a processor 5100, RAM modules 5200 and 5250, nonvolatile memory modules 5300 and 5305, a chipset 5400, a graphic processing unit (GPU) 5500, an input/output device 5600, and a storage device 5700.

The processor 5100 may perform an overall operation of the computing system 5000. The processor 5100 may perform various operations to be executed on the computing system 5000.

The RAM modules 5200 and 5250 and the nonvolatile memory modules 5300 and 5305 may be directly connected with the processor 5100. For example, the RAM modules 5200 and 5250 and the nonvolatile memory modules 5300 and 5305 may have a DIMM form. In some embodiments, the RAM modules 5200 and 5250 and/or the nonvolatile memory modules 5300 and 5305 may be mounted on a DIMM socket connected with the processor 5100 and may communicate with the processor 5100. In some embodiments, the nonvolatile memory modules 5300 and/or 5305 may be storage devices described with reference to FIGS. 1 to 57.

The RAM modules 5200 and 5250 and the nonvolatile memory modules 5300 and 5305 may communicate with the processor 5100 through the same interface 5150. For example, the nonvolatile memory modules 5300 and 5305 and the RAM modules 5200 and 5250 may communicate with each other through the DDR interface 5150. In some embodiments, the processor 5100 may use the RAM modules 5200 and 5250 as a working memory, a buffer memory, and/or a cache memory of the computing system 5000.

The chipset 5400 may be electrically connected with the processor 5100 and may control hardware of the computing system 5000 under control of the processor 5100. For example, the chipset 5400 may be connected to each of the GPU 5500, the input/output device 5600, and the storage device 5700 through main buses and may perform a bridge operation of the main buses.

The GPU 5500 may perform a set of arithmetic operations for outputting image data of the computing system 5000. In some embodiments, the GPU 5500 may be embedded in the processor 5100 in the form of a system on chip.

The input/output device 5600 may include various devices which receive data or commands provided to the computing system 5000 or may output data to an external device. For example, the input/output device 5600 may include one or more user input devices such as a keyboard, a keypad, a button, a touch panel, a touch screen, a touch pad, a touch ball, a microphone, a gyroscope sensor, a vibration sensor, a piezoelectric sensor, and the like and one or more user output devices such as a liquid crystal display (LCD), an organic light emitting diode (OLED) display device, an active matrix OLED (AMOLED) display device, a light emitting diode, a speaker, a motor, and the like.

The storage device 5700 may be used as a storage medium of the computing system 5000. The storage device 5700 may include one or more mass storage media such as a hard disk drive (HDD), a solid state drive (SSD), a memory card, a memory stick, and the like.

In some embodiments, the nonvolatile memory modules 5300 and 5305 may be used as a storage medium of the computing system 5000 through the processor 5100. An interface 5150 between the nonvolatile memory modules 5300 and 5305 and the processor 5100 may be faster in speed than that between the storage device 5700 and the processor 5100. That is, the processor 5100 may use the nonvolatile memory modules 5300 and 5305 as a storage medium, thereby improving the performance of the computing system 5000.

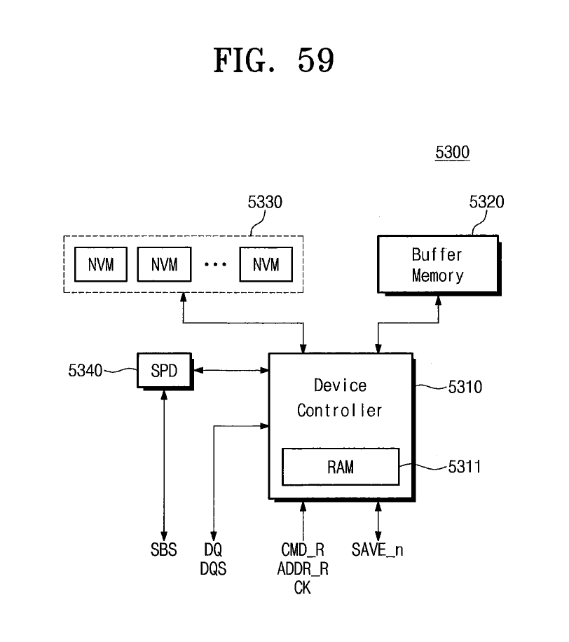

FIG. 59 is a block diagram illustrating an embodiment of the nonvolatile memory modules 5300 of FIG. 58. In some embodiments, FIG. 59 shows the nonvolatile memory module 5300 with a load reduced DIMM (LRDIMM) form. In some embodiments, the nonvolatile memory module 5300 illustrated in FIG. 59 may be of the form of a dual in-line memory module (DIMM) and may be mounted on a DIMM socket so as to communicate with the processor 5100.

Referring to FIG. 59, the nonvolatile memory module 5300 may include a device controller 5310, a buffer memory 5320, a nonvolatile memory device 5330, and a serial presence detect chip (SPD) 5340. The device controller 5310 may include a RAM 5311. In some embodiments, the nonvolatile memory device 5330 may include a plurality of nonvolatile memories NVM. The nonvolatile memories NVM included in the nonvolatile memory device 5330 may be implemented with a chip, a package, a device, or a module. In some embodiments, the nonvolatile memory device 5330 may be implemented with a chip or a package.

The device controller 5310 may transmit and receive a plurality of data signals DQ and a plurality of data strobe signals DQS to and from the processor 5100 and may receive a RAM command CMD_R, a RAM address ADDR_R, and/or a clock CK through separate signal lines.

The SPD 5340 may be a programmable read only memory device (e.g., EEPROM). The SPD 5340 may include initial information or device information of the nonvolatile memory module 5300. In some embodiments, the SPD 5340 may include initial information or device information such as a module type, a module configuration, a storage capacity, a module kind, an execution environment, and the like of the nonvolatile memory module 5300. When a computing system including the nonvolatile memory module 5300 is booted up, the processor 5100 of the computing system may read the SPD 5340 and may recognize the nonvolatile memory module 5300 based on the read result. The processor 5100 may use the nonvolatile memory module 5300 as a storage medium based on the SPD 5340.

In some embodiments, the SPD 5340 may communicate with the processor 5100 through a side-band communication channel. The processor 5100 may exchange a side-band signal SBS with the SPD 5340 through the side-band communication channel. In some embodiments, the SPD 5340 may communicate with the device controller 5310 through the side-band communication channel. In some embodiments, the side-band communication channel may be an Inter-Integrated Circuit (I2C) communication based channel. In some embodiments, the SPD 5340, the device controller 5310, and the processor 5100 may communicate with each other through I2C communication or may exchange information through the I2C communication.

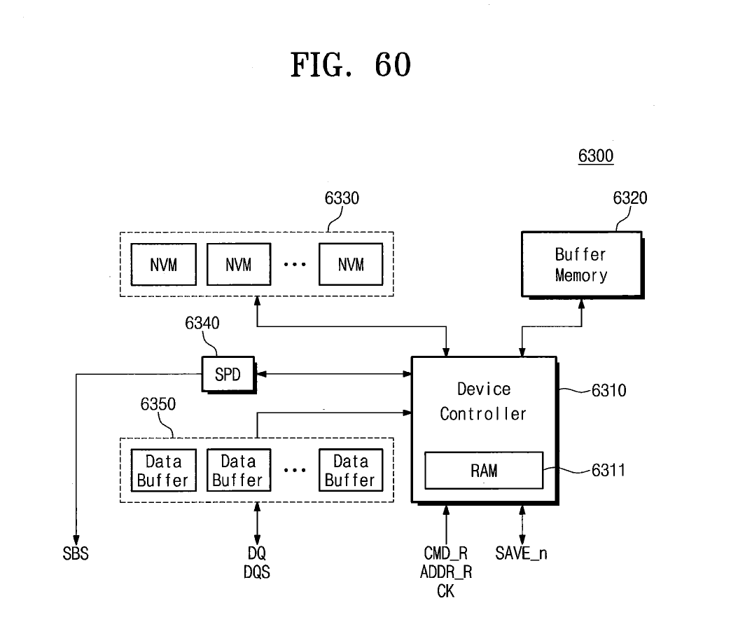

FIG. 60 is a block diagram illustrating an embodiment of the nonvolatile memory modules 6300 of FIG. 58. The embodiment of the nonvolatile memory modules 6300 may be used for the nonvolatile memory modules 5300 and/or 5305 of FIG. 58. In some embodiments, FIG. 60 is a block diagram of a nonvolatile memory module 6300 with a registered DIMM (RDIMM) form. In some embodiments, the nonvolatile memory module 6300 illustrated in FIG. 60 may be of the form of a dual in-line memory module (DIMM) and may be mounted on a DIMM socket so as to communicate with the processor 5100.

Referring to FIG. 60, the nonvolatile memory module 6300 may include a device controller 6310, a buffer memory 6320, a nonvolatile memory device 6330, a serial presence detect chip (SPD) 6340, and a data buffer circuit 6350. The device controller 6310 may include a RAM 6311. The device controller 6310, the RAM 6311, the nonvolatile memory device 6330, and the SPD 6340 are described with reference to FIGS. 1 and 59, and a detailed description thereof is thus omitted.

The data buffer circuit 6350 may receive information or data from the processor 5100 (refer to FIG. 58) through a data signal DQ and a data strobe signal DQS and may transfer the received information or data to the device controller 6310. Alternatively, the data buffer circuit 6350 may receive information or data from the device controller 6310 and may transfer the received information or data to the processor 5100 through a data signal DQ and a data strobe signal DQS.

In some embodiments, the data buffer circuit 6350 may include a plurality of data buffers. The data buffers may exchange the data signal DQ and the data strobe signal DQS with the processor 5100. In some embodiments, the data buffers may exchange a signal with the device controller 6310. In some embodiments, each of the data buffers may operate according to control of the device controller 6310.

In some embodiments, the device controller 6310 may manage sub-data described with reference to FIGS. 1 to 57.

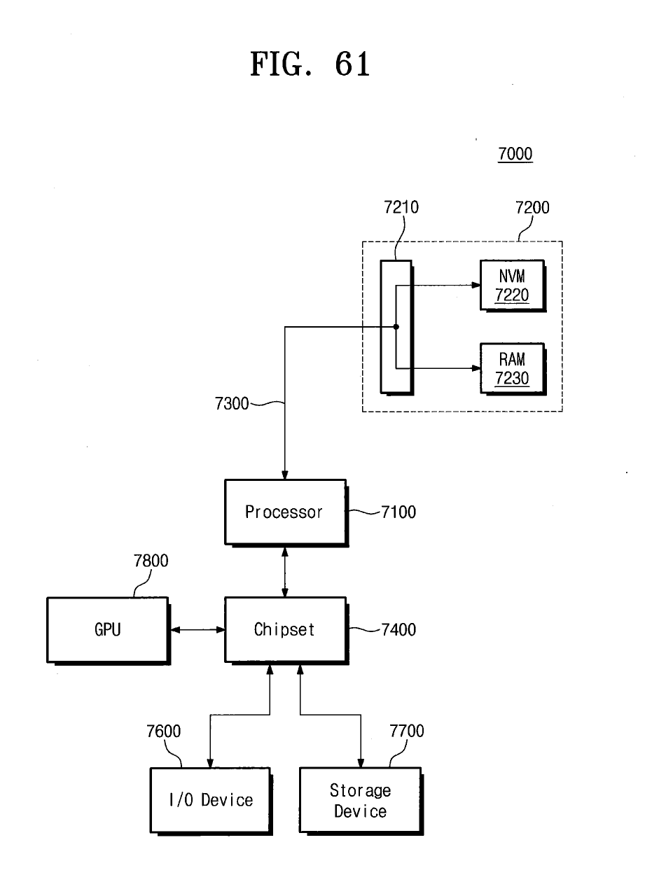

FIG. 61 is a block diagram illustrating another example of a computing system 7000 to which a nonvolatile memory module according to the inventive concept may be applied. For descriptive convenience, a detailed description about above-described components may be omitted. Referring to FIG. 61, a computing system 7000 may include a processor 7100, a nonvolatile memory module 7200, a chipset 7400, a graphic processing unit (GPU) 7800, an input/output device 7600, and a storage device 7700. The processor 7100, the chipset 7400, the GPU 7800, the input/output device 7600, and the storage device 7700 are substantially the same as those of FIG. 58, and a detailed description thereof is thus omitted.

The nonvolatile memory module 7200 may be directly connected to the processor 7100. In some embodiments, the nonvolatile memory module 7200 may be of the form of a dual in-line memory module (DIMM) and may be mounted on a DIMM socket so as to communicate with the processor 7100.

The nonvolatile memory module 7200 may include a control circuit 7210, a nonvolatile memory device 7220, and a RAM device 7230. Unlike the nonvolatile memory modules 5300 and 6300 described with reference to FIGS. 58 to 60, the processor 7100 may respectively access the nonvolatile memory device 7220 and the RAM device 7230 of the nonvolatile memory module 7200. In detail, the control circuit 7210 may store received data in the nonvolatile memory device 7220 or the RAM device 7230 in response to control of the processor 7100. In some embodiments, under control of the processor 7100, the control circuit 7210 may transmit data stored in the nonvolatile memory device 7220 to the processor 7100 or data stored in the RAM device 7230 to the processor 7100. That is, the processor 7100 may respectively recognize the nonvolatile memory device 7220 and the RAM device 7230 included in the nonvolatile memory module 7200. The processor 7100 may store data in the nonvolatile memory device 7220 of the nonvolatile memory module 7200 or may read data therefrom. In some embodiments, the processor 7100 may store data in the RAM device 7230 or may read data therefrom.

In some embodiments, the processor 7100 may use the nonvolatile memory device 7220 of the nonvolatile memory module 7200 as a storage medium of the computing system 7000 and may use the RAM device 7230 of the nonvolatile memory module 7200 as a main memory of the computing system 7000. That is, the processor 7100 may selectively access the nonvolatile memory device 7220 or the RAM device 7230 included in a memory module which is mounted on a DIMM socket.

In some embodiments, the processor 7100 may communicate with the nonvolatile memory module 7200 through a DDR interface 7300.

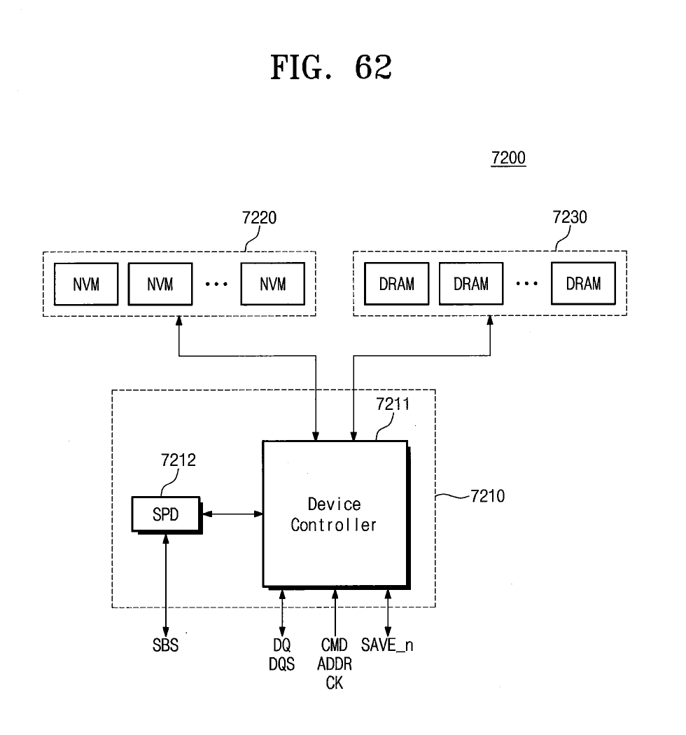

FIG. 62 is a block diagram schematically illustrating an embodiment of the nonvolatile memory module 7200 illustrated in FIG. 61. Referring to FIG. 62, the nonvolatile memory module 7200 may include a control circuit 7210, a nonvolatile memory device 7220, and a RAM device 7230. In some embodiments, the nonvolatile memory device 7220 may include a plurality of nonvolatile memories NVM, and the RAM device 7230 may include a plurality of DRAMs. In some embodiments, the nonvolatile memories may be used as storage of the computing system 7000 through the processor 7100. In some embodiments, the nonvolatile memories may include nonvolatile memory elements such as an electrically erasable and programmable ROM (EEPROM), a NAND flash memory, a phase-change RAM (PRAM), a resistive RAM (ReRAM), a ferroelectric RAM (FRAM), a spin-torque magnetic RAM (STT-MRAM), and the like.

The DRAMs may be used as a main memory of the computing system 7000 through the processor 7100. In some embodiments, the RAM device 7230 may include random access memory elements such as a DRAM, an SRAM, an SDRAM, a PRAM, an ReRAM, a FRAM, an MRAM, and the like.

The control circuit 7210 may include a device controller 7211 and a SPD chip 7212. The device controller 7211 may receive a command CMD, an address ADDR, and a clock CK from the processor 7100. The device controller 7211 may selectively store data, received through the data signal DQ and the data strobe signal DQS, in the nonvolatile memory device 7220 or the RAM device 7230 in response to signals received from the processor 7100. In some embodiments, the device controller 7211 may selectively transfer data, stored in the nonvolatile memory device 7220 or the RAM device 7230, to the processor 7100 through the data signal DQ and the data strobe signal DQS in response to signals received from the processor 7100.

In some embodiments, the processor 7100 may selectively access the nonvolatile memory device 7220 and/or the RAM device 7230 through a command CMD, an address ADDR, and/or a separate signal or separate information. That is, the processor 7100 may selectively access the nonvolatile memory device 7220 and/or the RAM device 7230 included in the nonvolatile memory module 7200. In some embodiments, the device controller 7211 may accumulate sub-data based on an operating method described with reference to FIGS. 1 to 57 and may program the accumulated sub-data at the nonvolatile memory device 7220 in response to a command of the processor 7100.

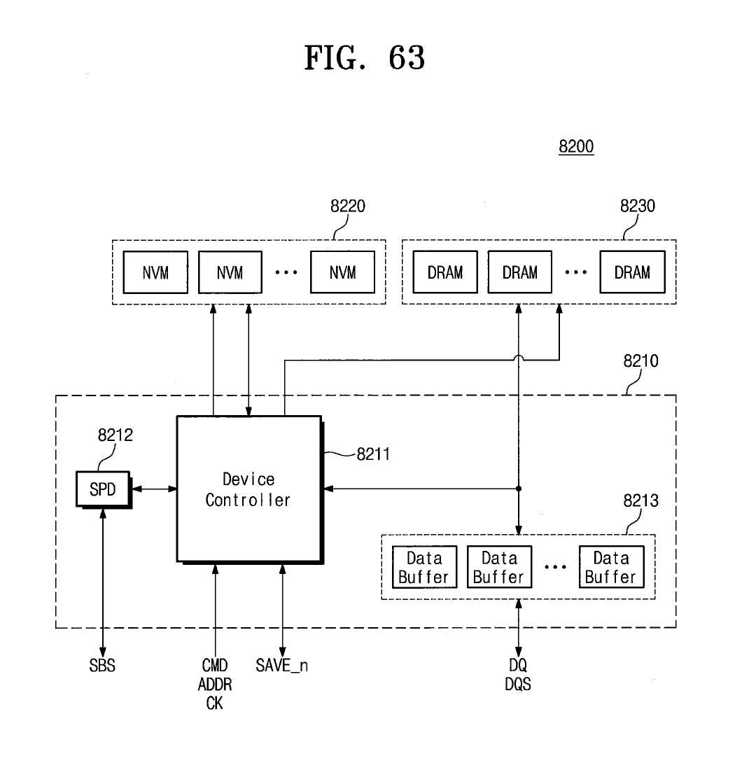

FIG. 63 is a block diagram illustrating an embodiment of the nonvolatile memory module 8200 illustrated in FIG. 61. In some embodiments, a nonvolatile memory module 8200 illustrated in FIG. 63 may be of the form of a dual in-line memory module (DIMM) and may be mounted on a DIMM socket so as to communicate with the processor 7100.

Referring to FIGS. 61 and 63, the nonvolatile memory module 8200 may include a control circuit 8210, a nonvolatile memory device 8220, and a RAM device 8230. The control circuit 8210 may include a device controller 8211, an SPD 8212, and a data buffer circuit 8213.

The device controller 8211 may receive a command CMD, an address ADDR, and a clock CK from the processor 7100. The device controller 8211 may control the nonvolatile memory device 8220 or the RAM device 8230 in response to received signals. For example, as described with reference to FIG. 61, the processor 7100 may selectively access the nonvolatile memory device 8220 or the RAM device 8230. The device controller 8211 may control the nonvolatile memory device 8220 or the RAM device 8230 under control of the processor 7100.

The data buffer circuit 8213 may receive the data signal DQ and the data strobe signal DQS from the processor 7100 and may provide the received signals to the device controller 8211 and the RAM device 8230. In some embodiments, the data buffer circuit 8213 may provide data, received from the device controller 8211 and/or the RAM device 8230, to the processor 7100 through the data signal DQ and the data strobe signal DQS.

In some embodiments, in the case where the processor 7100 stores data in the nonvolatile memory device 8220, data received through the data signal DQ and the data strobe signal DQS may be provided to the device controller 8211, and the device controller 8211 may process the received data and may provide the processed data to the nonvolatile memory device 8220. In some embodiments, in the case where the processor 7100 reads data stored in the nonvolatile memory device 8220, the data buffer circuit 8213 may provide data provided from the device controller 8211 to the processor 7100 through the data signal DQ and the data strobe signal DQS. In the case where the processor 7100 stores data in the RAM device 8230, data provided to the data buffer circuit 8213 may be provided to the RAM device 8230, and the device 8211 may transfer received command CMD, addresses ADDR, and/or clock CK to the RAM device 8230. In some embodiments, when the processor 7100 reads data stored in the RAM device 8230, the device controller 8211 may transfer the received command CMD, addresses ADDR, and/or clock CK to the RAM device 8230, and the RAM device 8230 may provide data to the data buffer circuit 8213 in response to the transferred signals. The data buffer circuit 8213 may provide data to the processor 7100 through the data signal DQ and the data strobe signal DQS. In some embodiments, the device controller 8211 may accumulate sub-data based on an operating method described with reference to FIGS. 1 to 57 and may program the accumulated sub-data at the nonvolatile memory device 8220 in response to a command of the processor 7100.

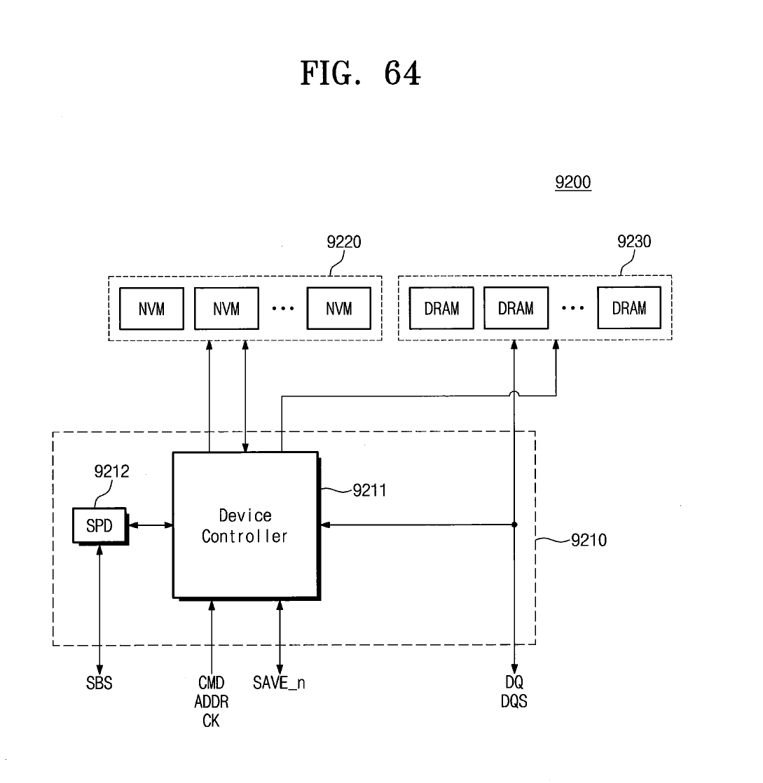

FIG. 64 is a block diagram schematically illustrating an embodiment of the nonvolatile memory module 9200 illustrated in FIG. 61. Referring to FIG. 64, a nonvolatile memory module 9200 may include a control circuit 9210, a nonvolatile memory device 9220, and a RAM device 9230. The control circuit 9210 may include a device controller 9211 and a SPD chip 9212. The nonvolatile memory module 9200 may operate to be similar to the nonvolatile memory module 8200 of FIG. 63. However, the nonvolatile memory module 9200 may not include the data buffer circuit 8213 unlike the nonvolatile memory module 8200 of FIG. 63. That is, the nonvolatile memory module 9200 of FIG. 64 may directly provide data, received from the processor 7100 through the data signal DQ and the data strobe signal DQS, to the device controller 9211 or the RAM device 9230. In some embodiments, data from the device controller 9211 of the nonvolatile memory module 9200 or data from the RAM device 9230 thereof may be directly provided to the processor 7100 through the data signal DQ and the data strobe signal DQS.

In some embodiments, the nonvolatile memory module 8200 of FIG. 63 may be a memory module of an LRDIMM form, and the nonvolatile memory module 9200 of FIG. 64 may be a memory module of an RDIMM form.

In some embodiments, the device controller 9211 may accumulate sub-data based on an operating method described with reference to FIGS. 1 to 57 and may program the accumulated sub-data at the nonvolatile memory device 9220 in response to a command of the processor 7100.

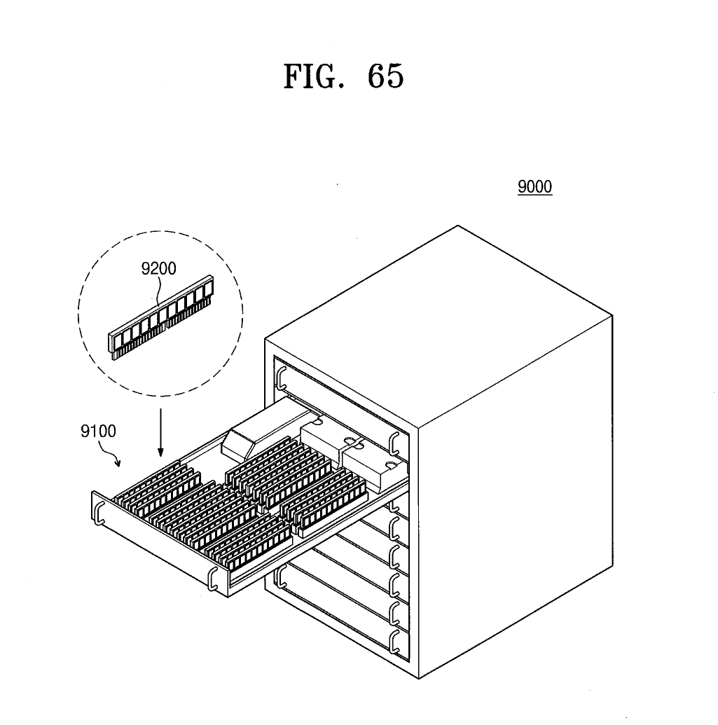

FIG. 65 is a diagram illustrating a server system 9000 to which a nonvolatile memory system according to embodiments of the inventive concept may be applied. Referring to FIG. 65, a server system 9000 may include a plurality of server racks 9100. The server racks 9100 may include a plurality of nonvolatile memory modules 9200. The nonvolatile memory modules 9200 may be connected with processors 7100 respectively included in the server racks 9100. For example, the nonvolatile memory modules 9200 may have the form of a dual in-line memory module and may be mounted on a DIMM socket electrically connected with a processor so as to communicate with the processor 7100. In some embodiments, the nonvolatile memory modules 9200 may be used as storage of the server system 9000. In some embodiments, the plurality of memory modules 9200 may operate according to a method described with reference to FIGS. 1 to 57.

A nonvolatile memory and/or a device controller according to the inventive concept may be packaged according to any of a variety of different packaging technologies. Examples of such packaging technologies may include the following: package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), small outline (SOIC), shrink small outline package (SSOP), thin small outline (TSOP), thin quad flatpack (TQFP), system in package (SIP), multi-chip package (MCP), wafer-level fabricated package (WFP), and wafer-level processed stack package (WSP).

According to embodiments of the inventive concept, even though sub-data smaller in size than a default transmission unit is write requested with respect to a nonvolatile memory module, it may be possible to minimize an increase in the number of write operations of a nonvolatile memory. Accordingly, it may be possible to improve data integrity of a nonvolatile memory module limited by the number of write operations and to extend a life thereof.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative.

1. A nonvolatile memory module, comprising:
at least one nonvolatile memory,
a random access memory (RAM); and
a device controller,
wherein, responsive to receiving a write request comprising sub-data from a host, the device controller accumulates the sub-data in the RAM and programs accumulated sub-data in the nonvolatile memory, and
wherein a size of the sub-data is smaller than a size of a default transmission unit provided from the host.

2. The nonvolatile memory module of claim 1, wherein the RAM comprises a command area to store a write command about the sub-data from the host and a write area to accumulate the sub-data.

3. The nonvolatile memory module of claim 1, wherein the write request comprising the sub-data comprises a sub-data write command comprising a size of the sub-data and a data offset indicating a position within the default transmission unit.

4. The nonvolatile memory module of claim 1, wherein the write request comprising the sub-data comprises a sub-data write start command provided together with first sub-data and a sub-data write end command provided together with last sub-data.

5. The nonvolatile memory module of claim 4, wherein at least one sub-data having a size the same as the first sub-data and provided within the write request between the first sub-data and the last sub-data is written at the RAM.

6. The nonvolatile memory module of claim 5, wherein the sub-data write start command comprises a size of the first sub-data and a data offset indicating a position within the default transmission unit of the first sub-data.

7. The nonvolatile memory module of claim 1, wherein the write request comprising the sub-data comprises a sub-data write start command, a sub-data write end command, and at least one sub-data provided between the sub-data write start command and the sub-data write end command.

8. The nonvolatile memory module of claim 7, wherein the sub-data write start command comprises a size of the at least one sub-data and a data offset indicating a position within the default transmission unit of the at least one sub-data.

9. The nonvolatile memory module of claim 7, wherein the device controller reads data from the nonvolatile memory, of which a logical address is the same as a logical address of the accumulated sub-data to be written to the nonvolatile memory, in response to the sub-data write end command.

10. A data writing method of a nonvolatile memory module, the method comprising:
storing a write start command of sub-data, of which a size is smaller than a size of a default transmission unit from a host, at a command area of a random access memory (RAM);
receiving from the host first sub-data corresponding to a write command to store the first sub-data in a write area of the RAM;
receiving second sub-data from the host to store the second sub-data in the write area; and
combining the first sub-data and the second sub-data from the write area to program the combined data in the nonvolatile memory.

11. A nonvolatile memory module, comprising
a device controller communicatively coupled to a host and configured to receive a plurality of data transmissions having a default transmission unit size from the host;
a nonvolatile memory coupled to the device controller and configured to be programmed with data from the plurality of data transmissions; and
a volatile memory coupled to the device controller and configured to store sub-data having a size smaller than the default transmission unit size that are accumulated from respective ones of the plurality of data transmissions from the host,
wherein the device controller programs accumulated sub-data data from the volatile memory into the nonvolatile memory when a predetermined condition is met.

12. The nonvolatile memory module of claim 11, wherein the volatile memory comprises a command area and a write area,
wherein a write transmission of the plurality of data transmissions comprises a write command portion and/or a write data portion,
wherein the command area of the volatile memory is configured to receive a write command from the write command portion of the write transmission, and
wherein the write area of the volatile memory is configured to store write sub-data accumulated from the write data portion of the write transmission responsive to the write command.

13. The nonvolatile memory module of claim 12, wherein the write transmission comprises a size of the write sub-data of the write transmission and a data offset indicating a position of the write sub-data within the write transmission.

14. The nonvolatile memory module of claim 12, wherein a first write transmission comprises a first write command portion comprising a sub-data write start command,
wherein, responsive to the sub-data write start command, the device controller begins accumulating the write sub-data in the volatile memory,
wherein a last write transmission comprises a last write command portion comprising a sub-data write end command, and
wherein the sub-data write end command is the predetermined condition and, responsive to the sub-data write end command, the device control stops accumulating the write sub-data in the volatile memory and programs the write sub-data accumulated in the volatile memory into the nonvolatile memory at an address in the nonvolatile memory associated with the write sub-data.

15. The nonvolatile memory module of claim 14, wherein, prior to programming the write sub-data accumulated in the volatile memory into the nonvolatile memory, the device controller is further configured to:
read locations of the nonvolatile memory adjacent the address in the nonvolatile memory associated with the write sub-data to recover merge data; and
merge the merge data with the write sub-data accumulated in the volatile memory.

16. The nonvolatile memory module of claim 12, wherein the volatile memory further comprises a read area,
wherein a read transmission of the plurality of data transmissions comprises a read command portion,
wherein the command area of the volatile memory is further configured to receive a read command from the read command portion of the read transmission,
wherein the read area of the volatile memory is configured to store read data accumulated from the nonvolatile memory responsive to the read command.

17. The nonvolatile memory module of claim 16, wherein the volatile memory further comprises a status area,
wherein the status area of the volatile memory is configured to store a read status of the read transmission and/or the write transmission.

18. The nonvolatile memory module of claim 17, wherein the write transmission further comprises an error parity corresponding to the write data portion of the write transmission,
wherein the device controller is configured to generate an error status of the write transmission responsive to a comparison of the write data portion of the write transmission and the error parity, and
wherein the status area of the volatile memory is further configured to store the error status.

19. The nonvolatile memory module of claim 17, wherein a first read transmission comprises a first read command for a read size of read data greater than the default transmission unit size,
wherein, responsive to the first read command, the device controller is configured to:
read a first read data portion from the nonvolatile memory of a default transmission unit size and accumulate the first read data portion in the volatile memory,
store a first read status information in the status area indicating that the first read data portion is available for access from the host and indicating a first position of the first read data portion within the read data,
read a last read data portion from the nonvolatile memory and accumulate the last read data portion in the volatile memory,
store a last read status information in the status area indicating that the last read data portion is available for access from the host and indicating a last position of the last read data portion within the read data, and
store a read completion status information in the status area indicating that the read transmission is complete.

20. The nonvolatile memory module of claim 19, wherein the last read data portion corresponds to a position within the read data that precedes the first read data portion.

21. (canceled)
